(19) United States
(12) Patent Application Publication
(10) Pub. No.: US 2024/0139745 A1
(43) Pub. Date: May 2, 2024

(54) PLATFORM FOR DECENTRALIZED TESTING

(71) Applicant: FloodLAMP Biotechnologies, PBC, Portola Valley, CA (US)

(72) Inventors: Randall James TRUE, Portola Valley, CA (US); Gary David WITHEY, JR., San Francisco, CA (US)

(73) Assignee: FloodLAMP Biotechnologies, PBC, Portola Valley, CA (US)

(21) Appl. No.: 18/343,268

(22) Filed: Jun. 28, 2023

Related U.S. Application Data
(60) Provisional application No. 63/367,313, filed on Jun. 29, 2022.

(51) Int. Cl. B01L 3/00

(52) U.S. Cl. CPC B01L 3/50851; B01L 2200/02; B01L 2300/0663; B01L 2300/12; B01L 2300/1805

(57) ABSTRACT

Systems, methods, and apparatus for sample testing, including biochemical testing for pathogens, biomarkers, or nucleic acids, are provided. These systems, methods, and apparatus may permit asynchronous testing of two or more samples. The apparatus may include a test reaction cap configured to permit sample testing, including instances in which the test reaction cap is coupled to a sample container. The systems, methods, and apparatus may permit testing of a fluid in a sample container using a heating unit with optical detection of sample test results.

### CROSS-REFERENCE TO RELATED APPLICATION

This application claims benefit of priority to U.S. Provisional Patent App. No. 63/367,313, filed on Jun. 29, 2022, which is hereby incorporated by reference herein in its entirety for all purposes.

### BACKGROUND

### Field of the Disclosure

This disclosure relates to the field of biological or environmental sample collection processes, sample testing, and test reporting workflows.

The COVID-19 pandemic has revealed the need for significant progress in many aspects of public health and emergency response. In some cases, such as the rapid development of mRNA vaccines, advances in biotechnology have exceeded timeline expectations and been highly successful. However, in the critical area of diagnostics and testing, the field has fallen far short of its potential. Testing based on the detection of molecules and/or biochemicals, e.g., including proteins, hormones (for example, hCG), DNA or RNA segments (for example, from an animal, virus, bacteria, amoeba), is a fundamental technology of critical importance. Testing provides essential information, both at the individual and at the societal levels. Biochemical/molecular testing may be utilized for: human and animal disease testing, medical screening (e.g., pregnancy), contamination detection (e.g., for water quality), environmental monitoring, etc. Currently, options in the bio-testing space continue to be inadequate for containing the spread of a pandemic level pathogen such as SARS-CoV-2.

In the interest of preparedness for future outbreaks of various diseases, it is vitally important to have accurate, reliable, fast, low-cost options for diagnostic (medical) and non-diagnostic (public health) testing by untrained individuals in the home, school, or place of business, or other venue. There exists a need for accurate tests (e.g., molecular tests) configured for widespread use in non-laboratory and possibly austere settings, especially with the capability to process many samples easily and quickly.

The most widely available testing options are either over-the-counter antigen tests or central lab-based PCR tests. Antigen tests provide convenience but greatly sacrifice accuracy. One of the best studies in the subject measured a 23% positive detection rate of a top antigen test compared to a standard polymerase chain reaction (PCR) test (see: [https://doi.org/10.1101/2022.02.27.22271090]). PCR testing, though more accurate, requires an expensive instrument, and thus incentivizes the centralization of testing. Access to PCR testing has been hampered by long wait times for results and high costs. The central lab processing model has proven to be especially inadequate during times of infection surges, when testing is needed most.

New rapid at-home molecular tests, utilizing the detection of DNA and/or RNA rather than proteins (which antigen tests detect), marry speed, accuracy, and convenience, but are cost prohibitive for most people and circumstances. Fast, accessible, and accurate testing results are critical for managing spread, preventing outbreaks, and helping individuals and organizations to make appropriate decisions in the interest of public health. Newer isothermal amplification chemistries, e.g., Loop-mediated Isothermal Amplification (LAMP), have matured during the pandemic and offer great hope for the future. Because isothermal tests may run at a single temperature and can be configured to give a visual readout, instrumentation may not be needed, making decentralization possible. However, prices for these range from $40-$70 per test, limiting their accessibility for routine testing. Also limiting is the fact that many of these tests utilize complex consumables that are configured for use only serially in single heaters and/or readers, e.g., heater/readers.

Coordinated efforts that utilize any of the above test types or others, aka “testing programs”, are often implemented by organizations or entities, such as schools, businesses, or communities, and can offer on-demand testing, scheduled routine screening, or a combination of both. “Screening” usually refers to a type of testing for people who have no symptoms and no known, suspected, or reported close contact exposure, and helps to identify unknown infections that may cause additional infections. Screening may refer to repeated testing, and participants in a screening program may develop symptoms or have an exposure and be tested.

The decentralized testing paradigm covers the range comprising 1) at-home/OTC devices, typically designed for the completely lay user, and provided as a single one time use package that can be run anywhere in less than an hour, ideally less than 30 minutes; and 2) “point-of-care” (POC) systems which are usually instruments that take test cartridges and are usually designed for clinics and doctor's offices. Many of these POC systems utilize ultra-high sensitivity PCR with expensive instrument and cartridge price points. Many of the current POC systems are serial instruments where only one test per instrument can be run at a time, typically taking between 15 minutes to 1 hour or more.

Decentralized testing has expanded during the COVID-19 pandemic to include organization based routine screening programs (e.g., at schools and workplaces) where the processing is on-site or near-site at either non-traditional labs or austere settings. In this model, newly trained test operators may run dozens or a hundred or more tests per day. Sometimes this is referred to as “point-of-need” testing rather than point-of-care because the intended use of the testing is for public health (e.g., outbreak suppression) rather than individual medical/diagnostic purposes. The newly trained operators may have little or no laboratory background and may never have performed biotesting of any type.

Instruments for processing biochemical, e.g., molecular, tests frequently comprise a means of heating and performing optical measurements. The heating may involve thermal cycling such as in a quantitative PCR instrument, which ramps the temperature up and down between about 50 degrees C. and 95 degrees C. every approximately 30 to 90 seconds, making an optical measurement, e.g., of a fluorescence reporter, at each well position for each thermal cycle. Isothermal amplification chemistries, such as LAMP, do not need thermal cycling and therefore instruments used or designed for isothermal tests are typically less complex and less costly than those for PCR. A so-called plate reader may be utilized, and in the case of a colorimetric isothermal test, an absorbance measurement may be made at regular intervals such as 30 seconds or 1 minute, or more simply at a single time point marking the end of the test, a so-called “end point” measurement. For both PCR and isothermal tests, the heating may be performed on a separate unit compared to the reading or optical measurements. There are pros and cons and tradeoffs to utilizing separate units or integrating the heating and reading functions.

A distinction usually exists between instruments, which typically accept consumables, either standard such as PCR tubes, or custom such as proprietary cartridges, and a device, which usually refers to a single unit that is used to perform a single test. Instruments may accept a few custom cartridges or one or many standard tubes, sometimes attached together in spacings such as standards set by the Society for Biomolecular Screening (SBS), e.g., 96 plate format.

Frequently, a goal of testing programs is to reduce spread within the organization and its interacting population. The two primary levers for reducing spread are the frequency of testing and sensitivity (accuracy) of the test. A more sensitive test offers more advance notice of when a person may be likely to infect others around them. The true turnaround time of the test, measured as time between when the sample is collected and when result is delivered, is a key metric. In many cases, people in organizations and congregate settings may be interacting and exposed to each other, therefore a faster true turnaround time results in knowing sooner if someone is infected, which can limit the amount of exposure to others around them. This can be especially important for critical personnel, such as first responders or hospital staff, where outbreaks in the workplace can have large negative consequences for an entire community. In some circumstances, individual samples or sample batches collected at the same time can be run on-demand, allowing for asynchronous test start times. This on-demand capability can minimize the true turnaround time of a testing system.

An area for progress in testing programs is household-based screening. Very few testing programs routinely screen entire households due to the high cost and logistical demands. Intra-household transmission, however, is one of the main vectors for disease spread. In epidemiologic context, people within a household, such as a family, have a high degree of exposure to each other and are typically likely to transmit an infectious disease to each other. Further, each member of a household also has exposure to others they interact with in congregate settings outside the home, such as schools and workplaces. Testing the household together, either each person individually or with samples combined in a sample “pool,” provides an extra degree of assurance for an organization-based testing program.

New testing paradigms and efficiencies are needed in order to more holistically utilize testing in a way that helps to suppress transmission rather than to simply diagnose it. This is paramount for an aerosolized, asymptomatically transmitting virus. Progress in testing would offer far reaching improvements to human health.

### SUMMARY OF THE DISCLOSURE

Some embodiments described below permit simple testing workflows using reaction containers which may be processed for specimen testing using heater/reader systems. In some embodiments, reaction containers may comprise container coupling units (“CCUs”) with one or more internal reaction chambers and/or fluidic pathways and/or other features. CCUs may be coupled and decoupled from sample containers in various steps of the testing process. The heating/reading systems may be separate systems or integrated into a single system. After the specimen testing is complete, the reaction container may be removed from the heater/reader system, and the heater/reader system may be reused for additional testing of other specimens in other reaction containers. The cost of consumables for specimen testing is reduced by virtue of reusing the heating/reading systems. The cost of the consumed CCUs or reaction containers may be reduced based on the described CCU designs and manufacturing flows. In some embodiments, multiple reaction containers (for one or more tests) may be created from a single sample container by serially coupling different CCUs.

In some embodiments, the CCU size and geometry is designed to be compatible with a heater/reader, and for example, the CCU may be only slightly larger than the sample container, such that when combined, multiple of these combined reaction containers may fit into a multi-processing heater/reader system in a space efficient manner (e.g., with different CCU container assemblies starting tests asynchronously). Overall system cost reduction and increased test throughput may be achieved.

In some embodiments, CCUs comprise one or more inner chambers whereby biochemical reactions occur. Such inner chambers may comprise dimensions to accommodate a range of reaction volumes that improve the performance of a test or the manufacturability of the CCUs. In some embodiments the design of the CCU comprises components to encourage the flow of liquid, e.g., a sample liquid, into the inner chambers, and limit the flow out, e.g., to prevent back flow or diffusion of reaction chemicals into another liquid in an attached volume.

In some embodiments, the CCU comprises a reaction cap which may be configured to be coupled to the top of a sample container, such that during coupling, at least a portion of fluid in the sample container is positioned below the reaction cap. In some embodiments, the CCU is configured to couple to a sample container with the CCU positioned below. Having described the embodiments wherein a CCU couples to a sample container, additional embodiments may comprise similar designs whereby one or more internal chambers and/or one or more fluidic pathways (and associated features) are integrated into the sample container, e.g., a container tube. In some of these additional embodiments, the sample container may be capped with a standard cap.

Testing workflows may be simplified by some of the embodiments described below. For example, the use of CCUs may simplify the workflow by removing specialized equipment such as micropipettors. The integration of a heating unit and reading unit (e.g., a unit with a sensor for sample fluid measurement) into a single unit may allow for workflows wherein the test operator's direct attention is required only until the reaction container is inserted into the heater/reader. In some embodiments, measurements of the reaction result may take place at multiple time intervals or time points, or at the endpoint of the reaction at a single specified time. Integration of the heating unit with the reading unit may relieve the test operator of the responsibility to attend the reaction during and at the end point of incubation since the measurements may be automated. In addition, the communication of results may also be automated in the reader, e.g., if integrated with the heater, to enable a truly on-demand, walk away system. This capability may offer many advantages including cost reduction, a compact instrument footprint, reduced test operator labor requirements, reduced administrator overhead, and shorter turnaround times on test results.

Integration of the heating unit with the reading unit to the extent that measurements may be taken at individual positions in the heater/reader independently of all other positions may allow for asynchronous incubation of multiple reaction containers in the heater/readers. In this case, it may not be required that reaction containers be batched for parallel processing with the same start time. This may allow for more flexible use cases and reduced turnaround time from sample collection to delivery of results. In some embodiments, batches of samples of different sizes, e.g., from 2 samples to 500 or more, may be supported, with methods and systems optimized for efficiency, performance, or quality.

In some embodiments, two or more test subjects may pool their respective biological specimens together and perform the test on the pooled sample. If the test result indicates a “positive” result for the pooled sample, one or more test subjects from the pool may perform the test individually to identify any test subjects that are positive. If the test result is “negative” for the pooled sample, all the test subjects that contributed to the pooled sample may be deemed to be negative based on the negative pooled sample result. In some embodiments, a pooled testing workflow may be utilized in instances in which the population being tested is expected to have a low positive (e.g., disease infection) rate. In some embodiments, the size of the test pool may be adjusted based on the expected positivity rate.

In summary, some embodiments of the invention described herein offer a multitude of highly advantageous improvements to systems and methods related to biochemical testing.

### BRIEF DESCRIPTION OF THE DRAWINGS

FIGS. 1A-O illustrate various exemplary CCU geometries in cross-section.

FIG. 2 illustrates an exemplary CCU in cross-section.

FIGS. 3A-D illustrate different views of an exemplary CCU with three internal chambers.

FIGS. 4A, B illustrate an exemplary CCU in two states with one of the two states allowing sample fluid to enter an internal chamber.

FIGS. 5A-I illustrate three exemplary designs for a CCU (A-B; C-D; E-F) with insets (H, I) showing offset/closed and aligned/open states schematically, respectively, of the CCU.

FIGS. 6A-H illustrate different views of an exemplary CCU with a plunger design with 6A-C depicting CCU component assembly, 6D, E showing different states of the plunger, and 6F-I illustrating motion of sample fluid as the plunger is depressed.

FIGS. 7A-F illustrate an exemplary CCU configured to be tested separately from a sample container.

FIG. 8 illustrates assembly of an exemplary two-part CCU.

FIGS. 9A-G illustrate views of various embodiments showing arrangements of one or more sensors, one or more light sources, and CCUs with one or more internal chambers to measure optical properties of a sample fluid in an internal chamber.

FIG. 9H shows a configuration for measuring test results from various samples using a camera.

FIGS. 10, 11, 12A-C show various views of an exemplary rotationally loaded CCU.

FIG. 13A-C shows a top-down view of an exemplary rotationally loaded CCU with a rotating cap oriented so that the transfer chamber may accept sample fluid volume from an attached sample container.

FIG. 14A-C shows a top-down view of an exemplary rotationally loaded CCU with a rotating cap oriented so that the transfer chamber may deliver sample fluid volume to an internal chamber of the top chamber.

FIG. 15A-C shows a top-down view of an exemplary rotationally-loaded CCU with a rotating cap oriented so that the transfer chamber does not align with either of the fluidic pathway portions in the cap base or the top chamber—fluidic pathway between all three parts of the CCU is sealed.

FIG. 16 shows a view of an exemplary rotationally loaded CCU with a rotational notch to constrain the motion of the rotating disc.

FIG. 17 shows an exemplary rotationally loaded CCU coupled to a sample container.

FIG. 18A-B shows a gasket for use between a cap base and a rotating disc of an exemplary rotationally loaded CCU.

FIG. 19A-F shows an exemplary workflow for using a dropper-type CCU.

FIG. 20A-E shows an exemplary dropper-type CCU configured to deliver a controlled sample volume to an internal chamber.

FIG. 21A-B shows an exemplary dropper-type CCU with a plunger.

FIGS. 22-26 illustrate the use of a plunger to move sample fluid from a sample container to an internal chamber.

FIG. 27 illustrates an exemplary CCU with a “snorkel” vent port for an internal chamber.

FIG. 28A-C illustrates an exemplary CCU and sample container with a “snorkel” vent port for an internal chamber.

FIG. 29 illustrates an exemplary CCU with a plunger coupled to a sample container.

FIGS. 30A-D illustrate the motion of a plunger to move sample fluid into an internal chamber.

FIGS. 31A, B illustrate two embodiments of a fluidic pathway between a transfer chamber and an internal chamber.

FIGS. 32A-C illustrate various embodiments of exemplary CCUs to control the volume of sample fluid transferred into an internal chamber.

FIGS. 33A, B illustrate an exemplary CCU with a vent for an internal chamber.

FIGS. 34A, B illustrate two exemplary embodiments of plunger designs.

FIGS. 35A-F illustrate an exemplary multi-reagent addition workflow using a two side plunger CCU.

FIGS. 36A-F illustrate another exemplary multi-reagent addition workflow using a two side plunger CCU.

FIG. 37 illustrates a cross-section view of an exemplary CCU with a ball in an internal chamber.

FIGS. 38A, B illustrate a cross-section view of the exemplary CCU from FIG. 37 (A) after the two parts forming the CCU are joined and a cross-section view of the CCU attached to a collection container (B).

FIG. 39 illustrates a cross-section view of the CCU attached to the collection container after the sample fluid has entered the internal chamber (and the ball has floated to the top of the internal chamber).

FIG. 40A-I illustrates assembly of an exemplary two-part CCU.

FIGS. 41A-D illustrate two exemplary designs of CCUs with gate valves in two different states.

FIGS. 42A, B and 42C-E illustrate two embodiments of a reaction container receiver.

FIGS. 43A, B illustrate an exemplary CCU in two states that may be used to introduce sample fluid into an internal chamber.

FIGS. 44A-C illustrate an exemplary CCU configured to attach to the bottom of a sample container.

FIG. 45 shows a schematic of components and of communication between components in an exemplary system implementing an embodiment.

FIG. 46A-D illustrate an exemplary two-dropper workflow using dropper-type CCUs.

FIG. 47 illustrates a configuration for using a camera to record sample positions and to take measurements of test results from samples.

FIG. 48 illustrates a configuration for using a light source array and a photodetector array on two sides of samples to take measurements of test results from samples.

FIGS. 49A, B illustrate two exemplary CCUs with different aspect ratios relative to sample containers.

FIGS. 50A-D illustrate four exemplary CCUs designed into the bottom of sample containers.

FIGS. 50E, F illustrate two exemplary CCUs configured to be used with multi-part sample containers.

FIG. 51 shows a schematic of an exemplary computer system used to implement an embodiment.

### DETAILED DESCRIPTION

A container coupling unit (CCU) may be coupled to a sample container wherein the CCU includes one or more internal chambers. In some embodiments, a CCU comprises a “reaction cap,” and in some instances the reaction cap couples to the top of the sample container. In some embodiments, a sample container is referred to as a “collection container.” In some instances, “sample” is used to refer to a biological specimen (e.g., nasal mucus that is collected on swab) or a portion of a biological specimen that is dispersed in a fluid.

In some embodiments, the inventions described herein may be used for testing for the presence of a pathogen or other biomarker in a specimen from a single individual. In some embodiments, two or more individuals may combine their biological specimens into a single pool for testing. In some embodiments, based on the test result from a pooled sample, individuals from the testing pool may follow up pooled testing with individual tests.

In some embodiments, a test subject may contribute one or more biological specimens for testing that may comprise biological fluid or other biological material collected using an anterior nasal swab, mid turbinate swab, nasopharyngeal swab, oropharyngeal swab, oral epithelial cell swab, or other swab type. In some embodiments, the swab may be placed into a collection container at the point of sampling. In some embodiments, the swab may be solid or may be designed to break-away in order to fit into a smaller collection container. In some embodiments, the collection end of the swab may be made of spun polyester, structured polypropylene, or other standard material or process. In some embodiments, the biological specimen or specimens may comprise a biological fluid such as saliva, mucus, ear wax, blood, pus, lymph fluid, urine, feces, semen, vaginal fluid, skin flakes, hair or hair follicles that is collected into a collection container. In some embodiments, an individual test subject may place their biological specimen individually into one or more collection containers. In some embodiments, multiple test subjects may place their biological specimens into the same collection container or collection containers.

In some embodiments, the biological specimen may be processed or tested in the original collection container that is used at the point of sampling. In some embodiments, the biological specimen may be transferred to a separate collection container or collection containers before further processing or testing. In some embodiments, a collection container used as a part of the processing or testing may be a standard container provided by a third-party manufacturer. In some embodiments, a collection container used as a part of the processing or testing may be a custom or proprietary container. In some embodiments, the collection container may be a tube made from polypropylene, polystyrene, polyethylene, or similar plastic. In some embodiments, the collection container may be a tube made of glass. In some embodiments, the collection container may be a tube that is conical-bottom, v-bottom, round-bottom, stand-up, or other standard bottom geometry. In some embodiments, the collection container may be rigid in its construction. In some embodiments, the collection container may be flexible, squeezable, or otherwise deformable. In some embodiments, the collection container may be a centrifuge tube, blood tube, swab collection tube, or similar tube type. In some embodiments, the collection container may have a volume of 0.2 mL, 0.5 mL, 1.5 mL, 2 mL, 3 mL, 5 mL, 15 mL, 30 mL, or 50 mL.

In some embodiments the biological specimen may be placed into a dry collection container. In some embodiments after transferring a biological specimen to the dry collection container, a volume of buffer, inactivation solution, or other collection medium may be added to the collection container to inactivate, preserve, or otherwise prepare the biological material from the biological specimen. In some embodiments, the collection container may be pre-filled with buffer, inactivation solution, or other collection medium to inactivate, preserve and/or otherwise prepare the biological material from the biological specimen prior to adding a biological specimen to the collection container. In some embodiments, after transferring a biological specimen to the collection container, the collection container is capped with a standard cap. In some embodiments, after transferring a biological specimen to the collection container, the collection container is coupled to a CCU.

In some embodiments, the operator who runs the test may run the test for only their own biological sample. In some embodiments, the test operator may run the test for their own sample as well as for the biological samples of other individuals. In some embodiments, the test operator may run the test for the biological samples of other individuals and not for themselves. In some embodiments, sample testing may be performed in the home. In some embodiments, the sample testing site may be a dedicated, stand-alone mobile or stationary location for testing. In some embodiments, the testing site may be a dedicated station or area in the school, workplace, hospital, shopping center, event venue, other public space, or other place of gathering.

In some embodiments, the system for testing may be single use where there may be no need for sample tracking since only a single sample is run. In some embodiments, the identification and tracking of the samples being tested may be facilitated by using a collection container, CCU, or internal chamber within a CCU that has an identifier (e.g., an alpha-numeric container ID or QR code), and the container identifier is retained by the test subject for later reference, for example, by searching a test result database using the container identifier to retrieve the test result. In some embodiments, the collection container, CCU, or internal chamber within a CCU may carry a label on which the test subject(s) can write identifying information. In some embodiments, the collection container, CCU, or internal chamber within a CCU may have an identifier (e.g., an alpha-numeric container ID or QR code) that may be scanned into a personal device (e.g., phone, tablet, laptop, etc. associated with one or more test subjects). In some embodiments, the collection container, CCU, or internal chamber within a CCU may have one or more copies of an identifier (e.g., with an alpha-numeric containerID, QR code) that can be removed and retained by test subject(s) and a copy of the identifier that remains on the container for sample identification and tracking by matching. In some embodiments, where samples from multiple test subjects are pooled into a single reaction container, the identifier—which may include any of the various identifiers specified herein or any other identification method—may include identifying information for any or all of the individuals contributing samples into the sample pool.

In some embodiments, the test may be performed at the site of collection whether that site is in the home or elsewhere. In some embodiments, after placing the biological specimen into the collection container, the collection container may be sent by mail or courier service to the testing site. In some embodiments, after placing the biological specimen into the collection container, the collection container may be placed into a drop-off receptacle at the testing site. In some embodiments, after placing the biological specimen into the collection container, the collection container may be placed directly into the testing apparatus, e.g., an incubator rack, at the testing site.

In some embodiments, the test may be run on a single-use basis with no required registration, for example, a test being conducted for the benefit of the test subject for determining the end of an isolation or quarantine period with the test subject “standing by” the reader/heater for results. In some embodiments, the identifying information of test subject(s) is registered with the testing system. In some embodiments, the identifying information of the test sample, e.g., a container identifier, a CCU identifier, is registered with the testing system. In some embodiments, the test subject(s) contributing to the test sample are identified as one or more registered test subjects in the testing system. In some embodiments, the testing system coordinates delivery of test results to test subject(s)—for example, the testing system relates a test result (from an internal chamber) to a container or CCU identifier which is then related to a test sample identifier which is then related to the test subject(s) that contributed to the test sample. In some embodiments, the test subject(s) query the testing system (e.g., using a container identifier, a CCU identifier) to get test results.

In some embodiments, testing of the biological sample may be performed without inactivating the sample in any way. In some embodiments, sample inactivation may be accomplished in the collection medium at the point of placing biological specimen into the collection container that contains the collection medium. In some embodiments, sample inactivation may be accomplished by the addition of inactivation solution or other reagent to the collection tube containing the biological specimen. In some embodiments, sample inactivation may take place in a saline and/or buffer solution such as Tris borate buffer or may contain other reagents including but not limited to proteinase K, EDTA, surfactants such as Tween-20, Triton X-100, NP-40, or Pluronic, reducing agents such as TCEP or DTT, RNA stabilizing agents such as Ribolock, or other reagents such as BSA. In some embodiments, sample inactivation may be accomplished by heating the collection tube containing the biological specimen in the presence or absence of inactivation solution or other reagents.

In some embodiments, the CCU may be attached to the collection container after placing the biological sample into the collection container. In some embodiments, the CCU may be attached to the collection container after inactivation solution or other collection medium is added to the biological sample in the collection container. In some embodiments, the CCU may be attached to the collection container after one or more heating steps, e.g., heat incubation for sample inactivation.

In some embodiments, the volume of CCU internal chamber may be between 1 uL and 1 mL. In some embodiments, the volume of collection container may be between 50 uL and 50 mL. In some embodiments, the ratio of the volume of CCU internal chamber to the volume of collection container may be between 1:50,000 and 1:1. In some embodiments, the CCU may contain an inner volume (e.g., fluidic pathway) that connects the internal chamber volume with the volume of the collection container when the CCU is attached to the collection container. The ratio of the inner volume to the volume of the collection container may be between 2:1 and 1:50,000.

In some embodiments, the volume of sample transferred to the internal chamber may be between 1 uL and 1 mL. In some embodiments, the total sample volume may be between 50 uL and 50 mL. In some embodiments, the ratio of the volume of the sample transferred to the internal chamber and the total sample volume may be between 1:50,000 and 1:1.

In some embodiments, the CCU may be composed on one or more pieces; each piece may be composed of one or more materials including plastic, metal, wax, rubber, and/or glass. In some embodiments, the CCU may be designed to fit any of a variety of standardized collection container types. In some embodiments, the CCU may be designed to fit any of a variety of custom collection containers. In some embodiments, the CCU or the collection container may include feature(s) such as interlocking teeth or ridges that lock the CCU in place once it has been attached to the collection container so that it cannot be removed. In some embodiments, the CCU may contain a single internal chamber and a single fluidic pathway from the inner surface of the CCU to the internal chamber. In some embodiments, the CCU may contain two or more internal chambers, each connected to the inner surface of the CCU by a fluidic pathway. In some embodiments, the CCU may be a monolithic piece. In some embodiments, the CCU may include two or more interconnected pieces with one or more pieces that can move relative to another piece; motion of the one or more pieces may permit fluidic pathway(s) to the internal chamber(s) to be opened and/or closed and/or to add volume(s) of biological sample(s) from the collection container into the internal chamber(s). Any of these variations may include various geometries for the internal chamber(s), the fluidic pathway(s), the notch(es), and the CCU itself. In some embodiments, one or more CCU surface portions, e.g., fluidic pathway(s), internal chamber(s), may be treated with a coating such as a hydrophilic or hydrophobic coating.

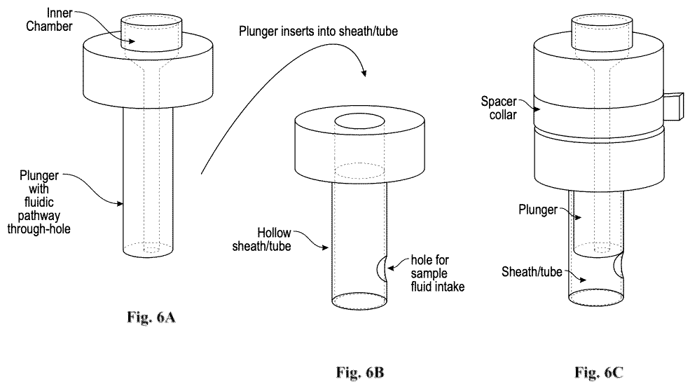

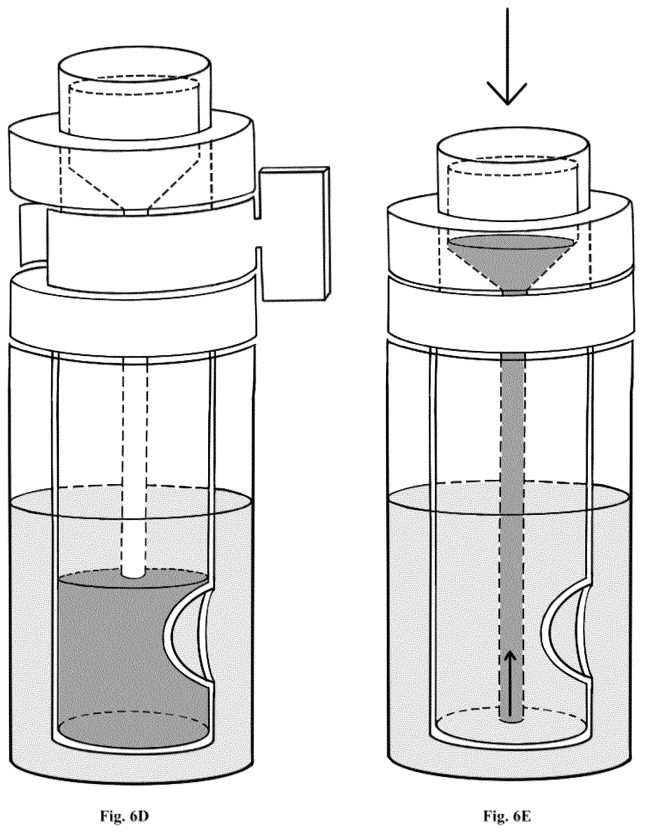

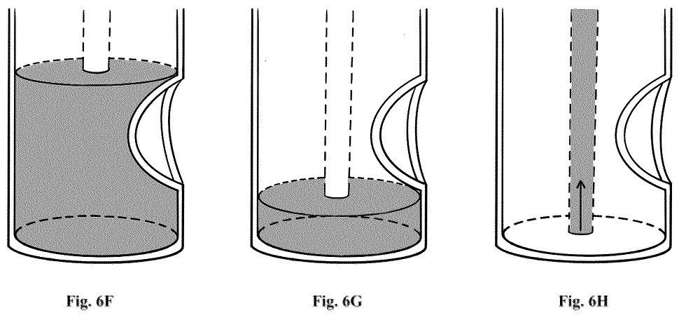

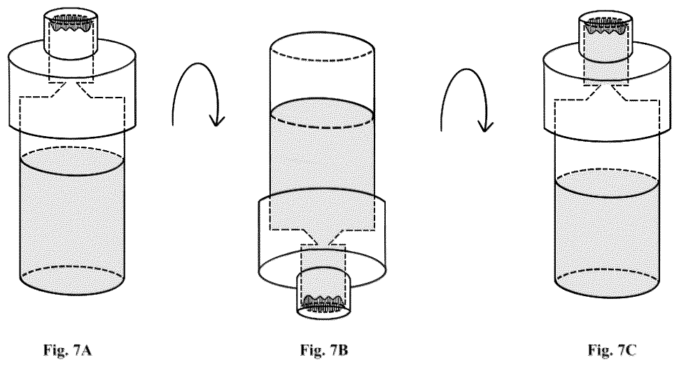

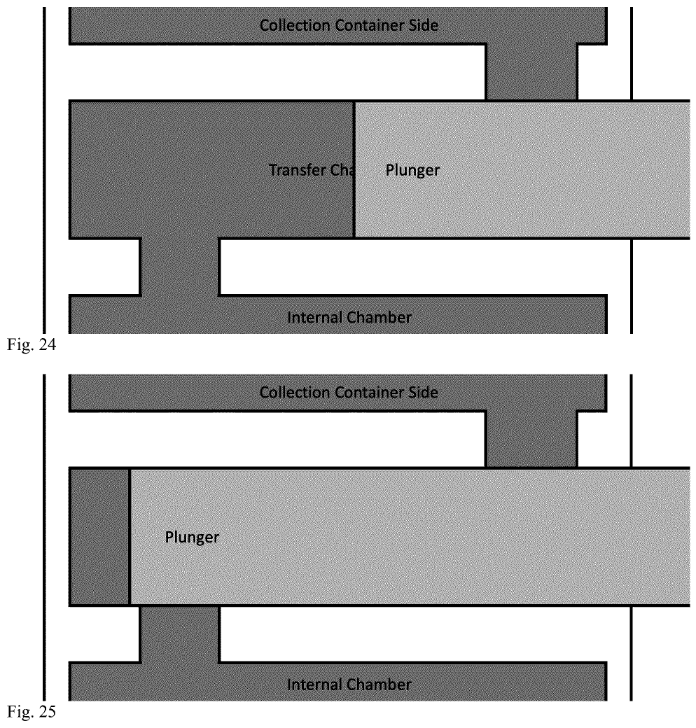

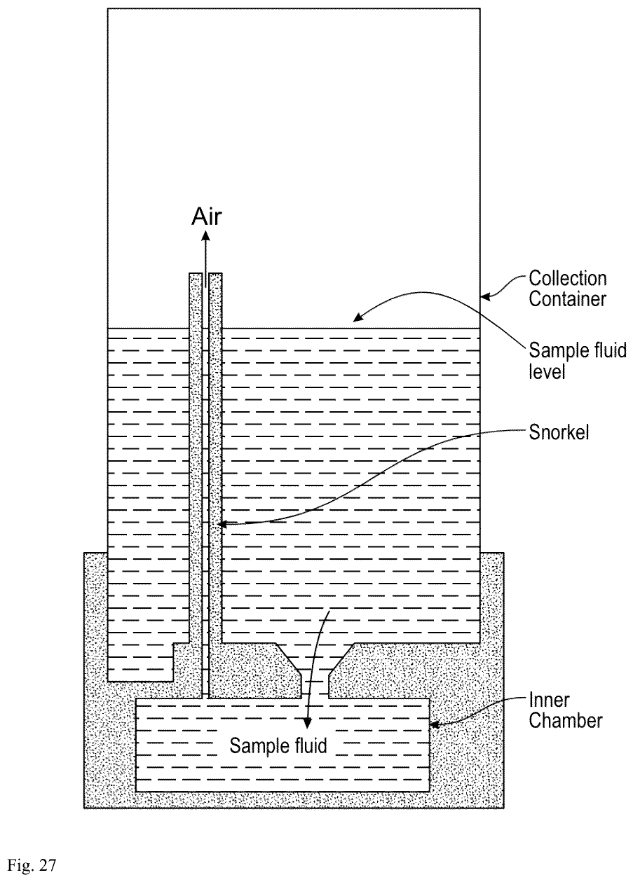

In some embodiments, the sample fluid may be induced to travel from the collection container into internal chamber(s) when induced by a physical motion such as tapping the tube on a surface with the CCU down, a snapping motion, or other physical motion. In some embodiments, the sample fluid may be induced to travel from the collection container into internal chamber(s) based on gravitational force. In some embodiments, the sample fluid may be induced to travel from the collection container into internal chamber(s) based on capillary action. In some embodiments, the sample fluid may be induced to travel from the collection container into internal chamber(s) by positive or negative pressure gradients. In some embodiments, the transfer of sample fluid from the collection container into internal chamber(s) may be induced by a pressure gradient caused by manual deformation or other physical manipulation of the collection container and/or CCU. In some embodiments, the transfer of fluid containing biological material from the collection container into internal chamber(s) may be induced by a pressure gradient induced by thermal expansion of air within the collection container. In some embodiments, the sample fluid may be forced into the internal chamber(s) using a plunger mechanism, see, for example, FIGS. 6, 22-25. In some embodiments, the CCU may be designed so that an internal chamber includes a vent that permits air in the internal chamber to vent as sample fluid enters the internal chamber. The vent in the internal chamber may be self-sealing after a given volume of fluid has entered the internal chamber—for example, the volumetric expansion of a dehydrated vent after fluid contacts it may seal the vent closed. In some embodiments, the CCU may be designed so that a vent in the internal chamber includes a tube (or “snorkel”) that extends into an attached container, for example, the original collection container to which the CCU is coupled. The tube may be of a length such that it rises above the level of any fluid that may be in the attached container when the CCU assembly is inverted; the tube may allow for transfer of air from the internal chamber to the attached container as sample fluid displaces the air in the internal chamber—see FIG. 27, below.

In some embodiments, the CCU may be designed so that diffusion of reaction mix volume from the internal chamber(s) (e.g., to the collection container volume) is limited or prevented by the geometry of the fluidic pathway between the internal chamber(s) and the collection container volume. In some embodiments, the CCU may be designed so that diffusion of reaction mix volume from the internal chamber(s) (e.g., to the collection container volume) is limited or prevented by a surface coating, such as a hydrophobic coating. In some embodiments, the CCU may be designed so that diffusion of reaction mix volume from the internal chamber(s) (e.g., to the collection container volume) is limited or prevented by a sealing mechanism. In some embodiments, the CCU may be designed so that diffusion of reaction mix volume from the internal chamber(s) (e.g., to the collection container volume) is limited or prevented by positive or negative pressure gradients. In some embodiments, the CCU may be designed so that diffusion of reaction mix volume from the internal chamber(s) (e.g., to the collection container volume) is limited or prevented by gravitational force. In some embodiments, the CCU may be designed so that diffusion of reaction mix volume from the internal chamber(s) (e.g., to the collection container volume) is limited or prevented by an air gap between the reaction mix and the collection container volume.

In some embodiments, the CCU may be removed from the collection container after a volume of sample is transferred to internal chamber(s) in the CCU. The removed CCU may be then attached to another component such as a fresh tube, a plug, or similar piece. This component may serve several functions including but not limited to preventing contamination of other components of the system (e.g., heating system, sensing system) by the reaction mix in the internal chamber(s), preventing contamination of the reaction mix in the internal chamber(s) by an external material or reagent, preventing evaporation of any reaction mix in the internal chamber(s), preventing removal of any reaction mix from the internal chamber(s), or preventing any other interference with the contents or performance of the reaction. In some embodiments, the CCU or internal chamber(s) may include one or more features (e.g., notch) that permit optical characterization of a portion of reaction mix in one or more internal chamber(s). The result of the test may be read using a light source (e.g., LED, OLED) and photosensor arranged so that the optical pathway travels through a feature. In some embodiments, the CCU and internal chamber(s) may feature a light pipe to couple light from a light source through the internal chamber to a photosensor. In some embodiments, the CCU may have a flat top/outer surface. In some embodiments, the result of the test may be read by using a camera that images the top/outer surface of the CCU through which the internal chamber(s) is/are visible. In some embodiments, the CCU may be made partially or entirely from optically clear plastic or glass.

In some embodiments, an amplification reaction may be used to detect the presence of a pathogen, biomarker, or sequence of DNA or RNA in the biological material. In some embodiments, the amplification reaction may be an isothermal amplification reaction including but not limited to a loop-mediated isothermal amplification (LAMP) reaction. In some embodiments, the amplification reaction (if used) may be but not limited to a polymerase chain reaction (PCR), Recombinant Polymerase Amplification (RPA), Rolling Circle Amplification (RCA), Nucleic Acid Sequence-based Amplification (NASBA), RAMP, Transcription-mediated Amplification (TMA), Nicking and Extension Amplification Reaction (NEAR), Multiple Displacement Amplification (MDA), Helicase Dependent Amplification (HAD), or similar amplification reactions. Exemplary readout techniques that may be used in amplification reactions are described in the following article including section 3 (pages 98, 101-103, 106), section 5 (pages 118-128), section 6 (pages 134, 135): [https://abrf.memberclicks.net/assets/JBT/September_2021_Early_Access/New_additions/JBT%2032-3%20Review%20Article.pdf].

In some embodiments, the readout of a reaction in an internal chamber may be colorimetric and may further be able to be visually read by the naked eye as a simple color change. The colorimetric readout may rely on a pH-dependent dye such as phenol red in which case the color of the reaction solution may change between pink and yellow as the pH of the reaction solution changes over the course of the amplification reaction, or it may utilize a Mg2+-dependent dye such as hydroxynaphthol blue (HNB) in which case the color of the reaction solution may change between violet and blue as the Mg2+ concentration in the reaction solution changes over the course of the reaction. In some embodiments, the readout of a reaction in an internal chamber may utilize fluorescence of one or more molecules in the internal chamber (e.g., detected by a photosensor sensitive to a fluorescent wavelength). In some embodiments, the readout of a reaction in an internal chamber may be based on the peak wavelength in the transmitted light spectrum though a portion of sample fluid in the internal chamber. In some embodiments, the readout of a reaction may utilize sequence specific methods, such as molecular beacons. In some embodiments, the readout of the reaction may be based on comparing the final color (after a heating step) of a portion of a sample in the internal chamber to a target color (e.g., based on proximity to a target color point in color space, for example, CIELUV) and may optionally separately track the initial color of a portion of a sample in the internal chamber. In some embodiments, the readout may be based detecting a change in color (e.g., distance between initial and final color in color space, for example, CIELUV) of a portion of a sample in the internal chamber before and after a heating step. In some embodiments, the any of the reaction readouts described herein or any other reaction readout may indicate a positive assay result, a negative assay result, inconclusive assay result, an error, or some other result,

In some embodiments, the readout may be visual to the naked eye as a change in appearance of the reaction solution, such as a turbidity change. In some embodiments, the readout of a reaction in an internal chamber may be non-optical such as a conductivity measurement, an impedance measurement, an acoustic measurement, or a thermal measurement.

In some embodiments, the end-user may receive unfilled CCUs that they then may load with the desired reagent(s), including but not limited to amplification master mix and primer solutions. The end-user may load reagents into the CCU using a manual pipette, an automated pipette, a semi-automated or fully automated fluid handling robot, a plate filler, a fluid handling assembly-line process, by using a loading mechanism that is built into the CCU itself, or by some similar means. The user may use the CCUs fresh, freeze them for storage, dry them for storage, lyophilize them for storage, or stabilize by using a process for storage. In some embodiments, the CCUs may be pre-loaded with the desired reagent(s). Loading may be accomplished by manual pipette, by automated pipette, by semi-automated or fully automated fluid handling robot, by plate filler, fluid handling assembly-line process, or the like known in the field to accomplish such tasks. In some embodiments, the pre-loaded reagent(s) may be dried, lyophilized, frozen, or stabilized using a process for storage. In some embodiments, the CCU may comprise two or more parts where one or more parts of the CCU are first loaded with the desired reagent(s) and then attached to other part(s), e.g., to form the complete CCU. The loaded reagent(s) may be dried, lyophilized, frozen, or otherwise stabilized prior to attaching the loaded part of the CCU to other part(s). The loaded reagent(s) may be dried, lyophilized, frozen, or otherwise stabilized after attaching the loaded part of the CCU to other part(s).

In some embodiments, a test kit received by the end user may include swabs, collection containers, collection containers pre-filled with inactivation solution or other collection media, separate containers of inactivation solution or other collection media to be added to the collection container by the end user, funnels or straws intended to facilitate transfer of saliva or other biological fluid into the collection containers, CCUs pre-filled with dried, lyophilized, frozen, or otherwise stabilized amplification reagents, CCUs without amplification reagents, separate containers, pellets, or other form of dried, lyophilized, frozen, or otherwise stabilized amplification reagents to be added to the CCUs by the end user, and instructions for use.

In some embodiments, heating of reaction mix in an internal chamber of a CCU may be accomplished using a heat block, a coil-based heating unit, an oven, an incubator, a chemical reaction, a water bath, a sand bath, a bead block, or other heating element. In some embodiments, the heating unit may comprise an adaptor module such as a heat block, water bath, sand bath, bead block or similar element to couple with standard dimensions and design specifications of a standardized heating unit. In some embodiments, the heating unit may be a custom-designed or closed system. In some embodiments, the heating unit may have the capacity to accommodate one or more CCUs simultaneously. In some embodiments, a reaction may take place in a single container (e.g., a combination of sample fluid and amplification reagents in the collection container makes up the reaction mix) when the reaction container is placed into the heating unit. In some embodiments, the heating unit may comprise discrete positions in which each reaction container may be placed as in the case of a heat block. In some embodiments, only a portion of the CCU or other reaction container may be inserted into the reaction container receiver (e.g., the heat block slot). In some embodiments, the entire CCU or other reaction container may be inserted into the reaction container receiver. In some embodiments, the CCU and a portion or all of a plug that is coupled to the CCU may be inserted into the reaction container receiver. In some embodiments, the CCU and a portion or all of a sample container that is coupled to the CCU may be inserted into the reaction container receiver. In some embodiments, after inserting the reaction container into the reaction container receiver, a thermal lid may be applied that encloses the reaction container in the reaction container receiver and may promote efficient thermal transfer to the reaction container. In some embodiments, the heating unit may comprise an incubation chamber wherein the placement of the reaction containers is not fixed, e.g., using an open water bath, sand bath, bead block, or oven. In some embodiments, the heating unit may comprise an incubation chamber wherein the placement of the reaction containers is determined by a physical rack with fixed positions and this rack is placed into the incubation chamber. In some embodiments, the heating unit may accommodate a single reaction container. In some embodiments, the heating unit may accommodate two or more reaction containers. A single heating unit may accommodate 4, 12, 24, 48, or 96 reaction containers, as examples.

In some embodiments, the heating unit may be integrated together with a reading unit that measures the result of the test in a reaction container placed into the heating unit. In some embodiments, the heating unit may serve only the function of heating the reaction container while other functions such as ensuring proper placement of the reaction container in the heating unit, controlling the temperature of the heating unit, detection of the reaction result, and collection of data are performed either manually or by a separate unit or units. In some embodiments, the heating adaptor module or unit may include one or more integrated printed circuit boards (PCBs). In some embodiments, the PCBs may serve various functions including but not limited to controlling and powering heating elements, sensing and indicating proper placement of the reaction container into the heating unit, detection of the reaction result, and/or data relay to a computer. The heater/reader system may integrate a single PCB that serves one or more of these functions, a single PCB that serves all of these functions, or multiple PCBs that each serve one or more of these functions. In some embodiments, the PCBs may be designed to conduct heat to the heating unit or between different parts of the heating unit. In some embodiments, the PCBs may be designed to operate at temperatures up to 45° C., up to 55° C., up to 65° C., up to 75° C., up to 85° C., or up to 95° C.

In some embodiments, a heater/reader system may include a sensor at each position in which a reaction container may be placed; the sensor may sense whether the reaction container is properly seated in position. Such a sensor may be integrated into one or more PCBs. An indication that the reaction container is properly seated may be provided (e.g., on a display, an LED, a light bulb). This indicator may be used to inform the test operator whether or not the reaction container is properly seated in position in the heating unit for incubation. In some embodiments, there may be indicators (e.g., on a display, an LED, a light bulb) to indicate at any position in the reaction container receiver that the test has started, that the test is in process, that the test has finished, that the test has experienced an error, that a test result has been determined, that a test result has been transmitted, or result of the test. In some embodiments, a thermal interface material (e.g., thermal paste, thermal pad) may be present between the reaction container and a portion of the heating unit to ensure proper heating of the reaction mix. In some embodiments, the thermal interface material may be attached to the reaction container before the reaction container is placed on the heating unit. In some embodiments, the thermal interface material may remain attached to the reaction container after the reaction container is removed from the heating unit (e.g., at the end of the heating stage)—leaving no residue at the heating unit site. In some embodiments, the thermal interface material may be attached to the reaction container before a CCU is coupled with the collection container. In some embodiments, the heating unit may include a clamp (e.g., manual clamp engaged by the test operator, computer actuated clamp) to secure a portion of the CCU or the collection container to the heating unit before the start of the heating process.

In some embodiments, a portion of the reaction container may be made from a thermally conductive material (e.g., aluminum). In some embodiments, the reaction container may be fitted with a secondary cap or collar that is made of a thermally conductive material (e.g., aluminum) before placing the reaction container into a heating unit. In some embodiments, the secondary cap or collar may be reusable after, optionally, a cleaning or sterilization process. In some embodiments, the secondary cap or collar may be integrated into a heating unit. In some embodiments, a heater/reader may include a sensor (e.g., a camera, QR code or other barcode reader, RFID sensor, or comparable detector) capable of capturing identifying information from the reaction container. The sensor may be a single unit built into the heater/reader unit, a separate module connected to the heater/reader unit either directly or through an interfacing device such as a smartphone, tablet, laptop or desktop computer, or integrated into the PCB at one or more positions in the heater/reader. The test operator may scan, image, or otherwise detect identifying information from a reaction container prior to placing the reaction container into the heater/reader unit. The reaction container may be scanned, imaged, or otherwise identified upon placing the reaction container into position in the heater/reader unit by a scanner, camera, or other device integrated into the PCB at that position.

In some embodiments, a PCB of the heater/reader unit may include one or more integrated optical detectors in order to read the reaction result at one or more positions in the heating unit where each position can accommodate a reaction container. The PCB may comprise a single optical detector at a single position in the heating unit, multiple optical detectors at a single position in the heating unit, a single optical detector at multiple positions in the heating unit, or multiple optical detectors at multiple positions in the heating unit. In some embodiments, the optical detector(s) may include photosensors, photodiodes, cameras, fluorescence detectors, or other commonly utilized optical detection components or systems. In some embodiments, the optical pathway used by the detector(s) run parallel to the PCB, perpendicular to the PCB, at an angle relative to the PCB that is between zero and ninety degrees, or any combination thereof. The optical pathway may travel into or through the reaction mix in an internal chamber of the CCU or through a feature in the CCU that contains some or all of the internal chamber volume. In some embodiments, properties of the reaction mix (e.g., optical measurement indicating color of reaction mix) in one or more internal chambers may be measured continuously over the course of the heating process. In some embodiments, properties of the reaction mix in one or more internal chambers may be measured at specified time intervals during the heating process (e.g., every 1, 2, 5, 8, or 10 minutes).

In some embodiments, properties of the reaction mix in one or more internal chambers may be measured at the end of the heating process. The properties may comprise optical properties, e.g., absorbance, fluorescence, color, or turbidity. In some embodiments, the reading unit may be separate from the heating unit. Sample tubes and/or reaction containers may be transferred from the heating unit to a separate reading unit for measurement of the test result(s). In some embodiments, data (e.g., reaction container identifying information, properties of reaction mix, test results, and other information) may be relayed from a computer system associated with a heating unit or a computer system associated with a reading unit to one or more computer systems associated with the testing system. In some embodiments, one or more computer systems associated with the testing system may communicate with one or more communication or computing devices (e.g., smartphones, tablets, laptops or desktop computers) associated with test subject(s) to receive test registration information or to provide test results. In some embodiments, one or more computer systems may communicate with each other over a network including wired or wireless connectivity.

In some embodiments, a heating unit or reading unit may be designed to be re-usable for running multiple tests on the same unit at the same slot/position. In some embodiments, a heating unit or reading unit may include one or more slots/positions to permit multiple tests/measurements to be made concurrently. In some embodiments, a heat block may be designed so that heat is transferred from the walls of each slot in the heat block to the sides of a reaction container. In some embodiments, the bottom of a heat block may be open or otherwise transparent so that the result of a test may be read by imaging a reaction container through the bottom face of the heat block. For example, the result of the test may be read by imaging a reaction container through a water bath from underneath the water bath. The result of the test may be read by imaging the reaction container through the water bath from underneath the water bath. In some embodiments, heating may be achieved by placing one or more reaction containers in a water bath. In some embodiments, reaction containers may be first placed into a fixture, such as a floating rack, and then the fixture is placed into the water bath, heat block, or other heating unit. The reading unit may include a camera that is separate from the heating unit. In some embodiments, reaction containers may be transferred from the heating unit to the separate reading unit for measurement of test results.

### Exemplary Use Case Scenario:

An individual, who in this example is the test subject and the test operator, intends to test themself for the presence of an infectious pathogen upon entering a controlled space, such as their place of work. They may have received a test kit from their employer that contains nasal swabs, collection tubes that are QR-coded and pre-filled with an inactivation solution, and separately packaged CCUs. Before leaving the home, they and their household members each self-collect a specimen using a nasal swab and place the swabs into a collection tube that contains an inactivation solution. After placing the nasal swab into the inactivation solution and swirling several times, they discard the swabs and CCU the collection tube using a standard cap. The collection tube contains the inactivation solution and biological material collected from the biological specimens collected from the individual and their family members.

Upon reaching their place of work, the individual removes the standard cap and fastens a CCU onto the collection tube. In the CCU is embedded an internal chamber that contains: (1) the lyophilized reagents needed to perform a LAMP reaction, and (2) volume to accommodate the desired amount of sample for the test. There is a fluidic pathway between the internal chamber and the inner surface of the CCU to allow a portion of the inactivation solution and biological material to pass through the fluidic pathway into the internal chamber. The fluidic pathway may also limit the diffusion of reaction mix from inside the internal chamber back into the collection tube. The individual inverts the CCU coupled to the sample container (e.g., the reaction container) and taps it on a solid surface to induce flow from the collection tube through the fluidic pathway and into the internal chamber.

Next, the individual uses a dedicated testing application on their smartphone to scan in and register their sample, optionally including registering the individual test subjects who contributed samples to the sample pool, using a QR code printed on the CCU or collection tube. They then go to the heater/reader unit which might be set up in the atrium or reception area of their workplace. They scan their tube there a second time using a scanner that is either connected to or integrated into the heater/reader, and they then place the reaction container, with the CCU oriented down into one position of the heater/reader for incubation to run an assay. The heater/reader might contain 24 or more positions for multiple assays to be run in parallel. There is a sensor in each position of the heater/reader that senses when a reaction container is placed into it and whether it has been placed properly.

In some embodiments, if the reaction container is seated properly in position, an indicator light at that position (or an indication on an attached display) turns green in order to provide that verification to the individual. In some embodiments, if the reaction container is not seated properly in position, an indicator light at that position (or an indication on an attached display) may turn yellow to provide a warning that the reaction container is not yet properly seated for the test to proceed. Having been the most recent tube scanned, the system knows the identity of the tube that has been placed in that position. Alternatively, a scanner could be built into each individual position to detect the reaction container (e.g., using a QR code, RFID, etc.). In either case, once the reaction container has been properly inserted a timer starts for that position and the individual can either wait or take appropriate precautions such as masking and/or social distancing until a result is delivered.

While the reaction container is incubating on the heater/reader, other employees may arrive, similarly scan their own samples into their own smartphones using the QR code on their reaction caps or collection tubes, scan their tubes on the scanner at the heater/reader, and place their own tube reaction container into another position of the heater/reader to begin incubation of their own sample. In this way, samples can be processed asynchronously.

An LED/photodiode is activated at each loaded position and along with a detector is used to determine the result of the corresponding reaction. The detection may be accomplished wherein a “real time” signal from the detector is acquired at a preset time interval, such as once per minute or once per 10 seconds. Alternately an endpoint measurement can be made a single predetermined time such as 20 minutes, or 30 minutes. Light from the LED is passed through a notch, protruding from the reaction container made from optically clear plastic, including at least a portion of the assay volume and is detected at the photodiode on the other side. A signal from the photodiode is interpreted by the heater/reader to infer a test result that is then relayed (directly or through an intermediary computer system) to the individual's smartphone through the app and may optionally also relay test results to the smartphone of other test subjects who contributed samples to the sample pool.

An indicator light on the heater/reader may indicate that the tube that has just finished processing and can be removed from this position of the heater/reader, then discarded either by an attendant in the lobby or the next subject. This will open up that position for re-use by a subsequent test subject.

### Exemplary RT-LAMP-Based Detection Process:

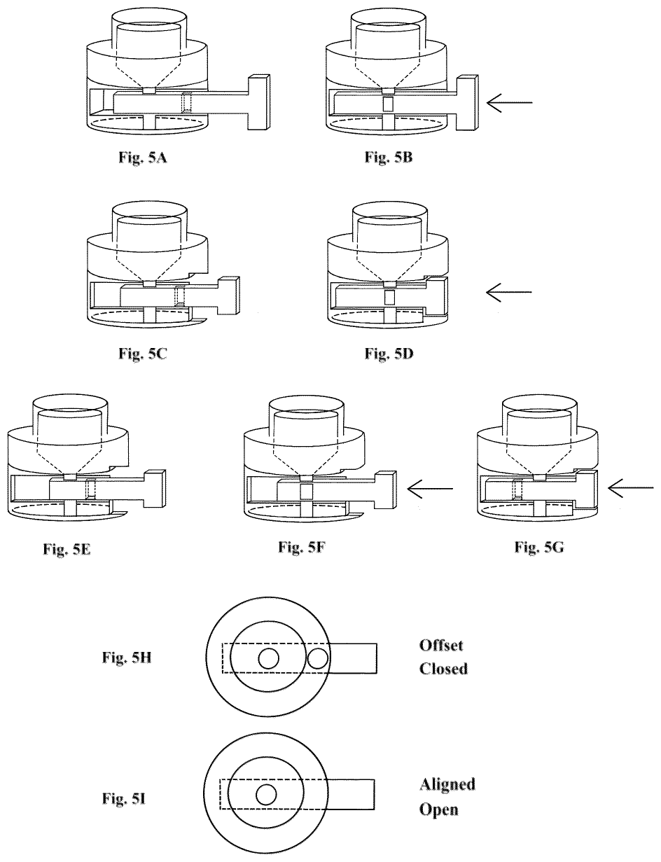

In some embodiments, a test process may utilize a variation of the assay described in the following paper: [https://www.pnas.org/doi/10.1073/pnas.2011221117] (see, for example, FIG. 5A of the paper). Compared to the medium-to-high complexity assay described in FIG. 5A of the paper, the disclosed test process is a more simple, low-complexity assay. In a two-step process that is analogous to the process described in the paper, the collection tube may be pre-loaded with an inactivation solution. The sample such as a nasal swab might be taken and added to the tube. The tube may then be capped with a standard cap, and the tube is heated to 95° C. to complete the inactivation process.

The purification steps described may then be skipped, opting instead for the direct protocol illustrated in FIG. 5A of the paper. Whereas the process described in the paper next involves the addition of 5 uL of inactivated sample to total a 25 uL RT-LAMP reaction, which requires the use of a micro pipettor, using an embodiment of the system described herein, the user may replace the standard cap with one of the reaction cap designs described herein, for example, use the dropper cap. The internal chamber of the dropper cap may come pre-loaded with a frozen volume of reagents that contains the enzymes, dNTPs, buffer components, primers and other reagents required to perform the RT-LAMP reaction. The user may invert the tube, squeeze a drop of sample into the internal chamber, press the side plunger to seal the internal chamber, and place the collection tube cap-down into a heater/reader unit for incubation and measurement of the test result. Depending on many factors such as the volume of the RT-LAMP reaction reagents, the dropper nozzle dimensions and shape, the chemical composition of the sample fluid including inactivation reagents and any other reagents such as surfactants, and the optimization of any of the reagent components or compositions, the dropper could be configured to deliver the required volume of sample to the overall reaction solution in order to achieve acceptable performance.

The removal of the process step utilizing a micropipettor is a significant factor in reducing the complexity of the test and putting the test process within reach of an unskilled novice. A micropipettor must be periodically calibrated and relies on technique and a degree of familiarity in order to operate reliably. The procedure described in the paper involves multiple stages of additions and transfers from one container to another, multiple steps of opening and closing and otherwise physically manipulating the containers. This higher degree of physical processing and exposure of container contents to the outside environment increases the risk of contamination that could negatively impact assay performance.

In comparison, the test procedure described herein may occur nearly entirely in a closed container. After initial sample collection, there may be only a single step where the user removes the standard cap and replaces it with a reaction cap. This is a simple step that requires no manipulation of the volume inside the container (addition, removal, or mixing) and so involves little risk of contamination. All other parts of the procedure may take place while the sample and the reaction volume are closed off from the outside environment, providing relatively little opportunity for contamination of the test.

### Exemplary Disease Testing Workflows:

One-Step with Post-Collection Addition [Dry Swab]:

In some embodiments, the workflow begins with the test subject(s) procuring a biological specimen, (e.g., saliva specimen, blood, or other bodily fluid/matter using a nasal swab, an oral swab, etc.), and placing the biological specimen(s) into an empty collection tube and sealing it with a standard tube cap. The test operator, who may or may not be one of the test subjects, then removes the standard tube cap from the collection tube containing the biological specimen(s). The standard tube cap may be discarded. The test operator then adds a defined volume of an inactivation solution or buffer that, in some embodiments, renders the biological specimen(s) non-infectious and further compatible with the subsequent steps of the test. In some embodiments, the biological material in the biological specimen is dispersed into the inactivation solution, making the biological material accessible to downstream molecular biology. The inactivation solution containing the dispersed biological material is hereafter referred to in this section as the “sample fluid”. The test operator then caps the tube with a reaction cap. The reaction cap is a specialized cap as described in one or more embodiments disclosed herein. In some embodiments, the reaction cap has an internal chamber that is pre-loaded with reaction mix that may be in the form of a frozen fluid, a lyophilized pellet, or other stabilized form. The internal chamber also has additional capacity to accept a volume of fluid of the sample fluid. In some embodiments, the test operator induces a volume of the sample fluid to travel into the internal chamber by inverting the tube, squeezing the tube, tapping or striking the reaction cap-down on a surface, or the like. In some embodiments, the inverted tube is then heated to or above a target temperature for or more than a target duration of time, e.g., to amplify the concentration of a detection molecule in the internal chamber. In some embodiments, the reaction cap may be heated to a temperature of 65° C. for up to 25, 30, 35, 45, or 60 minutes. In some embodiments, the inverted tube is placed into a heating unit, dry bath, or water bath. In some embodiments, to determine the result of the test the state of the internal chamber is read visually based on an inspection by the test operator or read based on a signal from a sensor in an instrument to determine the result of the test. In some embodiments, the heating system and sensing system are integrated in a single instrument.

Two-Step with Post-Collection Addition [Dry Swab]—See Description Above for Common Steps:

In some embodiments, the workflow begins with the test subject(s) procuring a biological specimen and placing the biological specimen(s) into an empty collection tube and sealing it with a standard tube cap. The test operator, who may or may not be one of the test subjects, then removes the standard cap from the collection tube, adds a defined volume of inactivation solution, and then re-caps the tube with the standard cap. In some embodiments, the test operator then places the tube in a heater at 95° C. for 5 minutes in either a water bath or dry bath (1st step). The combination of inactivation solution and heating will render the biological specimen(s) non-infectious and further compatible with the subsequent steps of the test by dispersing biological material into the inactivation solution, making the biological material accessible to downstream molecular biology, and removing or inactivating components that may degrade the target molecules or interfere with downstream molecular biology. In some embodiments, the test operator waits 5 minutes for the sample fluid to cool, then removes the standard cap and caps the tube with a reaction cap. The inverted tube (with a volume of sample fluid in the internal chamber of the reaction cap) is then heated at the necessary temperature for the required duration of time (2nd step). The state of the internal chamber is then read to infer the result of the test.

One-Step with Pre-Collection Addition [Wet Swabs]—See Description Above for Common Steps:

In some embodiments, the workflow begins with the test subject(s) procuring a biological specimen and then placing the biological specimen(s) in an open collection tube that is pre-filled with an inactivation solution, retaining the standard cap. The test subject(s) mix the biological specimen(s), e.g., swirl nasal swab(s), in the inactivation solution to render the biological specimen(s) non-infectious and further compatible with the subsequent steps of the test by dispersing biological material into the inactivation solution and making the biological material accessible to downstream molecular biology, and then re-cap the tube with the standard cap. The test operator, who may or may not be one of the test subjects, removes the standard cap and replaces it with a reaction cap. The inverted tube (with a volume of sample fluid in the internal chamber of the reaction cap) is then heated at the necessary temperature for the required duration of time. The state of the internal chamber is then read to infer the result of the test.

Two-Step with Pre-Collection Addition [Wet Swabs]—See Description Above for Common Steps:

In some embodiments, the workflow begins with the test subject(s) procuring a biological specimen and then placing the biological specimen(s) in an open collection tube that is pre-filled with an inactivation solution, retaining the standard cap. The test subject(s) mix the biological specimen(s), e.g., swirl nasal swab(s), in the inactivation solution and then re-cap the tube using the standard cap. In some embodiments, the test operator, who may or may not be one of the test subjects, then places the collection tube in a heater at 95° C. for 5 minutes in either a water bath or dry bath (1st step). In some embodiments, the test operator waits 5 minutes for the sample to cool, then removes the standard cap and caps the tube with a reaction cap. The inverted tube (with a volume of sample fluid in the internal chamber of the reaction cap) is then heated at the necessary temperature for the required duration of time (2nd step). The state of the internal chamber is then read to infer the result of the test.

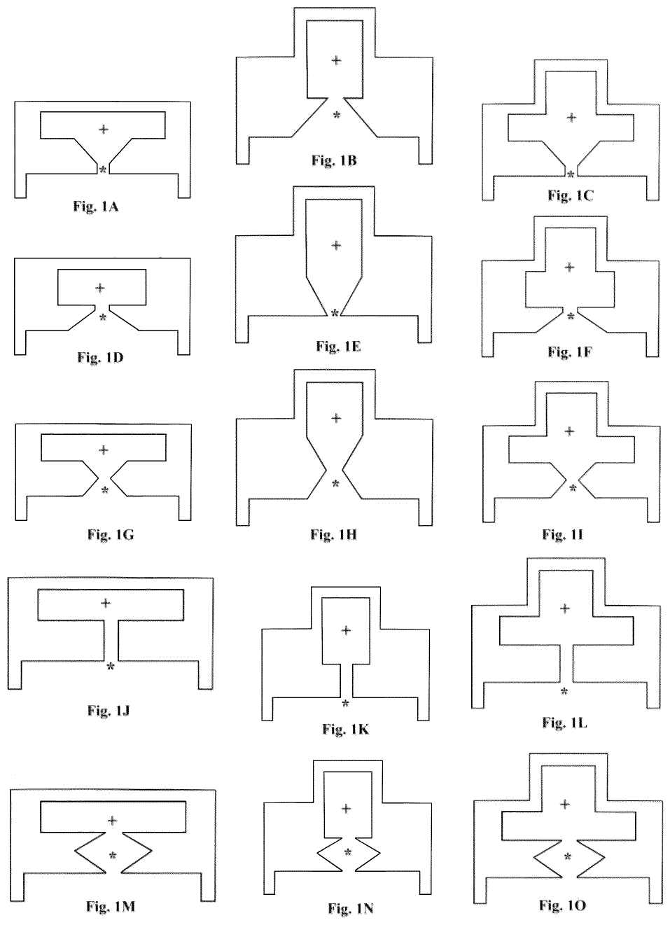

FIGS. 1A-O (arranged left to right, top to bottom as: A-C, D-F, G-I, J-L, M-O) illustrate various geometries that may be used for a CCU, including internal chamber indicted by (+) and fluidic pathway indicated by (*)—shown in cross-sectional profile view. In these embodiments, the illustrations depict monolithic pieces with no moving parts; however, similar variations in design may be employed in other example designs described herein, including those that are composed of multiple pieces or those with moving parts. The CCU may feature a fluidic pathway that widens from the inner surface of the CCU to the internal chamber (FIG. 1A), that narrows from the inner surface of the CCU to the internal chamber (FIG. 1B), that narrows at any point between the inner surface of the CCU and the internal chamber (FIG. 1C), that widens at any point between the inner surface of the CCU and the internal chamber with constrictions on each end (FIGS. 1D-I, M-O), or that is a constant width from the inner surface of the CCU to the internal chamber (FIGS. 1J-L). The cross-sectional view of the fluidic pathway itself may be rounded such as a circle or oval. Or, it may be flat-edged such as squared, rectangular or hexagonal. The fluidic pathway may contain one or more dividing walls to create two or more parallel fluidic pathways. It may contain one or more grooves that run lengthwise along the primary pathway. The CCU may include a protrusion or notch from its top outer surface where some or all of the internal chamber is nested inside the notch (FIGS. 1B, C, E, F, K, L, N, O). Any portion of the internal chamber that is not nested within the notch may be of the same width as the portion of the internal chamber that is nested within the notch or it may be wider or more narrow (only the wider version is depicted above). In the examples above, the illustrations depict largely squared geometries in cross-sectional view, however in some embodiments these geometries may be rounded.

In some embodiments, the CCU may include a coupling interface, e.g., an opening, wherein the CCU is configured to couple to the sample container via the coupling interface. In some embodiments, a CCU may be coupled to a collection container (e.g., collection tube) using a screw interface on the top of the collection container and a coupling interface comprising a screw interface on the CCU. In some embodiments, a CCU may be coupled to a collection container using a coupling interface comprising a press-fit interface on the CCU mated to a corresponding interface on the collection container. In some embodiments, a CCU may be connected (e.g., via a hinge) to the collection container. In some embodiments, a CCU or a collection container may contain a gasket to mitigate leaks from the coupling interface once the CCU is coupled to the collection container.

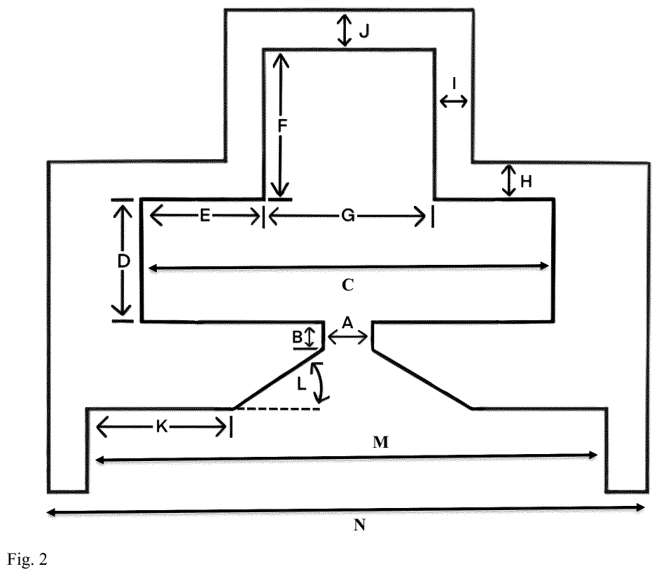

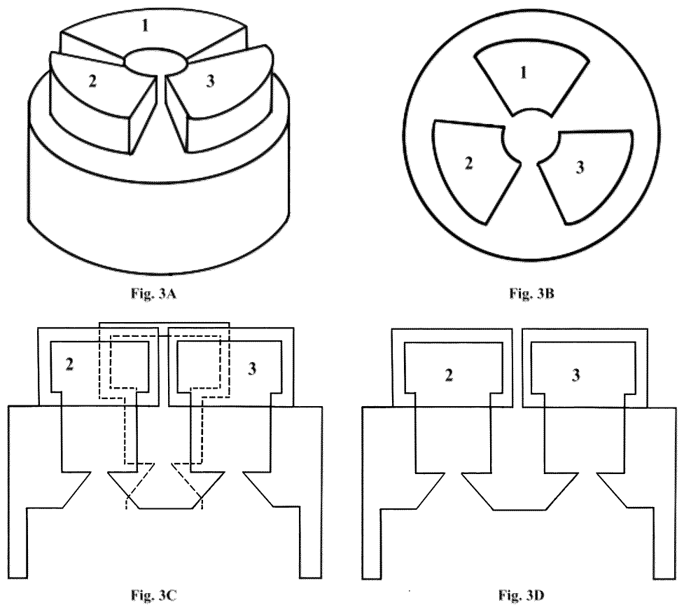

FIG. 2 illustrates a cross-sectional view of an exemplary CCU design. In some embodiments, the dimensions (A-K) may be varied to optimize the function and performance of the CCU, as well as one angle that may be varied (L). Dimensions M and N may be varied based on the sample container to which the CCU is coupled. Comparable adjustments may be made to any of the other possible CCU designs described herein, including to angles not depicted in this instance, for example, the angle used in the case where the fluidic pathway widens in the direction from the inner surface of the CCU to the internal chamber.

As illustrated in FIGS. 3A-D, the CCU may include one or more internal chambers, each connected to the inner surface of the CCU via a fluidic pathway. An embodiment with three internal chambers (1-3) in a CCU is depicted in FIG. 3. A perspective view is shown in FIG. 3A. A plan view is shown in FIG. 3B. Sectional views are shown in FIGS. 3C and 3D. In FIG. 3D (compared to FIG. 3C), the rear internal chamber (chamber 1) has been removed for clarity. The multiple internal chambers may be used to test for multiple biomarkers in parallel (e.g., one internal chamber configured to test for COVID19, another internal configured to test for the flu, remaining internal chamber configured as a negative control). In some embodiments, testing on different internal chambers may proceed in series (instead of proceeding in parallel)—e.g., first internal chamber heated at 45° C. for 20 min followed by a read of results for the first internal chamber (e.g., testing for flu) followed by second internal chamber heated at 65° C. for 30 min followed by a read of results for the second internal chamber. The multiple internal chambers may be used to provide additional confidence in the result of the test by providing multiple replicates of the same assay (e.g., all internal chambers configured to test for COVID19).

The multiple internal chambers may be used to provide additional confidence in the result of the test by providing an opportunity to include positive and/or negative controls in parallel with the test. In some embodiments, a positive control may be configured to result in a color change matching the expected color change for a “positive” test result. In some embodiments, a negative control may be configured to result in no color change matching the expected color change for a “negative” test result.

In some embodiments, the assay parameters applied to each internal chamber including but not limited to the test start time, test time period, target test time, measurement type (e.g., optical, conductivity, impedance, acoustic), measurement parameters (e.g., wavelength) may be the same. In some embodiments, the assay parameters applied to each internal chamber may be different.

In some embodiments, an internal chamber may be used as a control to confirm the heating process in a single step testing flow. In some embodiments, a reaction mix not sampled from the collection container may be used to confirm the heating process—the reaction mix to confirm the heating process may be designed to change color if the CCU heating process matches a target heating process (e.g., heating at 65° C. for 25 minutes).

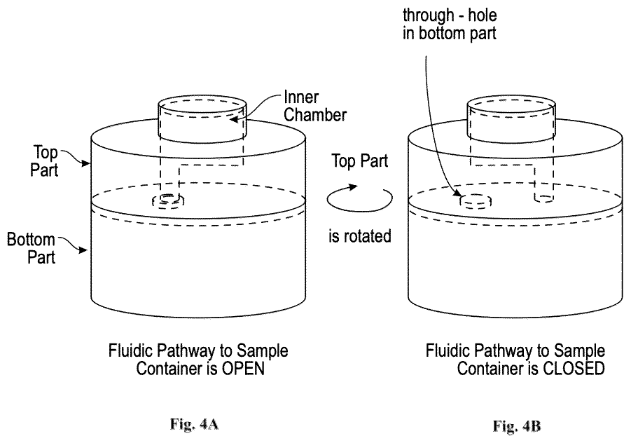

The CCU may consist of two or more interconnected parts that move in relation to one another as illustrated in FIGS. 4A, B. Such movement may open and or seal the fluidic pathway between the internal chamber (in the top part) and the inner surface of the CCU (in the bottom part). In the embodiment, two parts to the CCU each contain one part of the fluidic pathway. When the two parts (top part, bottom part) are in a specific orientation relative to one another, these parts align, and the fluidic pathway is open (FIG. 4A). When one part is then rotated with respect to the other, these parts become misaligned, and the fluidic pathway is sealed (FIG. 4B).

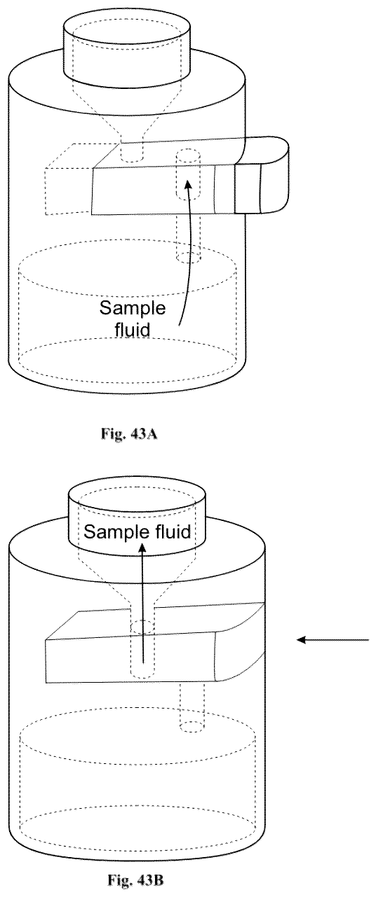

In some embodiments, as illustrated in FIGS. 5A-I and 43A-B, a CCU may be designed to have configurable fluidic communication between an internal chamber and the volume of a collection container. The exemplary CCUs illustrated in FIG. 5 consists of a primary part that surrounds a secondary sliding part. The secondary sliding part contains a through-hole. This through-hole can be aligned with the fluidic pathway rendering it open (FIGS. 5B, D, F, I) or it can be misaligned with the fluidic pathway rendering it closed (FIGS. 5A, C, E, G, H). These states can be achieved by sliding the secondary part relative to the primary part. In some embodiments, the secondary part may nest entirely inside the primary part when pressed inward. Plan views (FIGS. 5H, I) show the CCU in closed/offset and open/aligned states. An exemplary CCU illustrated in FIG. 43 shows a case where in a first position (FIG. 43A), the through-hole in the secondary sliding part aligns with the lower through-hole in the primary part that connects to the collection container internal volume when coupled with the collection container (collection container not illustrated). When in this first position, sample fluid from the collection container may enter the through-hole in the secondary sliding part. The secondary sliding part may then be moved to a second position (FIG. 43B) by inserting this secondary sliding part into the primary part. In this second position, the through-hole in the secondary sliding part aligns with the upper through-hole in the primary part that connects to the internal chamber. When in this second position, sample fluid from the through-hole in the secondary sliding part may enter the internal chamber.

The exemplary CCU system shown in FIGS. 6A-C consists of a plunger (FIG. 6A), a sheath-tube assembly (FIG. 6B), and an optional spacer collar (shown in FIG. 6C, with plunger FIG. 6A inserted part way into the sheath-tube assembly FIG. 6B). The plunger includes an internal chamber with a fluidic pathway. The sheath-tube includes a tube with an open top (for inserting the plunger) and an opening for sample fluid intake on the side. The illustration in FIG. 6C shows the assembled CCU before it is coupled to a collection container; for CCU assembly, the plunger is inserted into the sheath-tube, and an optional spacer collar may be used to maintain the bottom of the plunger above a portion of the side opening in the sheath-tube.

In the illustrated example shown in FIG. 6D, the sheath-tube screws onto the collection container top. In the configuration shown in FIG. 6D, fluid in the collection container (light gray) enters the “tube” portion of the sheath-tube via the side opening (shown as dark gray). With the optional spacer collar removed (as shown in FIG. 6E), images FIGS. 6F, G, H show the plunger moving down to the bottom of the sheath-tube. In the plunger positions shown between FIGS. 6F, G, the plunger displaces the fluid inside the sheath-tube back into the collection container. As the plunger moves from the position shown in FIGS. 6G, H, with the fluid in the sheath-tube no longer able to move back to the collection container (with plunger bottom below the side opening in the sheath-tube), the fluid from the sheath-tube is displaced into the fluidic pathway in the plunger (indicated by up-pointing arrow in FIG. 6H) and into the internal chamber—as shown in FIG. 6E. In some embodiments, there may be a locking mechanism to secure the depressed plunger in the “down” state and prevent it from moving back up. With the fluid in the internal chamber, the reaction container may be inverted and inserted into a heating unit.

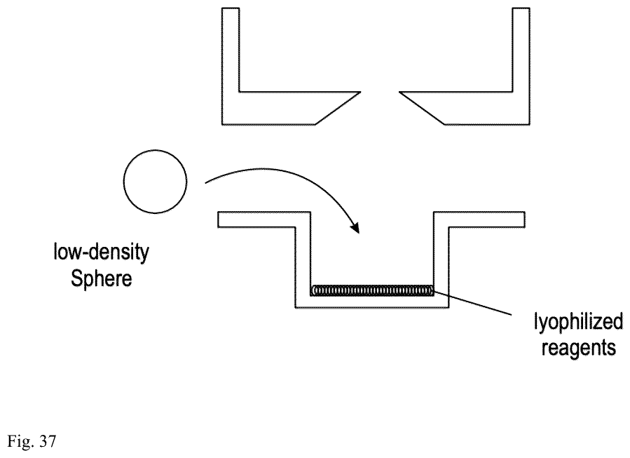

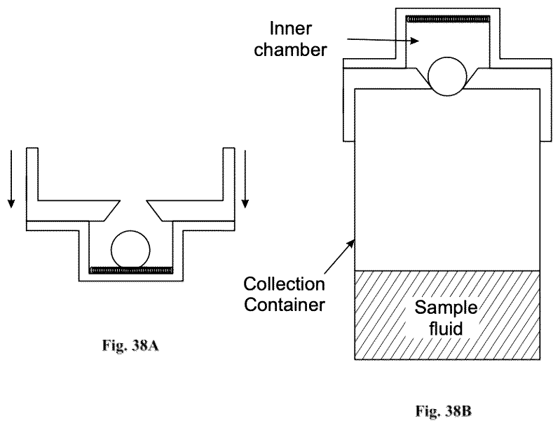

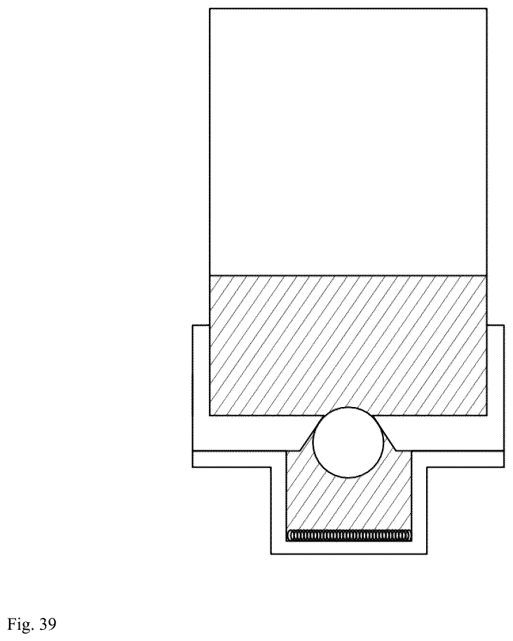

FIGS. 37, 38A-B, and 39 illustrate the assembly and function of a CCU that incorporates a low-density ball that is included inside the internal chamber. Importantly, the diameter of the low-density ball is greater than the diameter of the circular opening that separates the internal chamber from the volume of the collection container, and the density of the ball is lower than the density of the sample fluid so that the ball floats when immersed in the sample fluid. Incorporation of the low-density ball inside the internal chamber may be achieved by producing the CCU in two parts (see FIG. 37) and incorporating the low-density sphere during assembly and bonding of the two parts together (see FIG. 38B). When the tube is inverted and sample fluid enters the internal chamber, the low-density ball floats on top of the fluid that is inside the internal chamber (see FIG. 38A). When the volume of fluid in the internal chamber increases sufficiently to cause the low-density ball to rise and come into contact with the circular opening, it may form an effective barrier to prevent diffusion of reagents or movement of fluid between the internal chamber and the collection container (see FIG. 39).

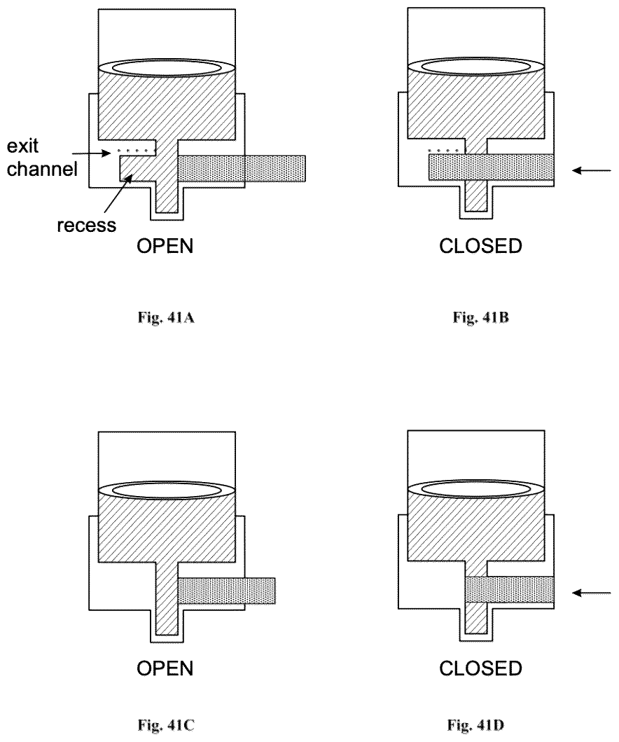

As depicted in FIGS. 41A-D, a gate valve may be used to close off the opening between the internal chamber and the collection container volume after the internal chamber has been filled with sample fluid (FIGS. 41B, D). In order to form an effective seal, there may be a recess on the far side of the opening in which the gate valve may fit (see FIGS. 41A, B). In this case there may be an exit channel (depicted with a dotted line above) that runs along the recess and provides fluid in the recess to escape back into the collection container side as the gate valve displaces this volume. In some embodiments, the gate valve and the portion of the CCU that houses the gate valve may feature ridges and grooves to guide or control the movement of the gate valve, see, for example, FIG. 34. In some embodiments, the ridges and grooves may be used to prevent the gate valve from being withdrawn from the CCU. In some embodiments, the ridges and grooves may be used to lock the gate valve in position after it has been inserted into the CCU thereby preventing it from being withdrawn.

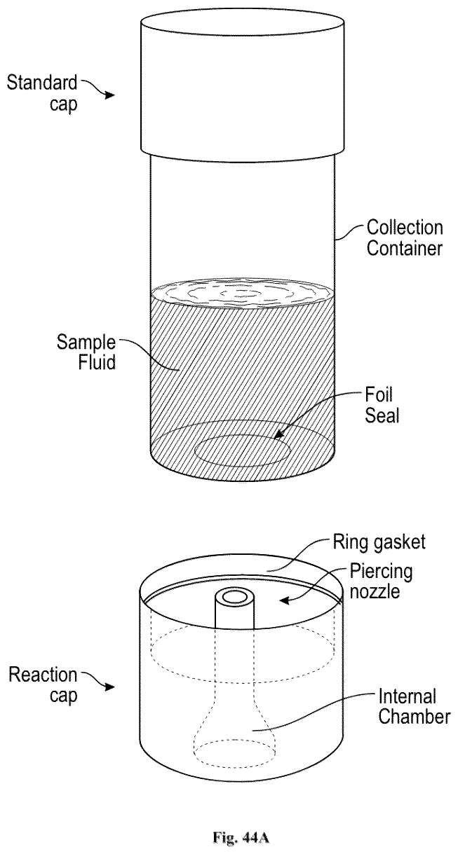

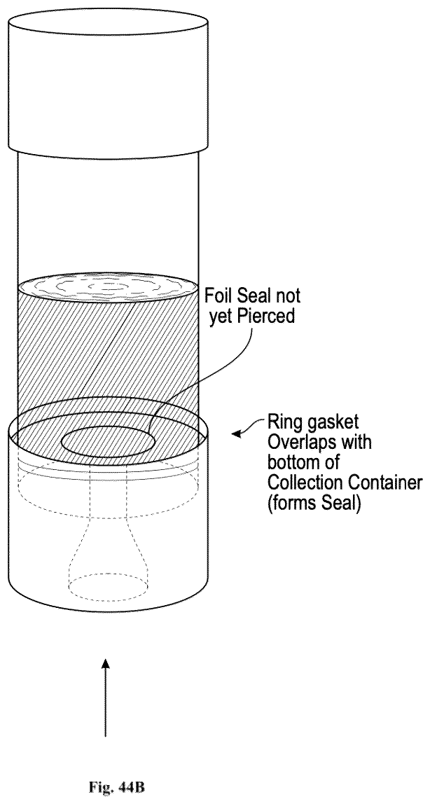

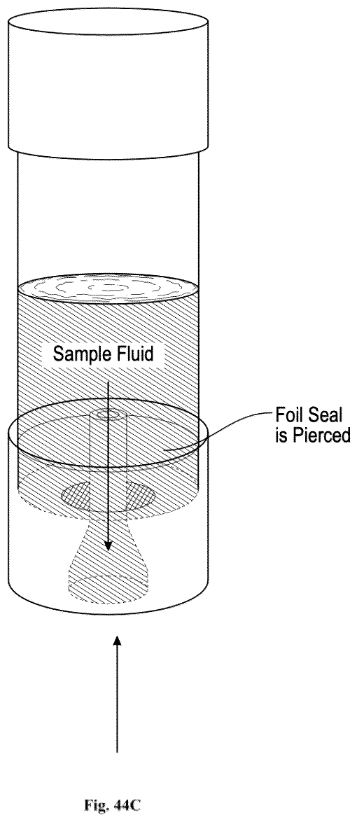

In some embodiments, a CCU may be attached to the bottom of a collection container. An exemplary case is shown in FIG. 44A with the collection container having a pierceable foil seal at its base. The CCU may be attached to the base using a press-fit, snap-cap, screwcap, or other attachment method. In some embodiments, a ring gasket may be included on the inner surface of the CCU where it may contact the collection container as shown in FIG. 44A. In some embodiments, a ring gasket may be included on the outer surface of the base of the collection container where it may contact the CCU (not depicted). The CCU may include a piercing nozzle that protrudes from the inner surface of the CCU, see FIG. 44A. This piercing nozzle may contain a fluidic pathway that connects to the internal chamber inside the CCU, see FIG. 44A. As the CCU is applied and before the piercing nozzle pierces the foil seal (see FIG. 44B), the ring gasket may form a seal between the collection container and the CCU in order to prevent leakage of the sample fluid from the collection container/CCU assembly when the foil seal is pierced. When applied further (see FIG. 44C), the piercing nozzle may pierce the foil seal and sample fluid may enter the internal chamber via the fluidic pathway within the piercing nozzle.

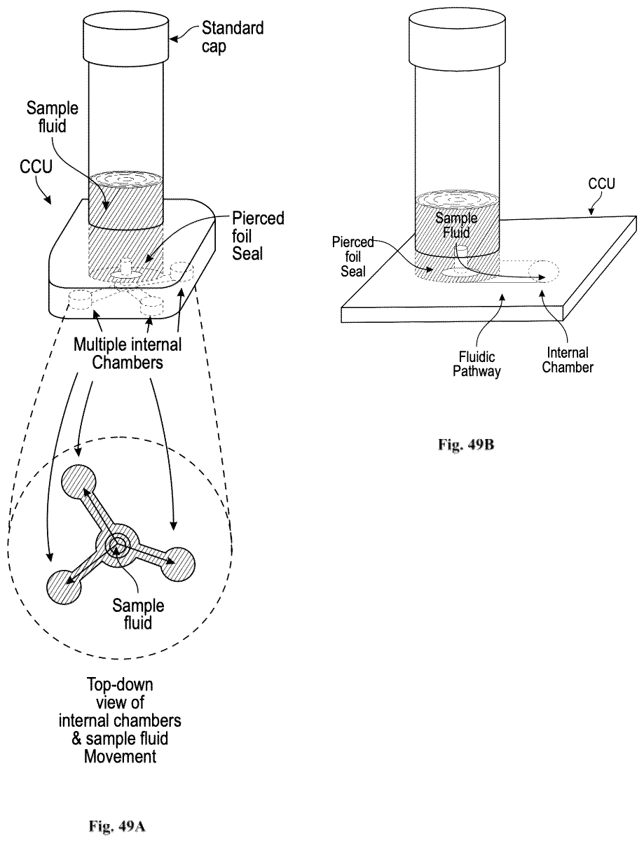

In some embodiments, CCUs may comprise a variety of aspect ratios, sizes, and shapes. For example, FIG. 49A depicts an embodiment wherein the CCU is of a greater depth and width compared to other embodiments previously described, featuring multiple internal chambers. FIG. 49B depicts an embodiment wherein the CCU is of a different aspect ratio, having a greater width and a shallow depth, and a narrow channel along the width of the CCU that connects to an internal chamber. In some embodiments, the reaction container, which may comprise a sample container coupled to a CCU, may be an independent unit that may feature an integrated heating and/or reading unit. In some embodiments, the reaction container, which may comprise a sample container coupled to a CCU, may be inserted into a heater/reader which may include a hot plate or water bath. In some embodiments, two or more reaction containers (e.g., sample container coupled to a CCU) may be processed asynchronously in a multi-slot heater/reader unit. In some embodiments, the assay result may be visually read or read optically by a reading unit.

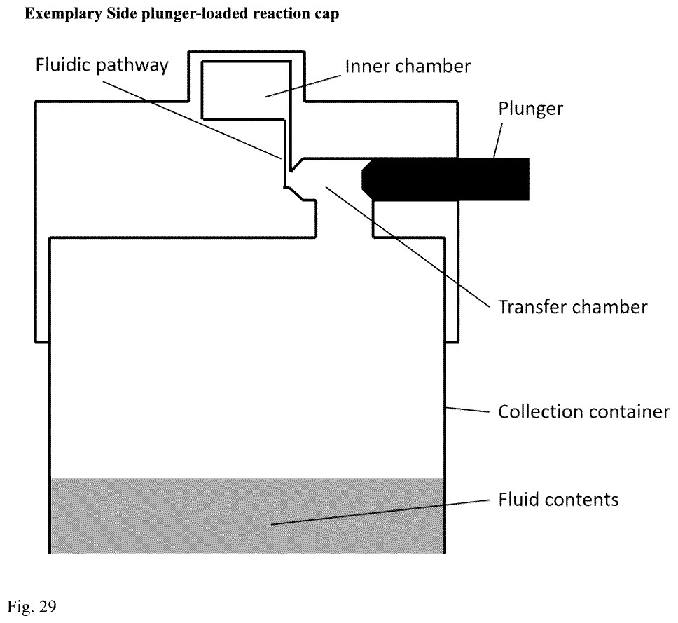

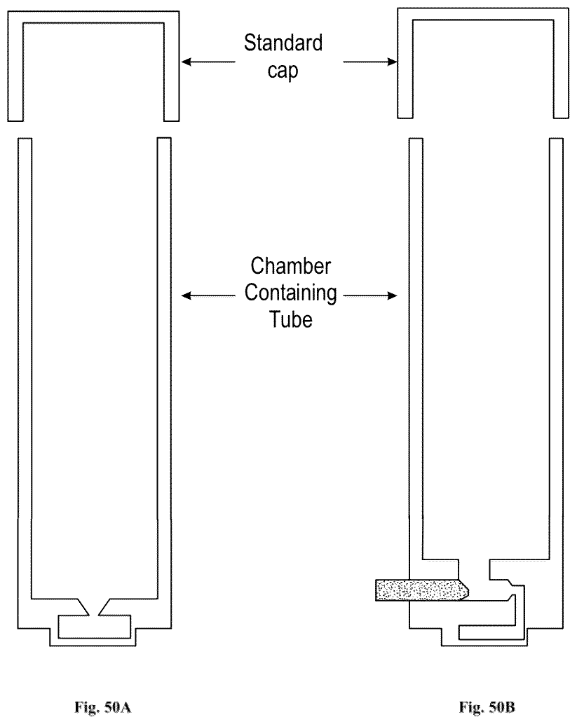

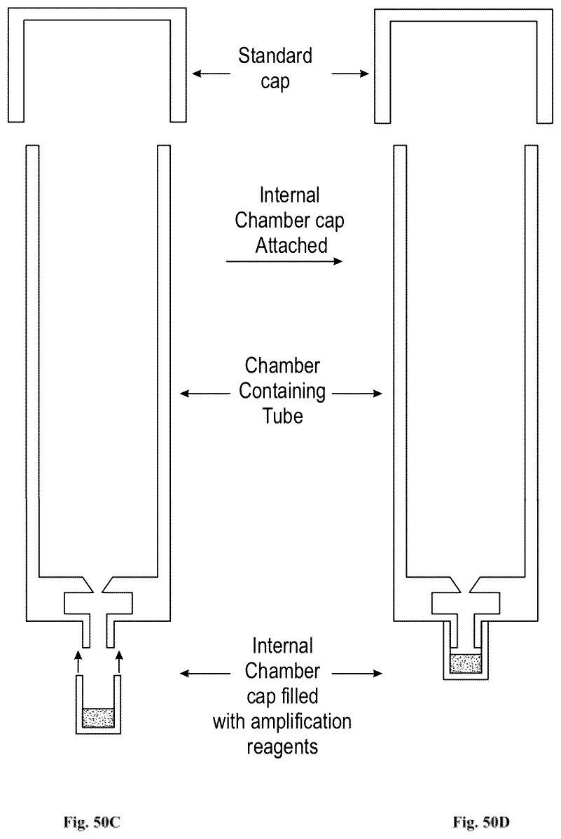

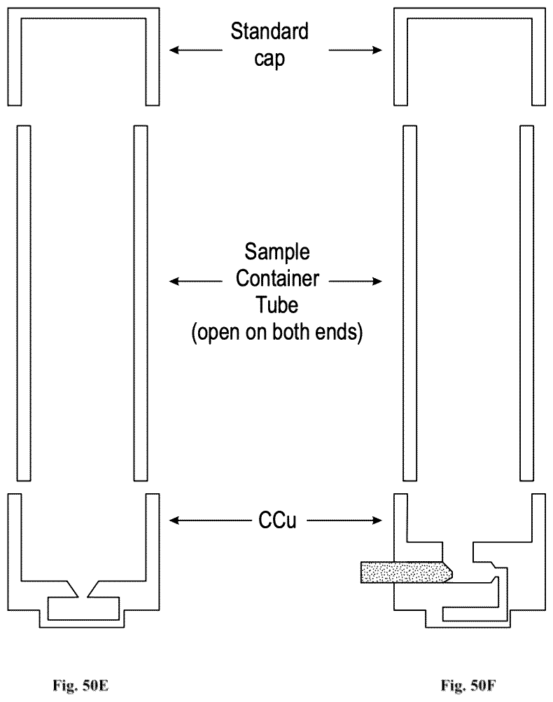

In some embodiments, features described herein that may be used to sequester a portion of sample fluid from the total volume of sample fluid including but not limited to internal chambers, fluidic pathways, transfer chambers, plungers, gate valves, constrictions, etc. may be designed to be a part of or integrate with the sample container. In some embodiments, these features may be designed into any part of the sample container including the bottom, the walls, the rim, etc. FIGS. 50A-F show exemplary embodiments that may be designed into the bottom of the sample container. FIG. 50A depicts a simple fluidic pathway with a constriction that leads to an internal chamber. FIG. 50B depicts a side-plunger-loaded design that is similar to the CCU embodiment depicted in FIG. 29, whereas in this example the features are designed into the bottom of the sample container. The plunger mechanism may be used to inject a volume of sample fluid into the internal chamber in a manner similar to that described previously. After adding sample fluid to the sample container, the sample containers depicted in FIGS. 50A and 50B may be capped with a standard cap. In some embodiments, a portion of the internal chamber may be provided as a separate part that may be filled with reaction reagents. These reaction reagents may be dried, lyophilized, frozen, or stabilized by some other means. The separate internal chamber part may be attached to the sample container to form a sealed internal chamber. FIG. 50C depicts an embodiment in which the fluidic pathway and a portion of the internal chamber, similar to those depicted in FIG. 50A, are designed into the bottom of the sample container and another portion of the internal chamber is provided as a separate part. Reaction reagents for an amplification reaction may be included in the separate internal chamber part, referred to as an “internal chamber cap”, (FIG. 50C). The internal chamber cap may then be attached to the bottom of the sample container to seal the completed internal chamber (FIG. 50D). After sample fluid has been added to the sample container, the sample container may be capped with a standard cap. In some embodiments, the sample container may comprise a tube with multiple openings (FIGS. 50E, F). In some embodiments, a CCU may be coupled to one or more openings of a tube with multiple openings. In some embodiments, a standard cap may be used to cap one or more openings of a tube with multiple openings. Attachment of the one or more CCUs, the one or more standard caps, and addition of sample fluid to the sample container may occur in any sequence. FIGS. 50E and 50F depict CCUs with similar design features to those depicted in FIGS. 50A and 50B, respectively. In some embodiments, the test operator may first attach the CCUs depicted in FIGS. 50E and 50F to one end of the tube that features openings on both ends. Sample fluid may then be added to the sample container with at least a portion of the CCU below the sample fluid. The sample container may then be capped on the other end with a standard cap. The test operator may then induce a volume of sample to transfer to the internal chamber of the CCU by methods previously described.

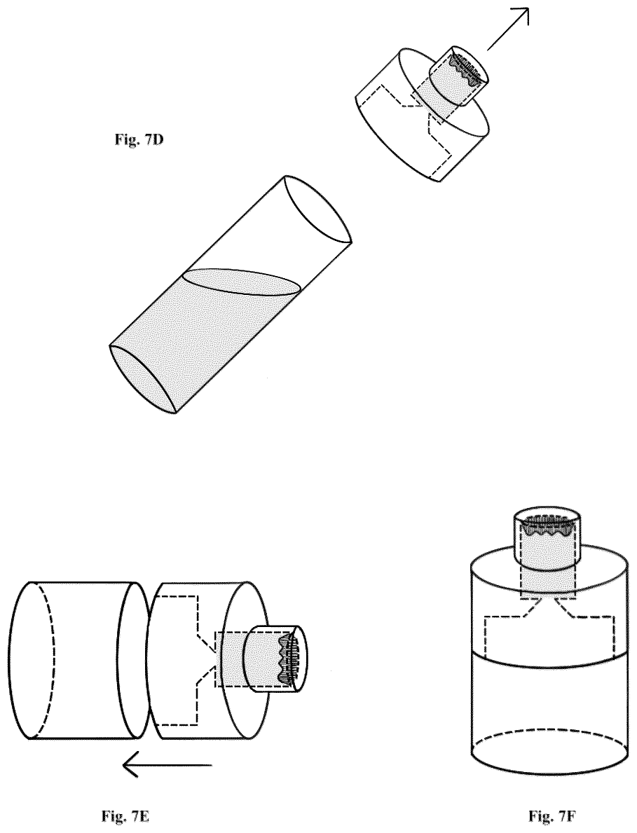

As illustrated in FIG. 7, after inducing sample fluid to enter the internal chamber of an exemplary CCU, possibly by inverting the tube and tapping it on a hard surface such as a tabletop (steps A-C), the CCU may be removed from the collection container (step D). The separate CCU may then be sealed by attaching it to another container, plug, or other piece used to seal the contents of the internal chamber inside the CCU (step E). The resulting CCU assembly (step F) may be tested as described herein. This system could be combined with a mechanism to seal the volume within the internal chamber after sample fluid is transferred to the internal chamber, such as the side-plunger mechanism described in FIG. 21 to close the constriction in the CCU.

There are several possible benefits to this approach. One such benefit is in reducing the risk that the contents of the internal chamber might diffuse into the larger sample volume of the collection container during the course of the reaction incubation. Another possible benefit is that the same sample fluid may be added to multiple, different CCUs in series. By adding the same sample fluid to multiple, different CCUs, the user may test for multiple biomarkers in parallel from the same sample. The multiple CCUs may also be used to provide additional confidence in the result of an individual test by providing multiple replicates of the same assay. The multiple CCUs may be used to provide additional confidence in the result of the test by providing an opportunity to include positive and/or negative controls to be run in parallel with the test.

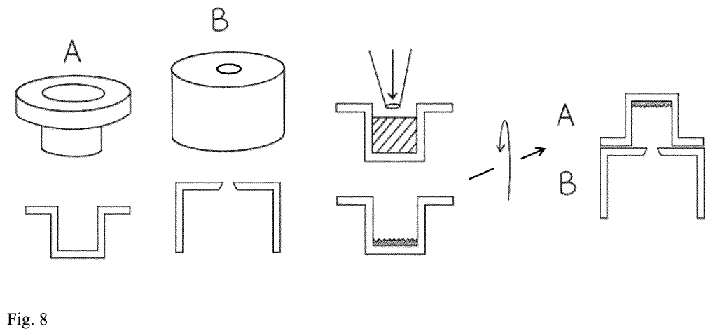

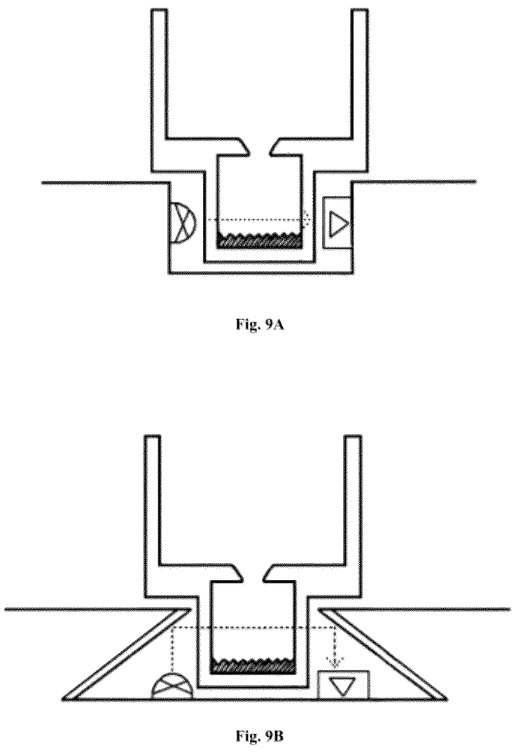

A CCU may be produced in multiple parts that are then combined at a later manufacturing step as illustrated in exemplary process in FIG. 8. As illustrated above, the internal chamber part (A) may be produced separately from the lower part of the CCU (B). The internal chamber part A may be made of optically clear plastic. The lower part of the CCU B may be made of optically clear plastic, polypropylene, or some other material such as another plastic. The internal chamber part A may be filled with the reagents necessary for the amplification reaction using a manual pipette, a fluid handling robot, assembly-line fluid handling process, or the like. Multiple CCUs may be placed into a tray that fits on a deck position of a fluid handling robot to be filled in parallel by the fluid handling robot. The amplification reagents may be lyophilized inside the internal chamber part A. Pre-lyophilized reagent may be added to the internal chamber part A. Amplification reagents may be frozen or otherwise stabilized after being added to the internal chamber part A. After amplification reagents are added to the internal chamber part A, the internal chamber part A may be glued, melted, bonded, or otherwise attached to the lower part of the CCU B.

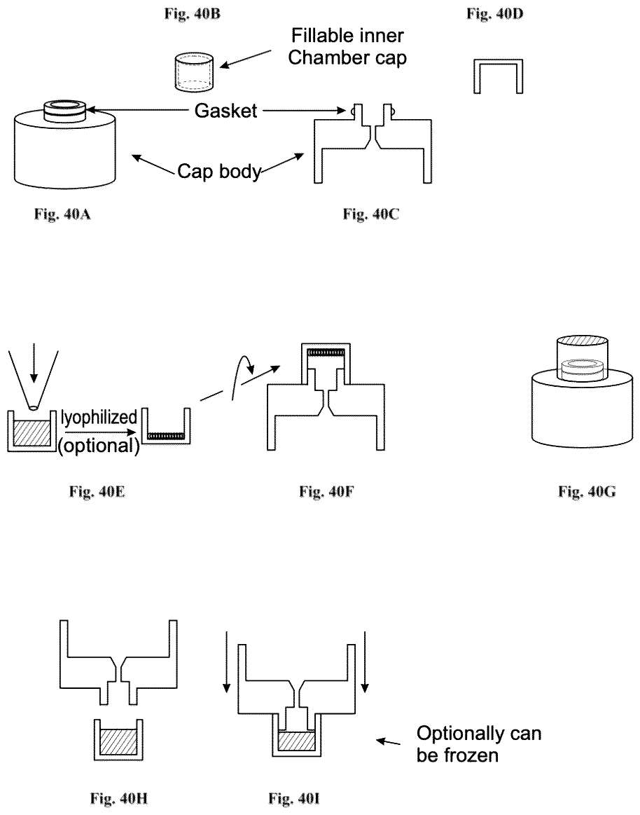

Similarly, as illustrated in FIGS. 40A-I, the internal chamber part, labeled as the “inner chamber cap” (FIGS. 40B, D), may be designed as a simple container that is optionally made of optically clear plastic and may be press-fit or screw-fit onto the lower part or cap body (FIGS. 40A, C). There may be a gasket between the internal chamber part and the cap body in order to prevent leaking of any fluid from the CCU. There may be a locking mechanism such as interlocking plastic protrusions or indentations (shown in FIG. 40C) on the adjacent surfaces of the internal chamber part and the cap body to irreversibly hold the internal chamber part in place after being attached to the cap body. The internal chamber part can be filled with reagents necessary for the amplification reaction using a manual pipette, a fluid handling robot, assembly-line fluid handling process, or the like. Multiple CCUs may be placed into a tray that fits on a deck position of a fluid handling robot to be filled in parallel by the fluid handling robot. The amplification reagents may be lyophilized inside the internal chamber part (FIGS. 40E-G). Pre-lyophilized reagent may be added to the internal chamber part. Amplification reagents may be frozen or otherwise stabilized after being added to the internal chamber part. After amplification reagents are added to the internal chamber part (FIG. 40H), the internal chamber part may be press-fit, screwed onto, glued to, melted to, bonded to, or otherwise attached to the CCU (FIG. 40I).

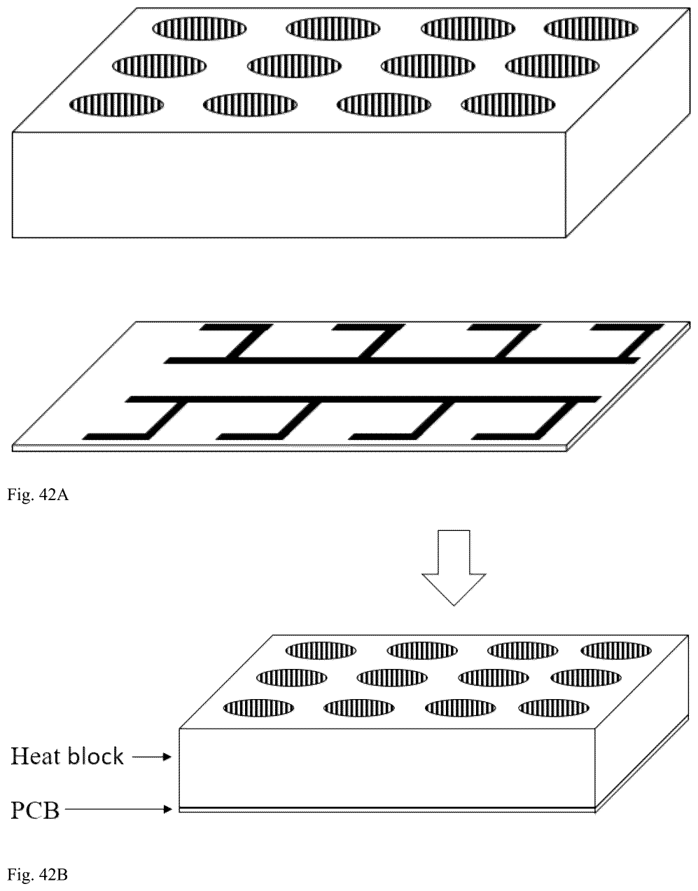

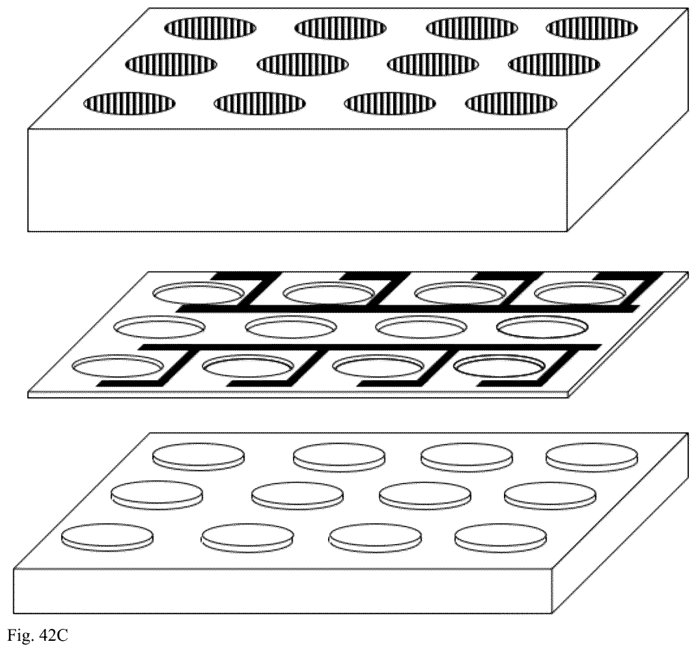

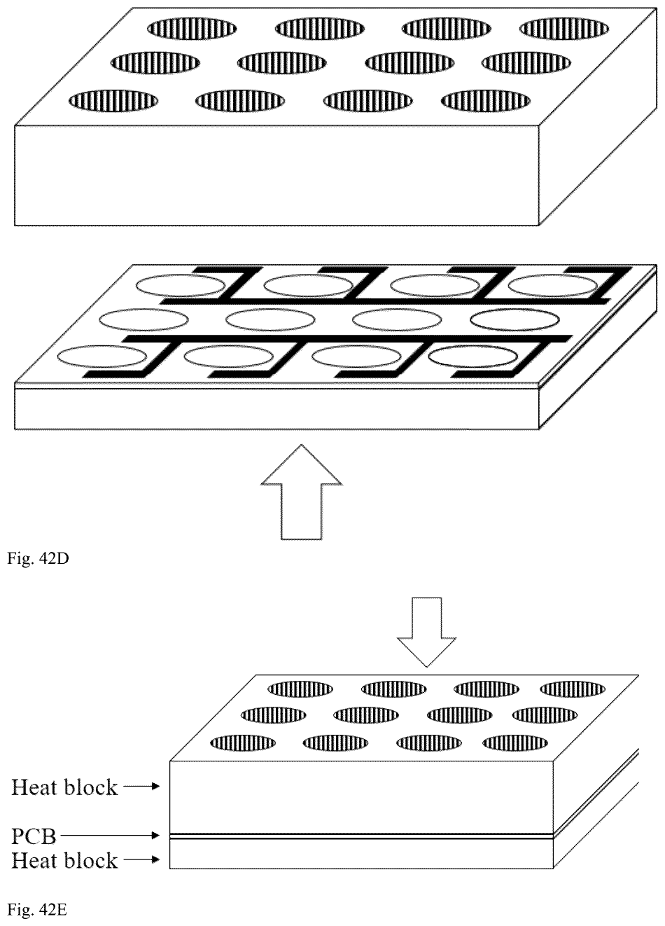

As illustrated in FIG. 42, the heating unit may include a heat block (FIG. 42A, top) that is comprised of a block of material, such as aluminum, with through-holes that allow the reaction container, which may be a CCU/collection container assembly or a reaction tube, to fit inside as well as a PCB (FIG. 42A, bottom) that integrates any of several functions including but not limited to control of heating of the heat block, sensing placement of reaction containers into the various slots in the heat block, and taking optical measurements of the reaction at certain timepoints. The PCB substrate may be made in large part of a thermally conductive material such as aluminum or copper. The heat block and the PCB assemble together (FIG. 42B), and that assembly may in turn be fit into a powered heating unit. In some embodiments, the heat block/PCB assembly may include a heat block with through-holes (FIG. 42C, top), a PCB with through-holes (FIG. 42C, middle), and a lower heat block with raised discs (FIG. 42C, bottom) that are designed to fit into the through-holes in the PCB when these two lower parts are assembled (FIG. 42D). This may provide more efficient heating to the reaction container. When fully assembled (FIG. 42E), the PCB layer is between the two heat block parts, and this assembly can then be fit into a powered heating unit.

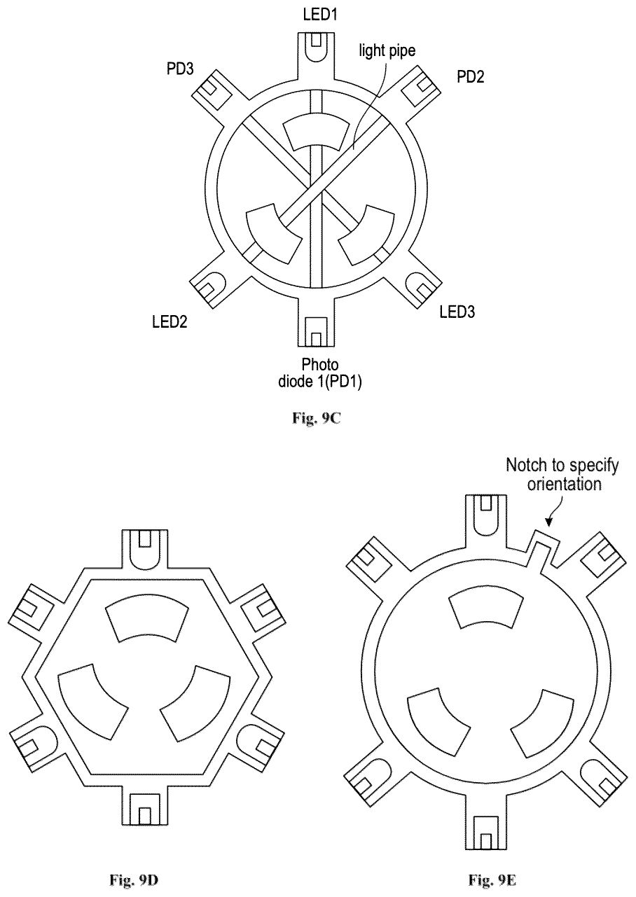

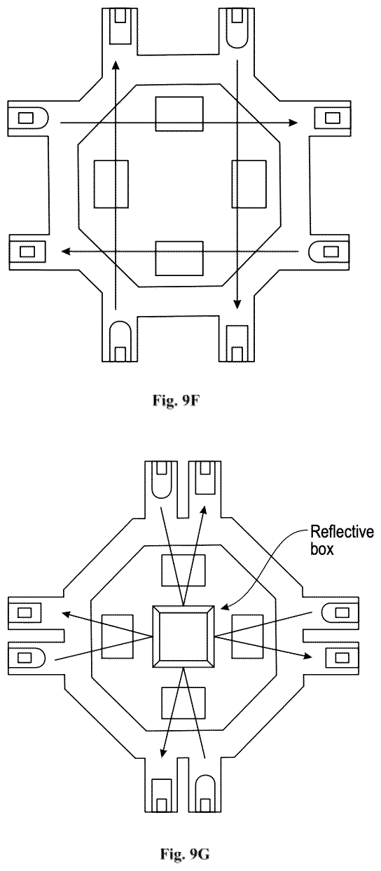

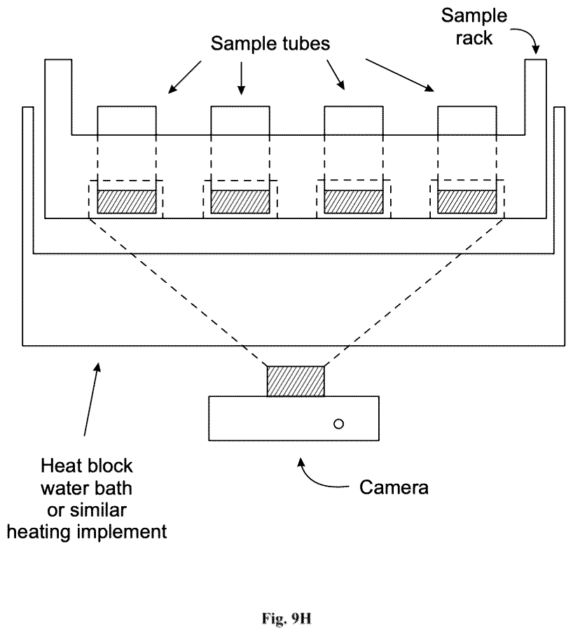

When placed into the reading unit that may or may not be the same as the heating unit, some or all of one or more of the internal chambers may protrude externally from the CCU surface into a part of the reading system where there is a light source (e.g., LED)/photosensor pair (FIG. 9A, B). The light source/photosensor pair may be arranged so that they are on opposite sides of the notch (FIG. 9A). The light source/photosensor pair may be arranged so that they are on the same surface and a reflective surface or reflective surfaces are used to guide the optical pathway between the pair to pass through the internal chamber notch (FIG. 9B). In some embodiments, there may be multiple internal chambers in a single reaction container (FIG. 9C-G). Measurements may be performed on each internal chamber individually using light source-photosensor pairs that are arranged so that the internal chamber is in the optical pathway between the light source and the photosensor (FIG. 9C-G).

In some embodiments, a light pipe may be used to guide the optical pathway from a light source through the internal chamber and to a photosensor (FIG. 9C). In some embodiments, a single light source or a single photosensor may be used to illuminate or to measure, respectively, different internal chambers—for example, by placing a single photosensor in the center of the design variation based on FIG. 9C; the single photosensor measuring the light from LEDs 1-3 (one at a time) to measure data for the 3 internal chambers. Such coupling using light pipes may be arranged for each internal chamber. In some embodiments, there may be an aspect to the reaction container design such as an asymmetry or shape that does not allow for free rotation or unconstrained placement of the reaction container into the reading unit (FIG. 9D, E). This design feature may be used to ensure that each internal chamber is placed optimally for measurement of the test result. Measurement of the test result may be performed by camera (FIG. 9H).

In some embodiments, the incubation may take place in a water bath such that the internal chambers in the reaction container are visible from underneath and can be imaged from beneath the water bath. In some embodiments, multiple reaction containers may be placed in a tray that is placed into a heat block, water bath, or similar incubation device. In some embodiments, the reaction containers may be transferred from the heat block, water bath, or similar incubation device to an imaging station where a camera is used to measure the result of the test. In some embodiments (not illustrated above), the measurement of the reaction result from multiple internal chambers in a single reaction container may be performed using a single LED as the light source and a separate photodetector for each internal chamber. In some embodiments (not illustrated above), the measurement of the reaction result from multiple internal chambers in a single reaction container may be performed using a single photodetector and a separate LED as a light source for each internal chamber.

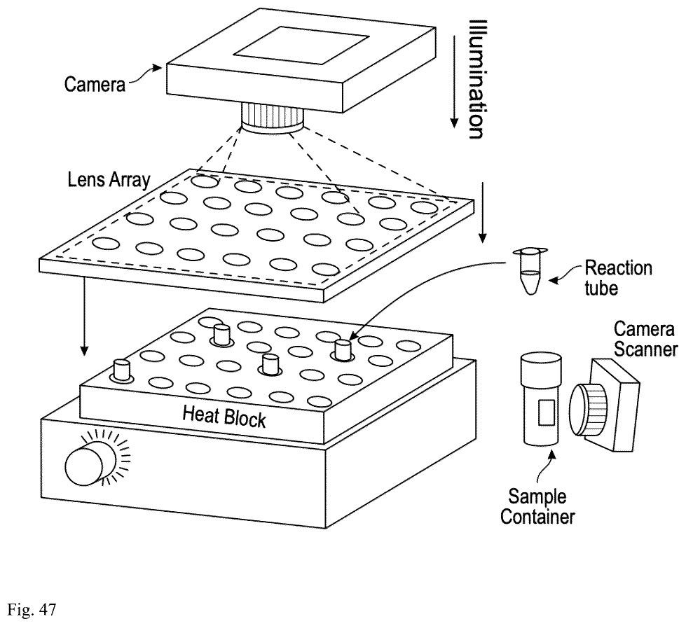

In some embodiments, as illustrated in FIG. 47, a camera that may be in communication with the system may be positioned above a heating unit to perform the functions of both registering the positions of reaction containers in the heating unit and taking measurements of the assay results. After preparing a reaction container, which may include a sample container, the user may register the reaction container or sample container with the system by scanning a QR code containing identifying information for that sample (e.g., identifying information for the test subject(s) who contributed specimen(s) to the sample) using a camera or other scanning instrument that may be in communication with the system. This may or may not be the same camera that performs the functions of both registering the position of reaction containers and taking assay measurements. The user may then place the reaction container onto the heating unit for incubation of the reaction. The camera that may be positioned above the heating unit may also be in communication with a computing device (not depicted) that may contain image processing software that may allow it to detect the position of a reaction container that was most-recently placed into the heating unit. The computing device may also be in communication with the heating unit and the additional camera/scanner (if any is present). The computing device may identify the most-recently placed reaction container with the sample container that was most recently scanned into the system via its QR code. In some embodiments, the camera's depth of field or focal plane may be adjusted to image an internal chamber in the reaction chamber. In some embodiments, the camera may image an optical property (e.g., color, turbidity) of a portion of the internal chamber to determine a test result associated with the imaged internal chamber.

The system may also include a lens array that may hinge, rotate, slide, or otherwise move between at least two configurations. When the lens array is in the first configuration, the heating unit may be unobstructed so that a user can place a reaction container into a position of the heating unit. When the lens array is in the second configuration, a lens may be directly above each position of the heating unit. Each lens may be less than 10 mm, 5 mm, 2 mm, 1 mm, or 0.1 mm distance from the top of a reaction container placed in the respective position of the heating unit. Each lens may guide light from the reaction container, when present, in the respective position of the heating unit to the camera in order to facilitate taking a measurement of the assay result in that reaction container. Illumination of the reaction containers may come from a light source that may be positioned above the heating unit. In some embodiments, the light source may be an LED or array of LEDs that is integrated into the lens array. The lens array may be constructed of plastic, glass, metal, or any combination thereof. In some embodiments, the lenses may be shaped lenses or diffraction gratings. In some embodiments, the lens array may be attached or fit to a PCB that contains holes at each lens position. In some embodiments, the PCB may feature the LED or array of LEDs that may be used to provide illumination of samples. After each reaction container is placed into the heating unit, the camera that may be positioned above the heating unit may capture images for assay measurement at pre-determined time points or time intervals at the beginning of the assay, at the end of the assay, and at any interval in between the beginning and end of the assay. Image processing software in the computing device may be used to interpret the images captured and to infer assay result(s). The result(s) may be communicated to the user or test subject(s) to their personal device(s) via a network.

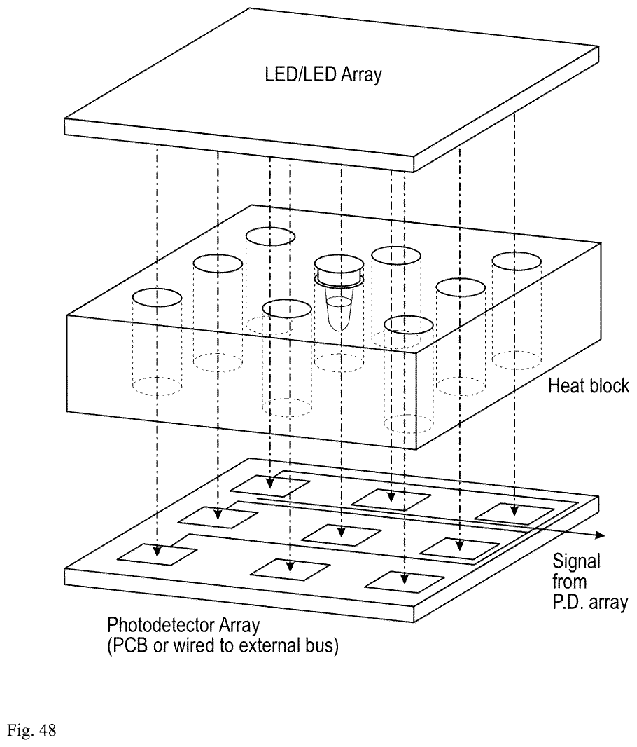

In some embodiments, as illustrated in FIG. 48, the heat block may comprise reaction container slots or holes that are through-holes cut into the block. In some embodiments, these through-holes may narrow in diameter from top to bottom. In some embodiments, the diameter of the through-hole in the bottom of the block may be less than 20 mm, 10 mm, 5 mm, 4 mm, 3 mm, 2 mm, 1 mm, or 0.5 mm. In some embodiments a light source such as an LED or LED array may be positioned above the heat block and illuminate the reaction container from above when taking measurement(s) of the assay(s). In some embodiments, there may be an array of photodetectors underneath the heat block. These photodetectors may be arranged so that they are aligned with the through-holes that are cut through the heat block. In some embodiments, the photodetectors may be integrated into a PCB. In some embodiments, the photodetectors provide an optical measurement, e.g., absorbance measurement, color measurement. In some embodiments, the individual photodetectors in the array may be wired to an external bus. In some embodiments, the photodetector array may be thermally conductive in order to allow for efficient heat transfer to the heat block. In some embodiments, there may be one or more optical sensors, e.g., one or more cameras, underneath the heat block. In some embodiments, the photodetector or optical sensor may detect a change in an optical property of an internal chamber of the reaction container. In some embodiments, the detected change of the optical property may be used to determine a test result associated with the imaged internal chamber.

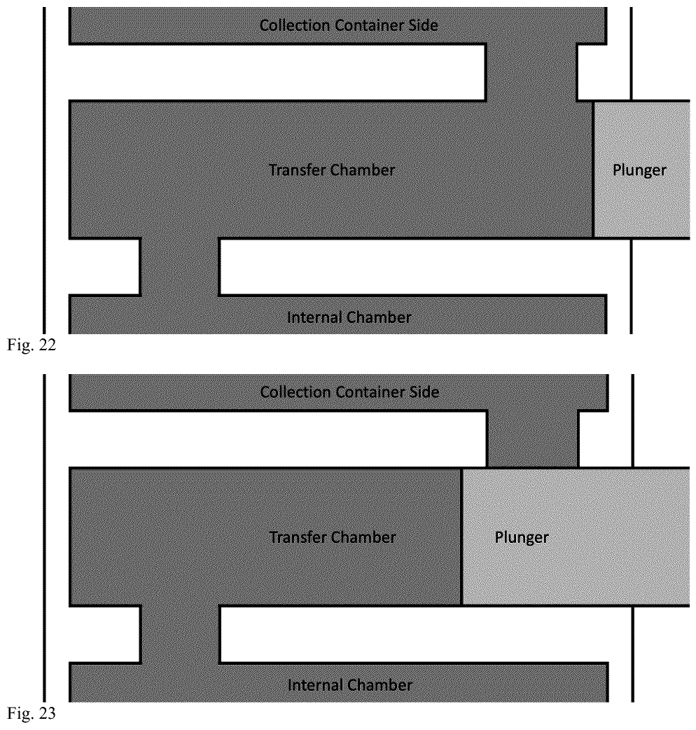

FIG. 22 illustrates a partial cross-section view of an exemplary CCU showing the collection container side (top), a transfer chamber (middle), and an internal chamber (bottom). The CCU illustrated in FIG. 22 includes the transfer chamber, the internal chamber, and a plunger (right) which is movable in the horizontal direction. The transfer chamber is connected to the collection container side on the right (top). The transfer chamber is connected to the internal chamber on the left (bottom). In some embodiments, the fluid with the biological material on the collection container side may not transfer into the internal chamber when the collection container with the CCU is inverted (e.g., due to air/gas trapped in portions of the internal chamber or portions of the transfer chamber).

In some embodiments, the dimensions or other aspects of the fluidic pathways between the collection container and the transfer chamber and between the transfer chamber and the internal chamber may be adjusted to promote the transfer of sample fluid into the transfer chamber by gravitational force or tapping on a surface while not allowing the sample fluid to continue into the internal chamber until the plunger is depressed. For example, the fluidic pathway between the collection container and the transfer chamber may be wider than the fluidic pathway between the transfer chamber and the internal chamber, or the fluidic pathway between the collection container and the transfer chamber may be treated with a hydrophilic coating and the fluidic pathway between the transfer chamber and the internal chamber may be treated with a hydrophobic coating.

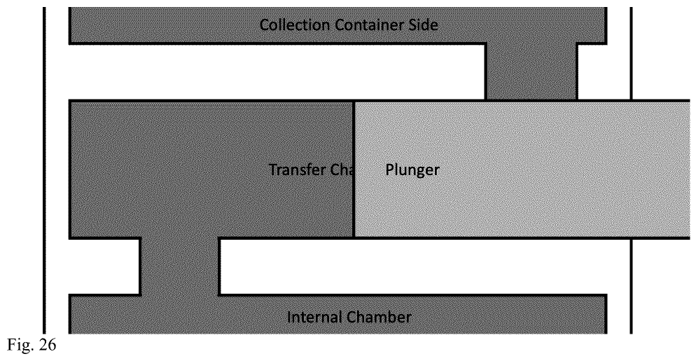

If some fluid with the biological material moves into the transfer chamber (with plunger located at the right as shown in FIG. 22), a portion of that fluid (with the biological material) may be moved into the internal chamber using the plunger as illustrated in FIGS. 22-25 below. As the plunger is moved from the right to the left (as illustrated in sequence shown in FIGS. 22-25), some of the fluid that is inside the transfer chamber may be displaced into the internal chamber. In some embodiments, after moving the plunger from the right to the left as illustrated in FIGS. 22-25, the plunger may be moved back to the right as illustrated in FIG. 26, for example, to move some of the air/gas (if present) from the internal chamber into the transfer chamber; any fluid transferred into the internal chamber based on the motion of the plunger would rest at the bottom of the internal chamber (not shown). A test may be performed using the fluid transferred into the internal chamber, for example, with the plunger in the state shown in FIG. 25 or 26. See also FIGS. 29 to 36A-F.

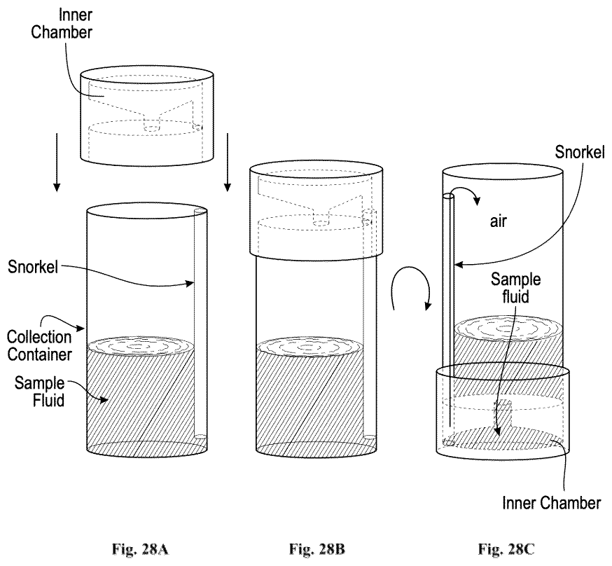

As shown in FIGS. 27 & 28A-C, in some embodiments, a venting tube or “snorkel” may be used to facilitate the flow of air from the internal chamber as it is displaced by a volume of sample fluid. In some embodiments, the tube may be directly connected to the CCU and inserted into the collection container when the CCU is attached to the collection container (FIG. 27). In some embodiments, there may be a snorkel attached to the inner wall of the collection container that aligns with another portion of the snorkel (FIGS. 28A-C), which may in some embodiments be a tube or in some embodiments be a channel that may be built into the CCU, when the CCU is attached to the collection container. In some embodiments, the snorkel may be of a sufficient length that when the CCU/collection container assembly is inverted, the top of the snorkel protrudes above the fluid level of the sample fluid that may be in the collection container.

### Exemplary Side Plunger-Loaded CCU

In some embodiments, the CCU may consist of two or more parts including a primary housing part that may contain one or more internal chambers, fluidic pathways, and transfer chambers as well as one or more plungers. In some embodiments, the transfer chamber may be connected to the inner surface of the CCU by a channel that may be sufficiently wide to allow fluid to travel freely into the transfer chamber when the reaction container is inverted, optionally using a flicking, snap-down, tapping or other physical manipulation to induce fluid to travel into the transfer chamber.

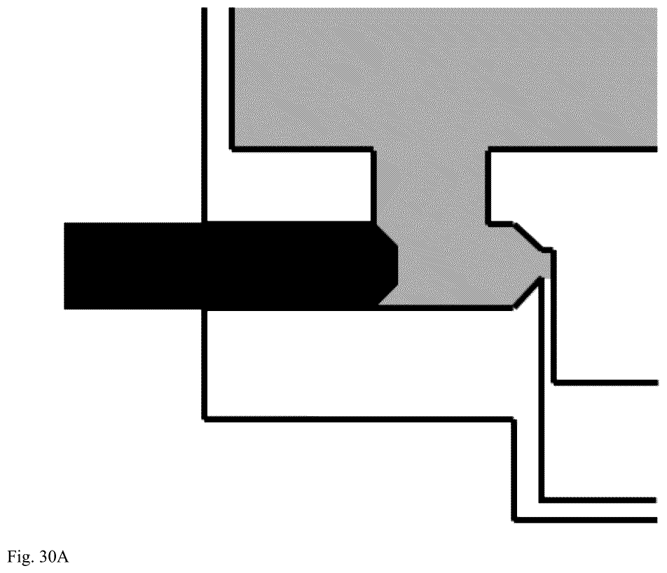

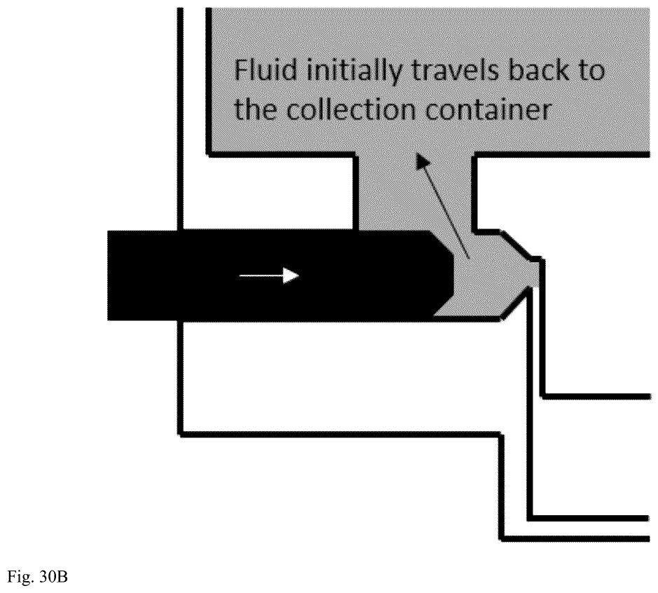

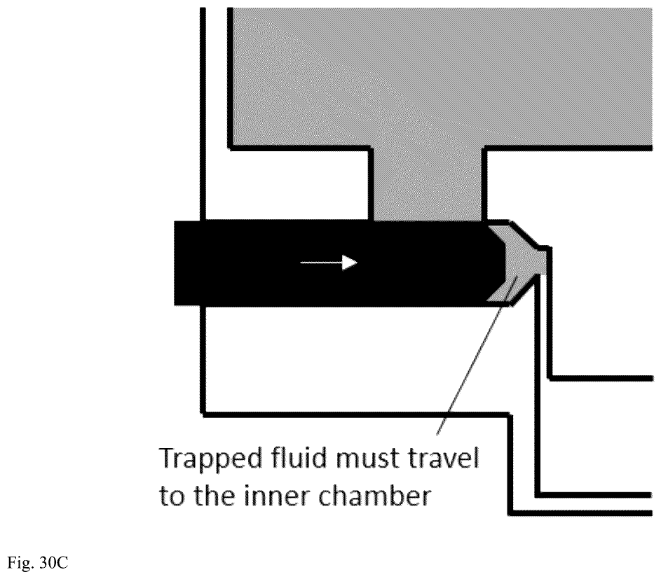

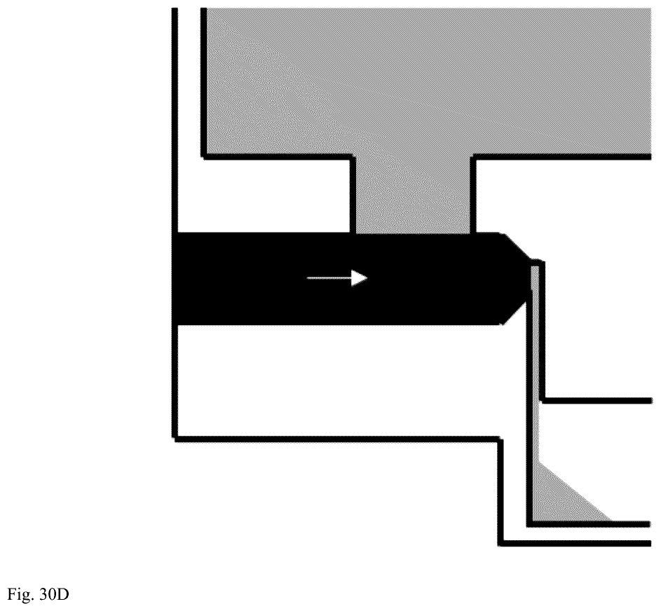

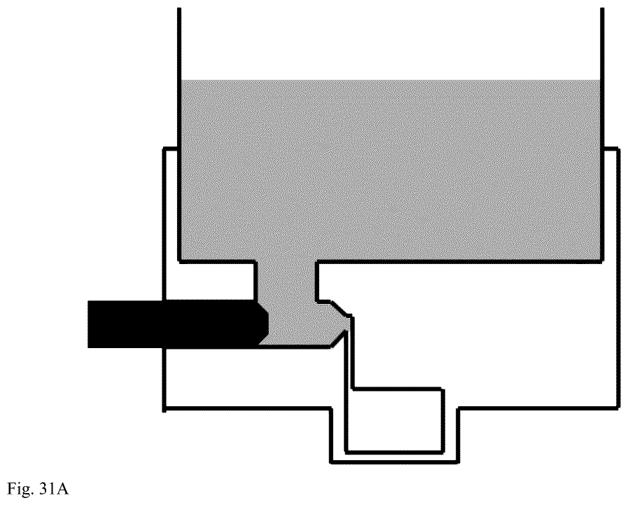

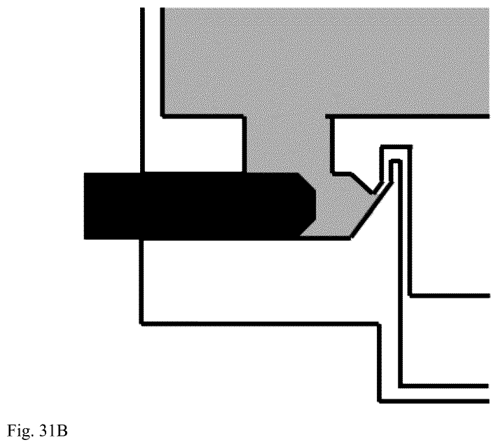

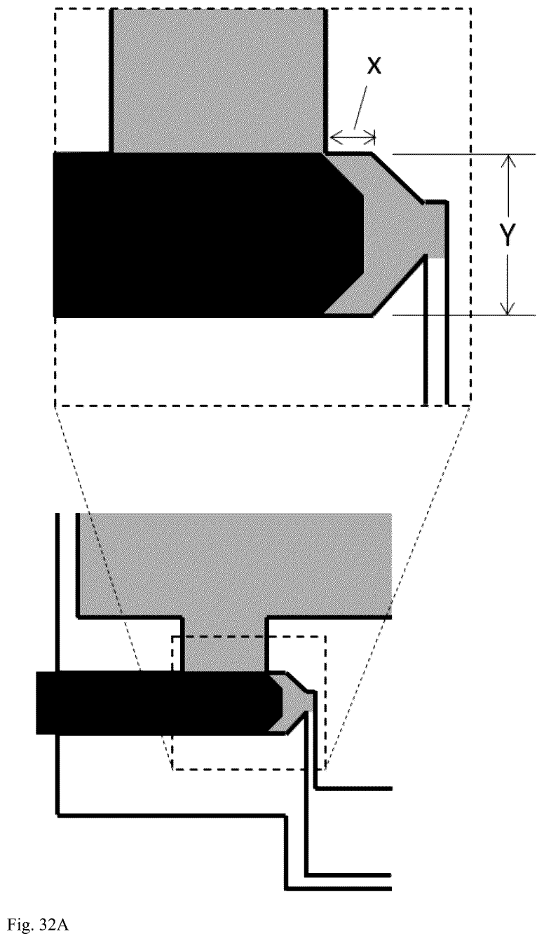

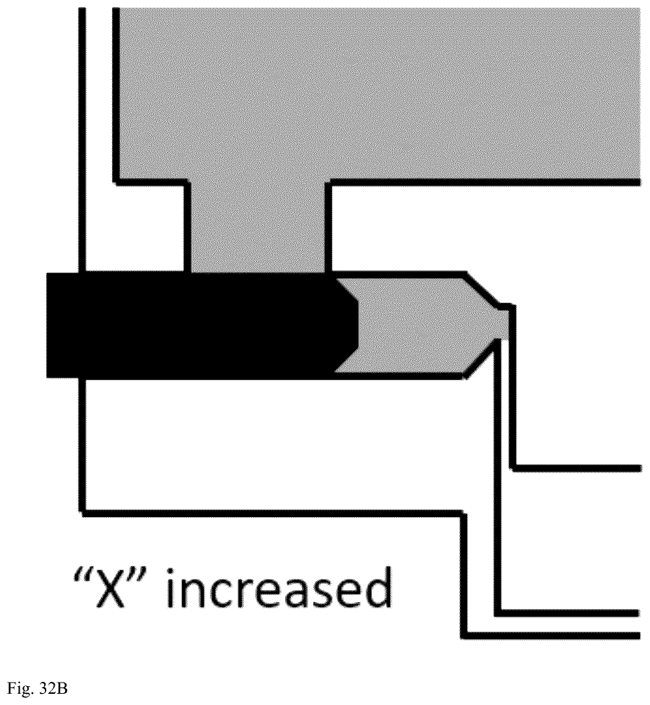

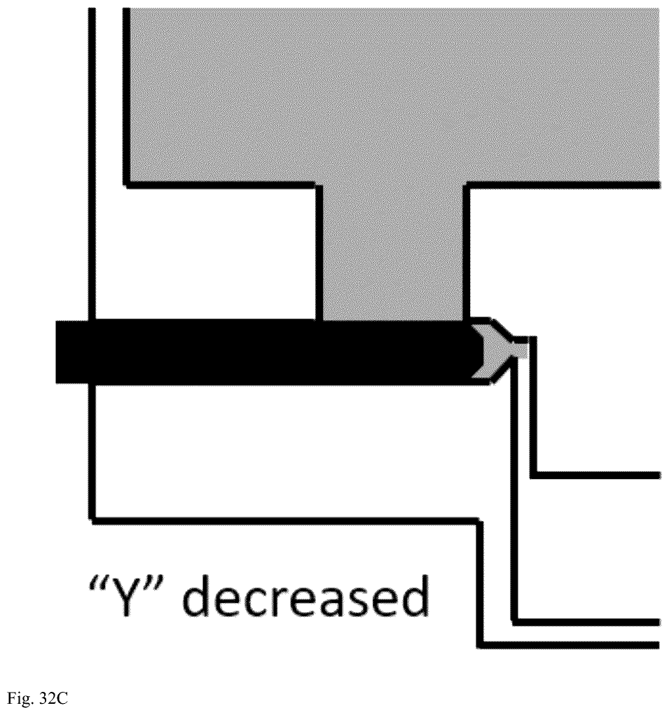

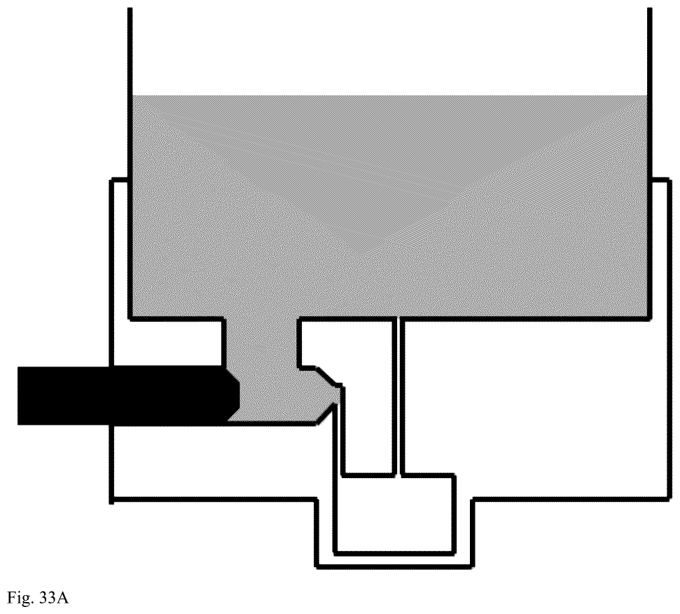

FIG. 29 shows an exemplary side plunger-loaded reaction cap coupled to a collection container. The exemplary side-plunger loaded CCU may have a diameter in the range of 14-21 mm and a total height of 15-20 mm. The transfer chamber may be 3 mm in diameter and the length of the transfer chamber that contains fluid that will be injected into the internal chamber (depicted as “X” in FIG. 32) may be 5 mm. FIGS. 30A-D illustrate the motion of a plunger to displace sample fluid from a container to an internal chamber. As the plunger moves from its position in FIG. 30A to its position in FIG. 30B, sample fluid travels back to the container. Once the plunger reaches the position shown in FIG. 30C, the trapped sample fluid traves (“is pushed”) into the internal chamber as shown in FIG. 30D. FIG. 31A illustrates an embodiment in which a fluidic pathway between a transfer chamber and an inner chamber is sufficiently narrow that fluid will not travel through the fluidic pathway until induced to do so using a plunger. FIG. 31B illustrates an embodiment in which a feature may be included in a fluidic pathway (e.g., an upward loop, hydrophobic coating) to impede the travel of fluid through the fluidic pathway until induced to do so using a plunger.

In some embodiments, the transfer chamber may be connected to the internal chamber by a fluidic pathway that may not allow fluid to travel easily from the transfer chamber to the internal chamber. This may be achieved using a narrow diameter, a surface coating such as a hydrophobic coating, one or more bends in the pathway, an obstruction that can be cleared by the user, or some other means. Fluid may only travel to the internal chamber when forced into it by actuation of the side plunger. There may be a portion of the transfer chamber of a defined volume in which fluid may be trapped when the plunger is inserted sufficiently far into the transfer chamber to block the channel that connects the transfer chamber to the volume of the collection container. This fluid may be forced through the fluidic pathway into the internal chamber as the side plunger continues to be pressed inward. Certain dimensions of the transfer chamber may be adjusted to adjust the volume of fluid that may be injected into the internal chamber when the side plunger is inserted. Two example dimensions that may be adjusted are illustrated in FIG. 32A (including zoomed inset) and labeled as “X” (length) and “Y” (diameter). FIG. 32B shows an embodiment in which the dimension marked “X” is increased relative to the embodiment of FIG. 32A. FIG. 32C shows an embodiment in which the dimension marked “Y” is decreased relative to the embodiment of FIG. 32A.

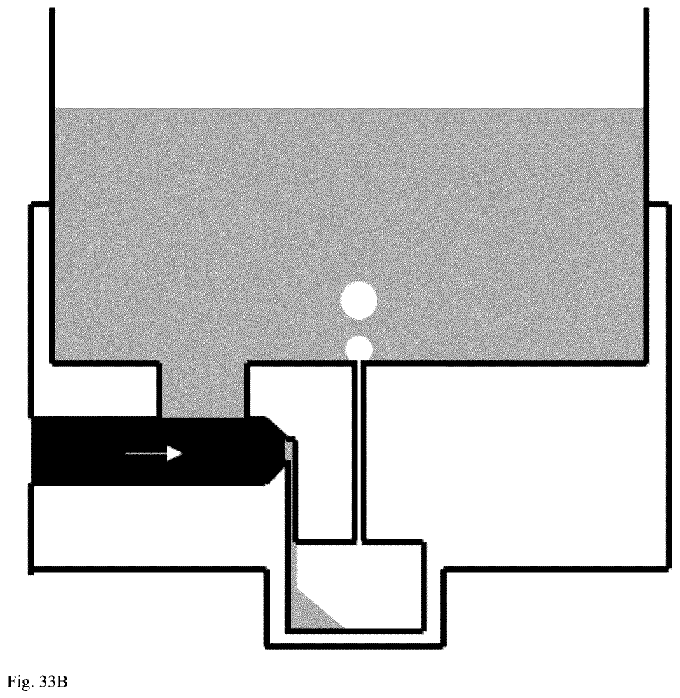

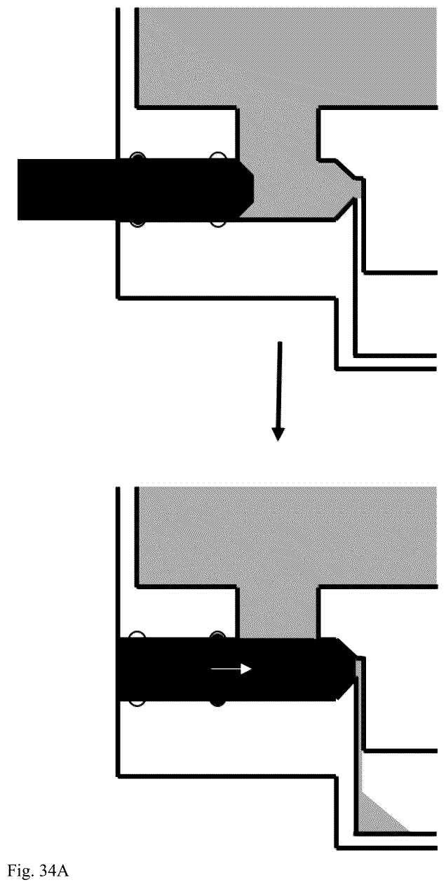

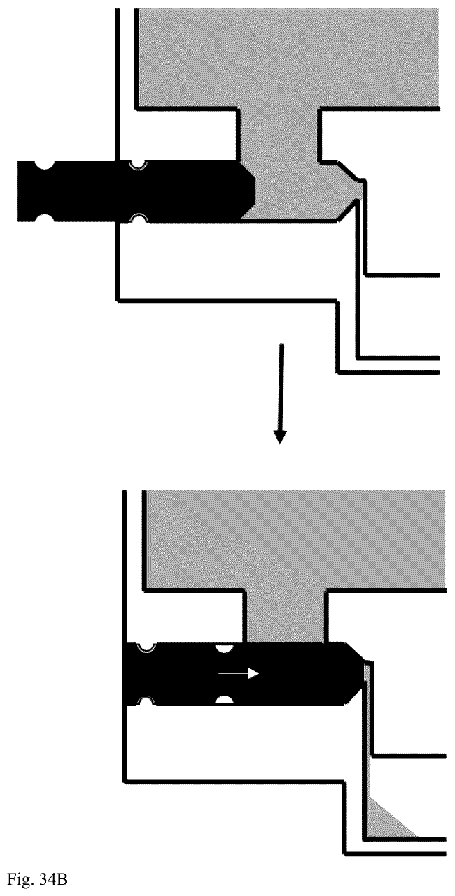

In some embodiments, there may be a venting channel as illustrated in FIGS. 33A, B that may allow air (displaced by the sample fluid introduced into the internal chamber by the plunger) to escape the internal chamber and travel into the volume of the collection container, into a separate chamber, or out of the reaction container. This venting channel may be designed so that fluid cannot travel through it freely. This may be achieved using a narrow diameter, the placement of the channel terminal in the internal chamber, a surface coating such as a hydrophobic coating, one or more bends in the pathway, an obstruction that can be cleared by the user, or some other means.

In some embodiments, the plunger and the channel that houses the plunger may contain ridges and grooves that may be used to guide or lock the movement or position of the plunger in the channel. They may be used to prevent the plunger from being pulled out of the channel entirely or to keep the plunger locked in place once fully inserted, as examples. The ridges and grooves may be on the plunger and channel, respectively, or vice versa, compare, for example, FIGS. 34A, B. Ridges and grooves in the plunger and the channel through which the plunger moves may be used to guide or lock the movement or position of the plunger in the channel. They may be used to prevent the plunger from being pulled out of the channel entirely or to keep the plunger locked in place once fully inserted, as examples. The ridges and grooves may be on the plunger and channel, respectively (top) or vice versa (bottom).

In some embodiments, there may be two or more transfer chambers, plungers, fluidic pathways, and internal chambers. Two or more transfer chambers, plungers, and fluidic pathways may connect to a single internal chamber. Two or more transfer chambers and plungers may be of the same dimension in order to each deliver the same fluid volume to the internal chamber or they may be of different dimensions in order to each deliver a different fluid volume to the internal chamber.

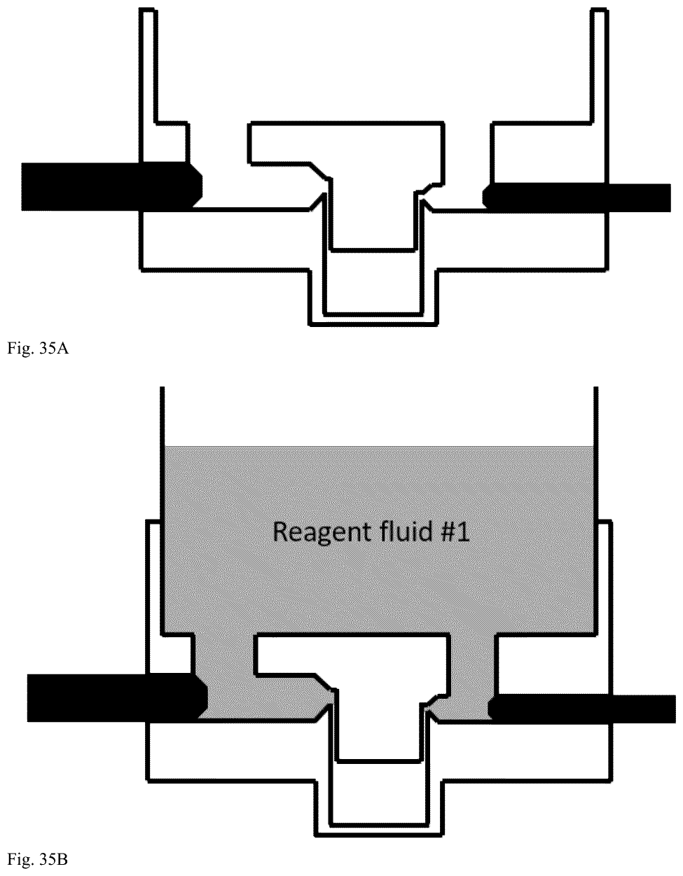

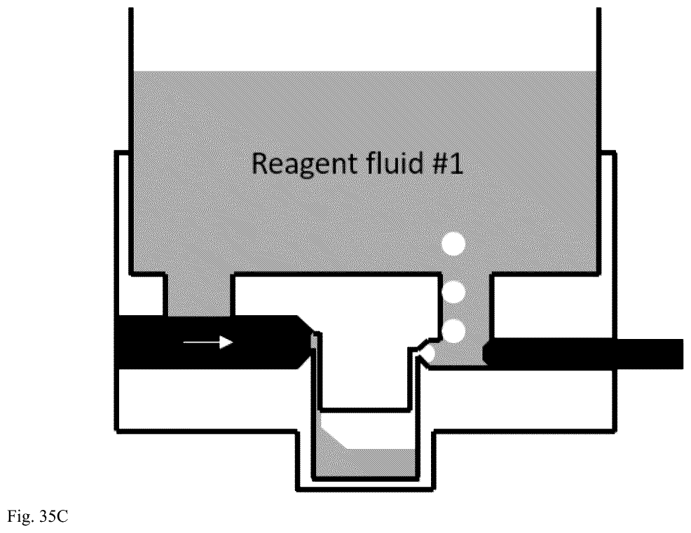

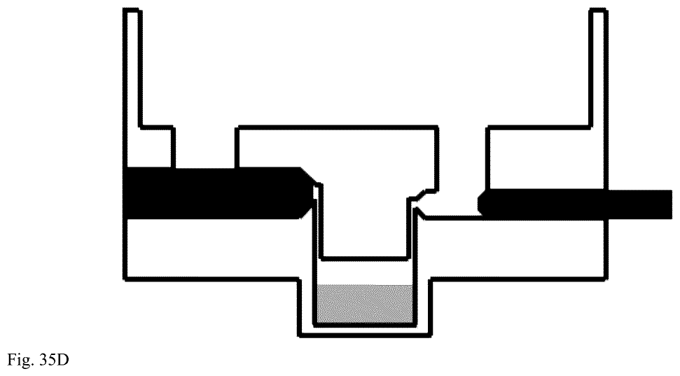

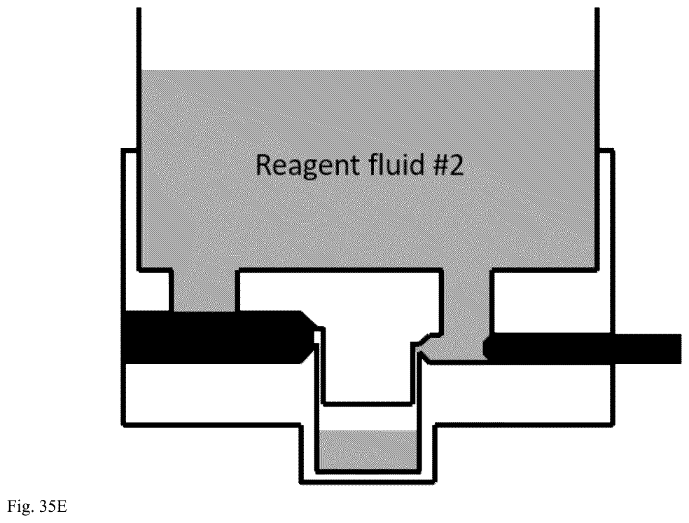

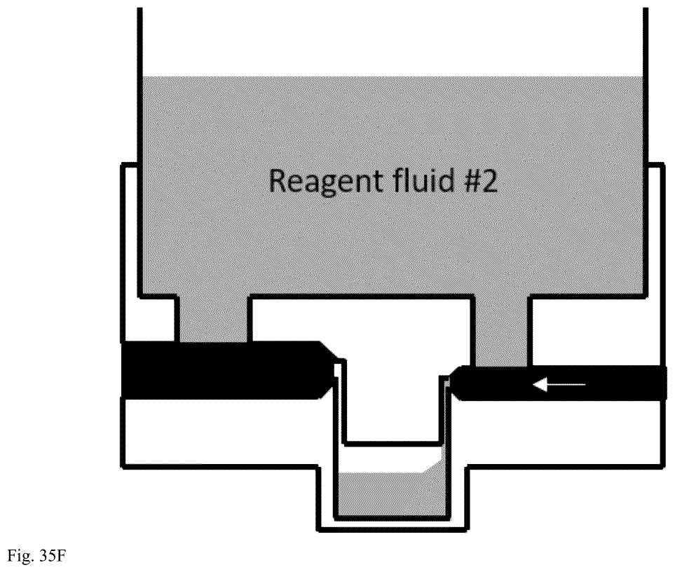

FIGS. 35A-F illustrate an exemplary multi-reagent addition workflow using a two side plunger/transfer chamber/fluidic pathway CCU. Both plungers begin in the open position (FIG. 35A), the CCU is attached to a sample container that contains a first reagent fluid (FIG. 35B). A first plunger is pressed to inject a first volume of a first reagent fluid into the internal chamber (FIG. 35C). If only a single reagent workflow is used, the second plunger may be pressed to seal off the internal chamber after the configuration shown in FIG. 35C. Continuing with the multi-reagent process, the CCU is then removed from the first sample container and optionally rinsed (FIG. 35D). The CCU is then attached to a second sample container that contains a second reagent fluid (FIG. 35E). A second plunger is pressed to inject a second volume of a second reagent fluid into the internal chamber (FIG. 35F).

In some embodiments, plungers may be designed so that they cannot be retracted after they have been pressed into the CCU. Plungers may be designed so that they can be retracted and pressed in at will. In multi-step workflows involving the injection of multiple different fluids into the internal chamber, a plunger may be pressed and inserted in order to seal that transfer chamber from being used for the current fluid.

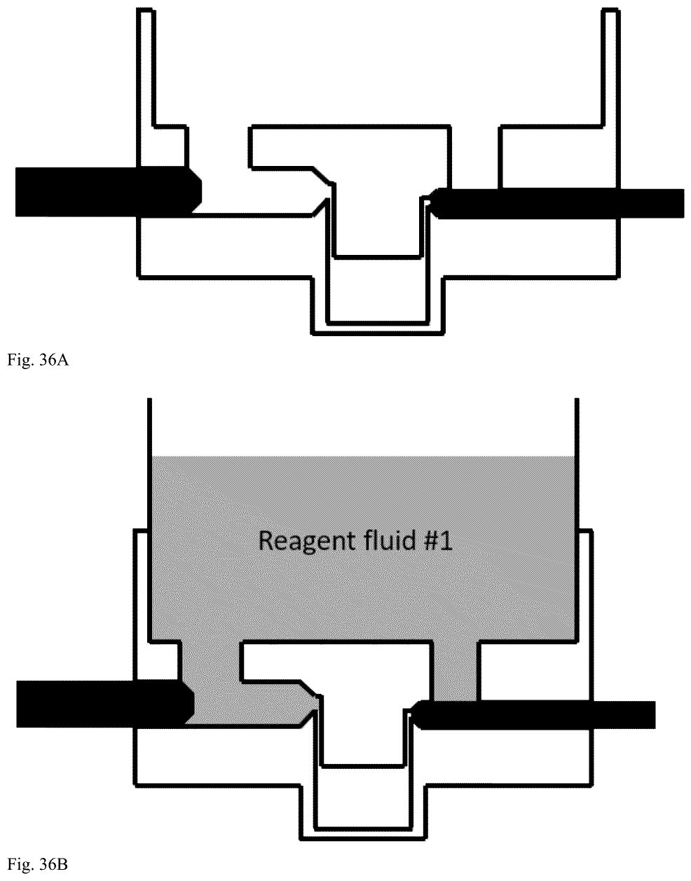

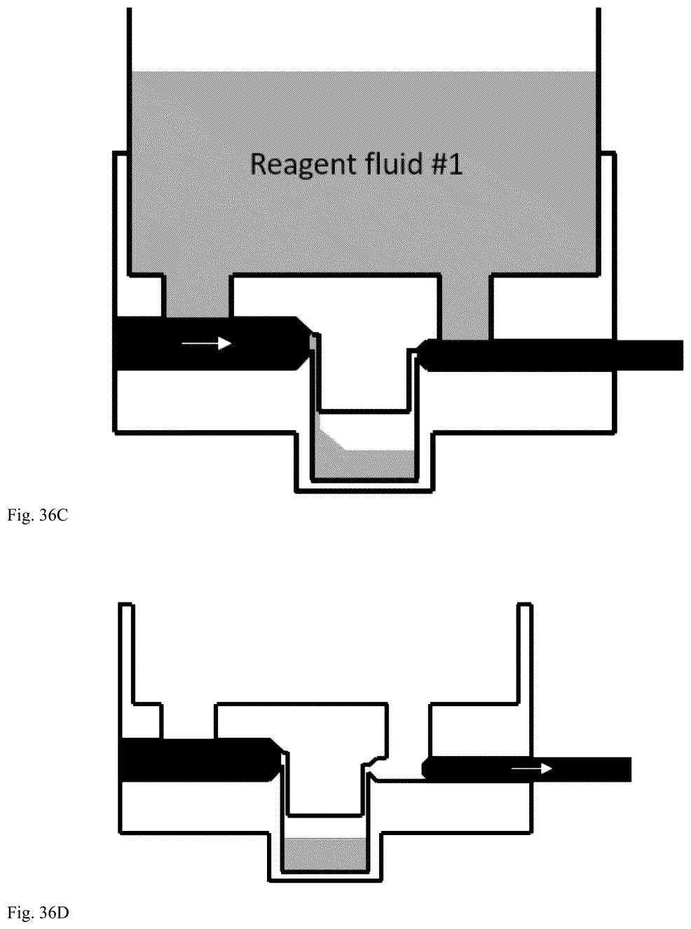

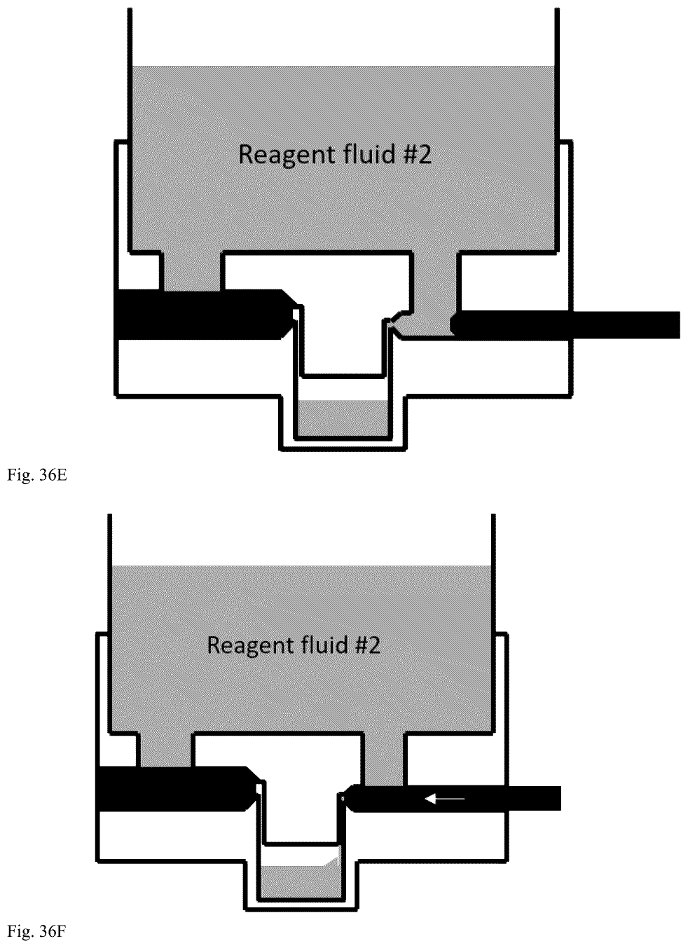

FIGS. 36A-F illustrate another exemplary multi-reagent addition workflow using a two side plunger/transfer chamber/fluidic pathway CCU and sealing of fluidic pathways to prevent unwanted injection of sample fluid into the internal chamber. A first plunger begins in an open position and a second plunger begins in a sealed position (FIG. 36A), the CCU is attached to a sample container that contains a first reagent fluid (FIG. 36B). The first plunger is pressed to inject a first volume of a first reagent fluid into the internal chamber (FIG. 36C). The CCU is then removed from the first sample container, optionally rinsed, and the second plunger is retracted into an open position (FIG. 36D). The CCU is then attached to a second sample container that contains a second reagent fluid (FIG. 36E). The second plunger is pressed to inject a second volume of a second reagent fluid into the internal chamber (FIG. 36F).

In some embodiments, multiple transfer chambers, plungers, and fluidic pathways may be used to deliver multiple different fluid types into the internal chamber(s) including but not limited to water, buffer, saline, lysis solution, inactivation solution, reaction solution, primer solution, sample fluid, or other reagents. These multiple additions may be made by attaching the CCU to a first collection container or other reagent container, inverting the assembly, inducing the fluid to travel into the transfer chamber and injecting the fluid in that container by pressing and inserting one or more of the plungers. The CCU may then be removed from that container, optionally washed or rinsed with water, buffer, or other reagent, and then attached to a second collection container or other reagent container. After inverting the CCU plus container assembly and inducing the fluid to travel into the transfer chamber, the fluid in the second container can then be injected by pressing and inserting one or more of the remaining plungers. Multiple additions may continue to be added as desired. Optionally, in the case where a plunger is designed to be retracted and re-inserted, a single plunger, transfer chamber, and fluidic pathway may be used to add multiple different reagents to the same internal chamber. The internal chamber may be designed so that fluid is not extracted from the internal chamber if a plunger is retracted.

### Exemplary Rotationally Loaded CCU

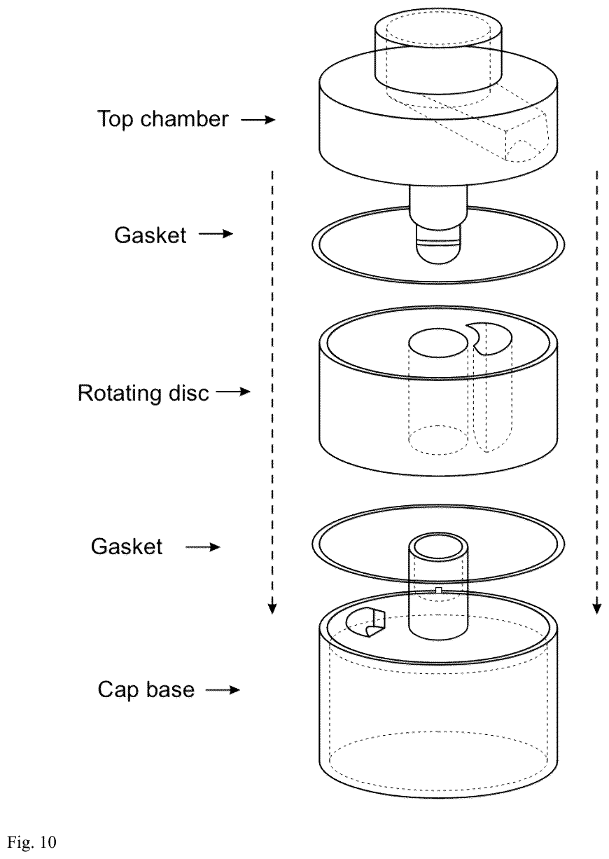

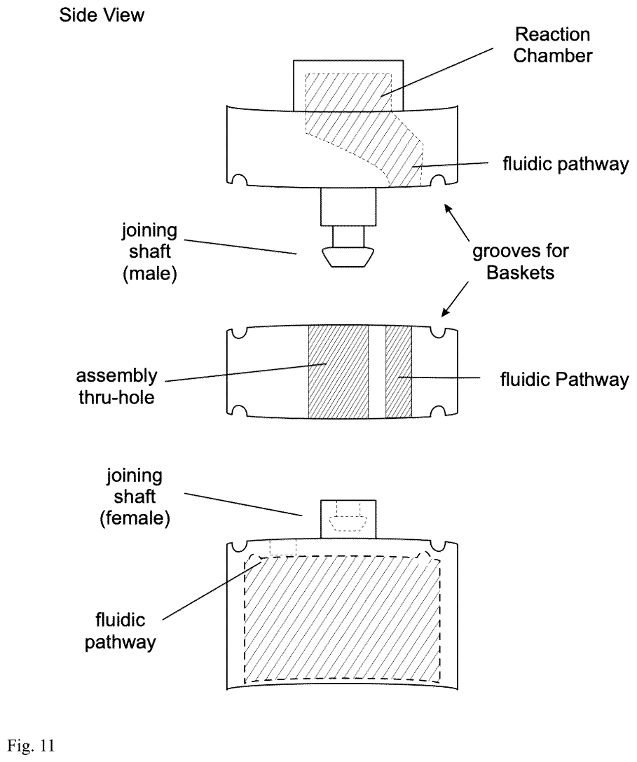

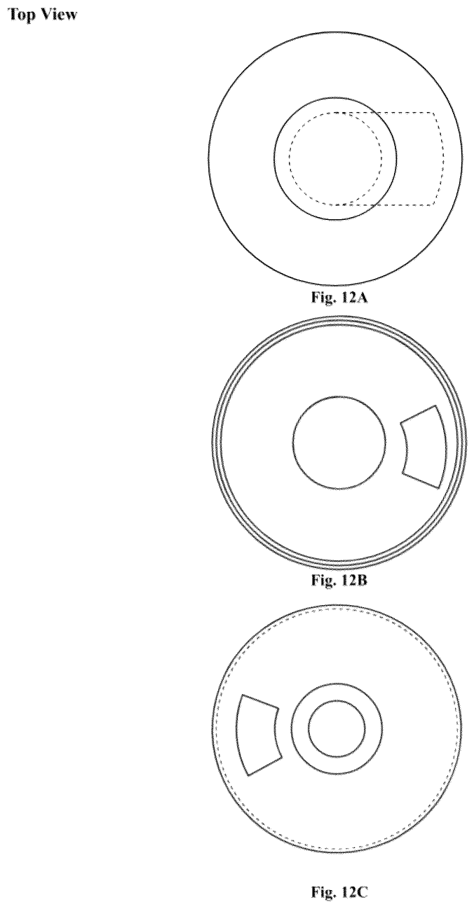

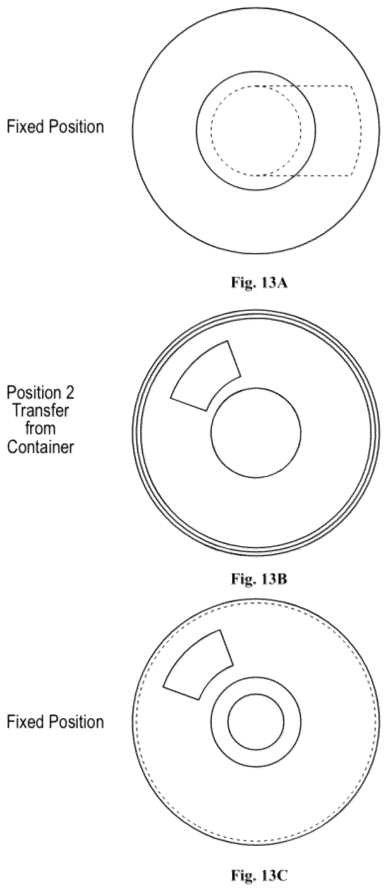

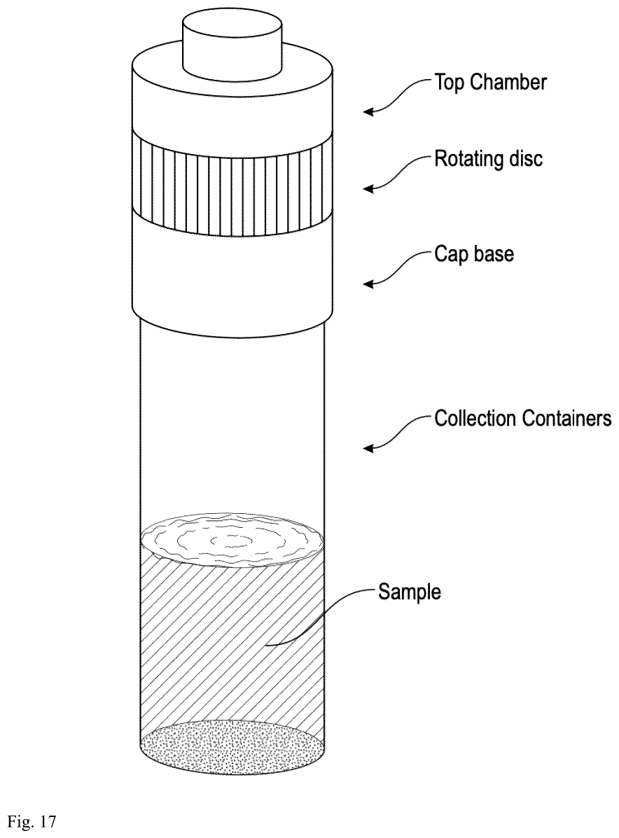

An exemplary rotationally loaded CCU may comprise three primary components as illustrated in FIGS. 10, 11, 12A-C labeled as the Top chamber, the Rotating disc, and the Cap base. FIG. 11 shows a cross section view, and FIGS. 12A-C show a top-down view of Top chamber (FIG. 12A), Rotating disc (FIG. 12B), and Cap base (FIG. 12C). An assembled rotationally loaded CCU coupled to a sample container is shown in FIG. 17. The Top chamber may house the internal chamber and amplification reagents (when loaded) as well as a portion of the fluidic pathway that connects to the internal chamber. The Rotating disc may contain another portion of the fluidic pathway that may be referred to as a transfer chamber. This transfer chamber may transfer a fixed volume of sample from the collection container to the internal chamber. The Cap base may contain another portion of the fluidic pathway that connects to the volume inside the collection container. The Cap base may attach to the collection container by means of a screwcap, snap-cap, press-fit, or other attachment mechanism. Some approximate dimensions of an exemplary CCU are a total diameter of 14-21 mm, a total height from the bottom of the Cap base to the top of the Top chamber of 15-20 mm, a height for the Rotating disc part of 3-6 mm, and a fluidic pathway diameter of 2-4 mm if circular in cross-section.

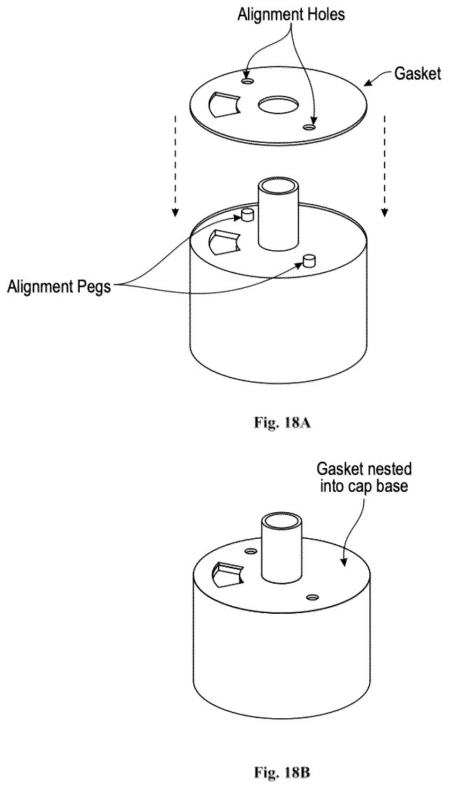

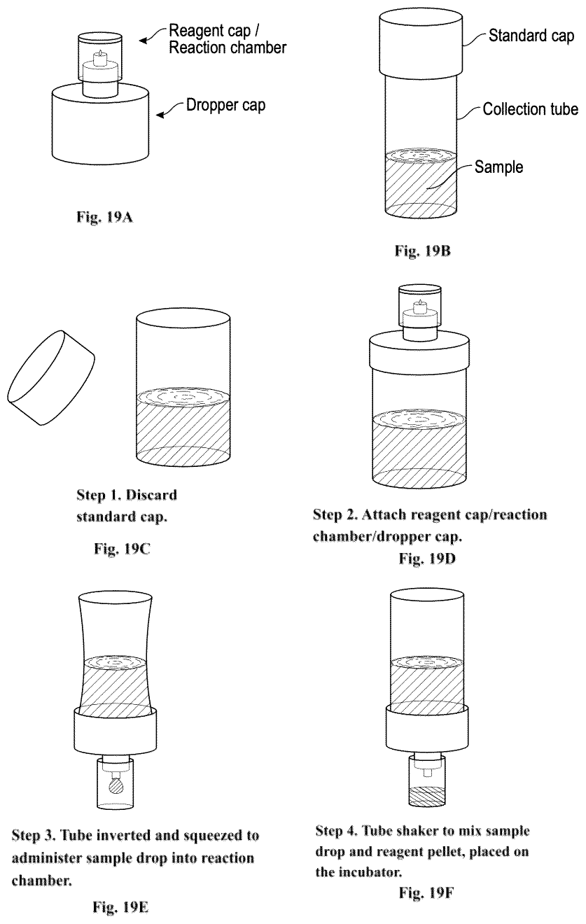

In an exemplary assembly of the Rotationally loaded reaction cap, the Top chamber may stack on the Rotating disc and the Rotating disc may stack on the Cap base. The Top chamber and the Cap base may be attached and fixed in position relative to one another by a shaft that runs through a center through-hole in the Rotating disc, and the Rotating disc may rotate around the axis of the shaft. The shaft may be rigid and fixed and may not allow the Top chamber or the Cap base to move or rotate relative to one another. At the interface between the Top chamber and Rotating disc or at the interface between the Rotating disc and the Cap base, there may be an o-ring gasket to prevent sample fluid from leaking from the CCU at the respective interface. The gasket may be an o-ring gasket near the edge (around the circumference) of the CCU. There may be a recess in the Top chamber, Rotating disc, and/or Cap base on the face that is at the interface with the other parts in order for the o-ring gasket to partly nest inside. In some embodiments, the gasket at either of the two interfaces between the three components may be a mat-type gasket with through-holes cut to allow for sample fluid to pass through the fluidic pathway segments when aligned—shown in FIG. 18A-B. In some embodiments, there may be optional gaskets (FIG. 18A) that encircle the fluidic pathway at the two interfaces where the three components interface one another in order to prevent leaking via the fluidic pathway. In some embodiments, there may be alignment pegs in the Top chamber, Rotating disc, and/or Cap base and corresponding holes in a gasket mat in which the alignment pegs may insert when the gasket is nested inside the part face (FIG. 18B). These alignment pegs and holes may facilitate proper assembly and prevent the gasket from rotating with respect to one or more of the three components. In some embodiments, the gasket may be thicker than the groove or recess is deep, or the alignment peg(s) are tall so as to provide a tight seal at the interface. In some embodiments, there may be an asymmetry in the joining shaft that may facilitate proper assembly and prevent the gasket from rotating with respect to one or more of the three components. In some embodiments, a portion of the joining shaft may include a gasket to prevent fluid transfer from the Rotating disc/Cap base interface to the Top chamber/Rotating disc interface.

In some embodiments, the top surface of the Top chamber may feature a protruding notch that houses some or all of the one or more internal chambers. In some embodiments, an internal chamber may contain reagents needed for amplification. In some embodiments, reagents in the internal chamber may be in lyophilized, dried, frozen, or other stabilized form. In some embodiments, the Top chamber may feature at its base part or all of the shaft that joins it to the Cap base or a fixture where the shaft that is part of the Cap base can attach. In some embodiments, a fluidic pathway inside the Top chamber may connect the internal chamber to an area on the base surface of the Top chamber that may be between the shaft or shaft fixture and the gasket. In this way, the fluidic pathway may be off-center where it meets the base surface of the Top chamber. In some embodiments, the inner walls of the fluidic pathway and internal chamber may be coated with a hydrophilic coating to promote wetting by fluid and therefore promote the transfer of sample fluid into the internal chamber through the fluidic pathway. In some embodiments, there may be a concave groove that surrounds the perimeter of the base surface of the Top chamber. This may allow a gasket to partially nest and form a seal with the top surface of the Rotating disc without creating a space between the base surface of the Top chamber and the top surface of the Rotating disc. In some embodiments, the face of the Top chamber that interfaces with the Rotating disc may be recessed to allow for a gasket mat to nest into this face and form a tight seal with the Rotating disc when assembled. In some embodiments, the face of the Top chamber may feature one or more alignment pegs that may align with alignment holes in a gasket mat in order to facilitate assembly and prevent the gasket mat from rotating with respect to the Top chamber. In some embodiments, the Top chamber may be composed partially or entirely of optically clear plastic.

In some embodiments, the Rotating disc may feature a through-hole that allows the shaft that joins the Top chamber to the Cap base to pass through. In some embodiments, the Rotating disc may feature an off-center through-hole that is of an inner volume equivalent to the volume of sample that is desired to be delivered into the internal chamber. This may form another part of the fluidic pathway between the collection container and the internal chamber. In some embodiments, this portion of the fluidic pathway may be coated with a hydrophilic coating to promote wetting by fluid and therefore promote the transfer of sample fluid from the collection tube through the Cap base and into this portion of the fluidic pathway. In some embodiments, there may be a concave groove that surrounds the perimeter of the top and/or base surface(s) of the Rotating disc. This may allow a gasket to partially nest and form a seal with the bottom surface of the Top chamber and/or the top surface of the Cap base without creating a space between the top and/or base surfaces of the Rotating disc and the adjacent surface(s) of the Top chamber and/or Cap base. In some embodiments, one or both faces of the Rotating disc may be recessed to allow for a gasket mat to nest into the Rotating disc face and form a tight seal with the Top chamber or Cap base when assembled. In some embodiments, one or both faces of the Rotating disc may feature one or more alignment pegs that may align with alignment holes in a gasket mat in order to facilitate assembly and prevent the gasket mat from rotating with respect to the Rotating disc. In some embodiments, the Rotating disc may be designed to rotate with respect to the Top Chamber and Cap base, rotating around the joining shaft. At one position of rotation, the portion of the fluidic pathway in the Rotating disc may align with the portion of the fluidic pathway in the Top chamber. At another position of rotation, the portion of the fluidic pathway in the Rotating disc may align with the portion of the fluidic pathway in the Cap base. The assembled cap may be designed so that at no rotational position might the portion of the fluidic pathway in the Rotating disc be aligned with the portion of the fluidic pathway in the Top chamber and the portion of the fluidic pathway in the Cap base simultaneously. In some embodiments (not illustrated), the Top Chamber, Rotating disc, and Cap base may be designed such that a fluidic pathway aligns between the Cap base and the Top Chamber simultaneously. Once a portion of the sample is in the internal chamber of the Top Chamber, the Rotating disc may be rotated to close off the fluidic pathway from being aligned between the Cap base and the Top Chamber—thereby isolating the portion of the sample in the internal chamber of the reaction cap.

In some embodiments, the Cap base may feature on its top surface part or all of the shaft that joins it to the Top chamber, or a fixture where the shaft that is part of the Top chamber can attach. In some embodiments, the Cap base may feature an off-center through-hole that may form another part of the fluidic pathway between the collection container and the internal chamber. In some embodiments, this portion of the fluidic pathway may be coated with a hydrophilic coating to promote wetting by fluid and therefore promote the transfer of sample fluid from the collection tube through the Cap base and into the Rotating disc portion of the fluidic pathway. In some embodiments, there may be a concave groove that surrounds the perimeter of the top surface of the Cap base. This may allow a gasket to partially nest and form a seal with the base surface of the Rotating disc without creating a space between the top surface of the Cap base and the base surface of the Rotating disc. In some embodiments, the face of the Cap base that interfaces with the Rotating disc may be recessed to allow for a gasket mat to nest into this face and form a tight seal with the Rotating disc when assembled, see, for example, FIG. 18B. In some embodiments, the face of the Cap base may feature one or more alignment pegs that may align with alignment holes in a gasket mat in order to facilitate assembly and prevent the gasket mat from rotating with respect to the Cap base. In some embodiments, the base portion of the Cap base may be designed to attach to the collection container. This attachment may be by a snap-cap, a press-fit, a screwcap, or other attachment method. In some embodiments, the Cap base and/or sample container may comprise features such as interlocking teeth or some other mechanism such that after the CCU and sample container have been coupled, they cannot be separated or loosened.

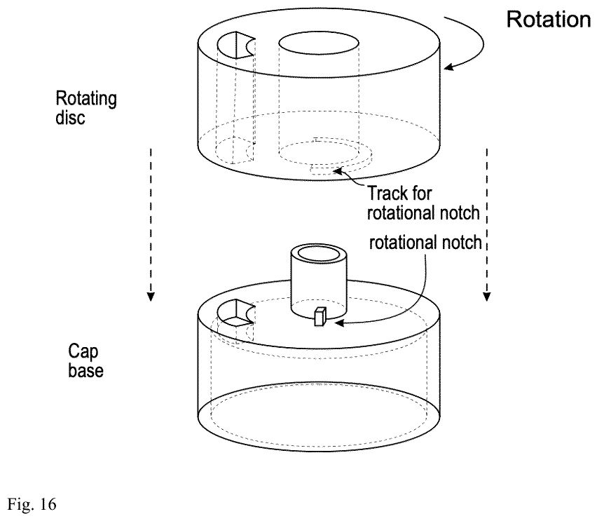

In some embodiments, the assembled CCU may be designed so that the rotational positions of the Rotating disc are constrained to a desired range—see FIG. 16. This may be accomplished by including a rotational notch that may protrude from the joining shaft and a rotational track that is embedded into the through-hole in the Rotating disc. When the CCU is assembled, the Rotating disc may be constrained to rotate only along the positions where the rotational notch moves within the rotational track. The relative positions of the rotational notch, the rotational track, and the portions of the fluidic pathway in the Cap base, the Rotating disc, and the Top chamber may be arranged so that at one end of the rotational track the portion of the fluidic pathway in the Rotating disc aligns with the portion of the fluidic pathway in the Cap base, and at the other end of the rotational track the portion of the fluidic pathway in the Rotating disc aligns with the portion of the fluidic pathway in the Top chamber. In some embodiments, there may be a locking mechanism such as a protrusion at one end of the rotational track so that when the Rotating disc is rotated so that the portion of the fluidic pathway in the Rotating disc aligns with the portion of the fluidic pathway in the Top chamber it can no longer be rotated to any other position. In some embodiments, any or all of the Top chamber, the Rotating disc, and the Cap base may feature markings to indicate the intended rotational position of the Rotating disc at different steps during use of the CCU.

### Example Workflow—Rotationally-Loaded CCU

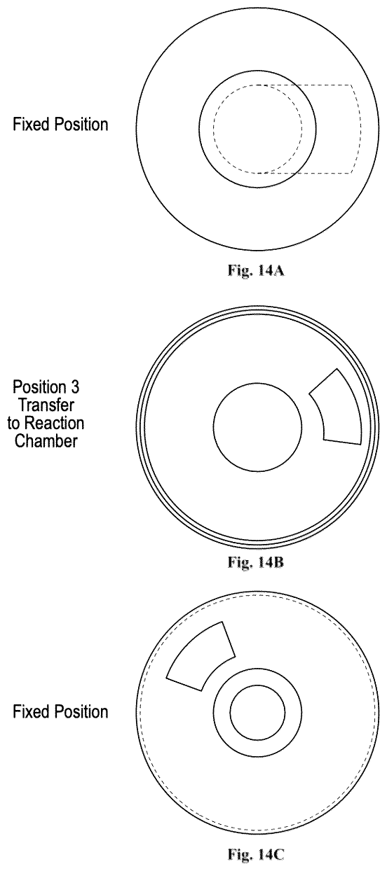

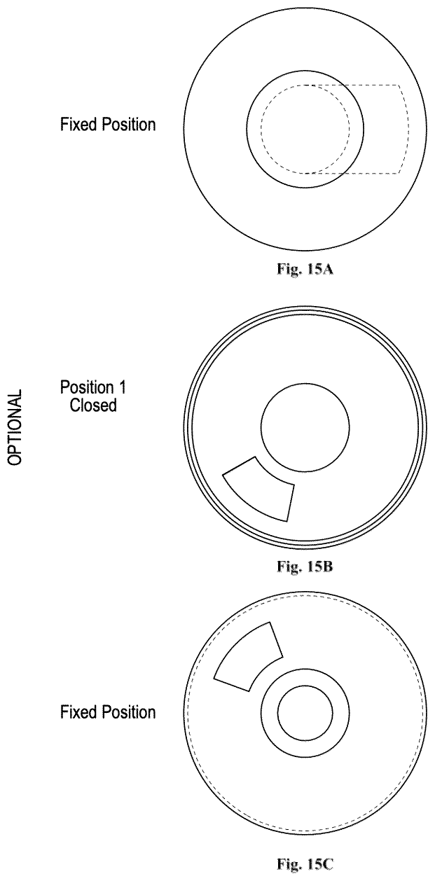

After obtaining a biological specimen such as an anterior nares swab and swirling it in an inactivation solution in the collection tube, the user takes a CCU and screws it onto the collection tube. Once coupled to the sample container, interlocking teeth lock the CCU in place and prevent it from being de-coupled from the sample container. The Rotating disc begins in a position that is furthest clockwise on the rotating track (when looking down at it from above), and this is illustrated by indicating marks. For example, the Rotating disc (FIG. 13B) may have a vertical double-arrow pointing above and below at the number “1” that is displayed at this first position on the Top chamber (FIG. 13A) and the Cap base (FIG. 13C). In this position, the fluidic pathway in the Rotating disc aligns with the fluidic pathway in the Cap base—see FIG. 13A-C. The user inverts the tube and may tap it on a hard surface or use a flicking motion to induce the sample fluid to fill the portion of the fluidic pathway inside the Rotating disc. With the tube remaining inverted, the user then turns the Rotating disc to the opposite end of the rotational track where the double-arrow on the Rotating disc (FIG. 14B) will align with the number “2” that is displayed at that second position on the Top chamber (FIG. 14A) and the Cap base (FIG. 14C). In this position, the fluidic pathway in the Rotating disc—which is now filled with sample fluid—aligns with the fluidic pathway in the Top chamber—see FIG. 14A-C. The user again may either tap the tube (CCU side down) on hard surface or use a flicking motion to induce the sample fluid to travel down the fluidic pathway and into the internal chamber. The user then agitates the CCU by shaking or flicking to elute the lyophilized reagents in the internal chamber into the sample fluid. The user then places the tube CCU down into a slot in the heater/reader for incubation of the amplification reaction and measurement of the result. FIGS. 15A-C illustrate an optional configuration of the Rotating disc (FIG. 15B; compare with FIGS. 13B, 14B) such that the fluidic pathway is not aligned with the Cap base or the Top chamber (see FIGS. 15A, 15C).

### Exemplary Dropper—Type CCU

In some embodiments, an exemplary Dropper reaction cap may consist of three primary components including a Squeezable collection container that may be made from a flexible plastic, a Dropper cap that may fit on the collection container and that may feature a nozzle that may be used to administer a volume of sample fluid by squeezing the attached collection container, and a Reagent cap/internal chamber that may fit onto the nozzle of the Dropper cap and that may contain reagents needed for an amplification reaction.

In some embodiments, the Squeezable collection container may be composed of flexible plastic. In some embodiments, the Squeezable collection container may be cylindrical in shape. In some embodiments, the Squeezable collection container may feature an elongated cross-section such that it has the shape of a partially flattened cylinder. In some embodiments, the Squeezable collection container may feature a portion of the collection container that is more flexible and easily squeezed than other portions of the collection container. In some embodiments, the Squeezable collection container may be sufficiently long and wide to fit one or more swabs inside the collection container.

In some embodiments, the Dropper cap may be composed of plastic. In some embodiments, the Dropper cap may attach to the Squeezable collection container by screwcap, snap-cap, press-fit, or other attachment mechanism. In some embodiments, the Dropper cap may feature a nozzle with a through-hole that forms a fluidic pathway between the Squeezable collection container and the Reagent cap/internal chamber. In some embodiments, the Dropper cap may feature a side plunger that may be used to seal the fluidic pathway after the desired volume of sample fluid has been transferred to the Reagent cap/internal chamber.

In some embodiments, the Reagent cap/internal chamber may be composed of optically clear plastic. In some embodiments, the Reagent cap/internal chamber may be cylindrical in shape. In some embodiments, the Reagent cap/internal chamber may have squared edges. In some embodiments, the Reagent cap/internal chamber may be filled with reagents needed for an amplification reaction. In some embodiments, these reagents may be lyophilized, dried, frozen, or stabilized using a process. In some embodiments, the Reagent cap/internal chamber may be attached to the nozzle cap by screwcap, snap-cap, press-fit, or glued or bonded during manufacture. In some embodiments, the Reagent cap/internal chamber may feature a score mark or other marking to indicate the desired fill volume to provide guidance to the user on what volume of sample to add to the internal chamber via the Dropper cap.

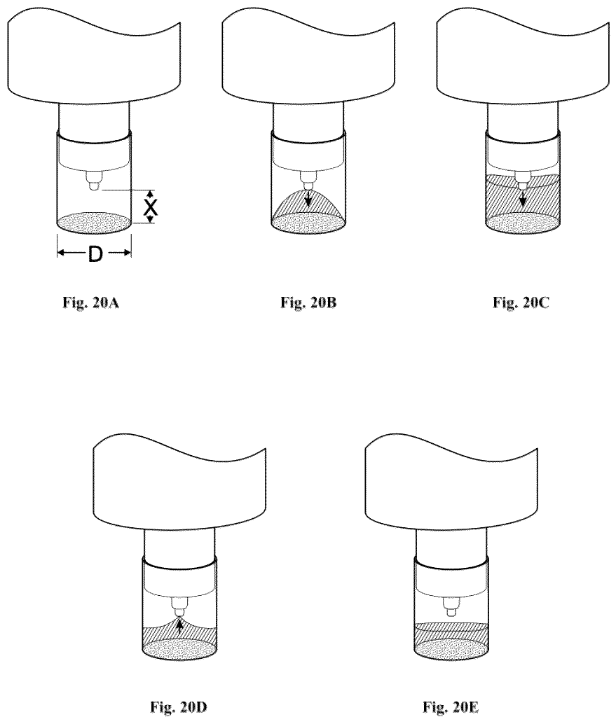

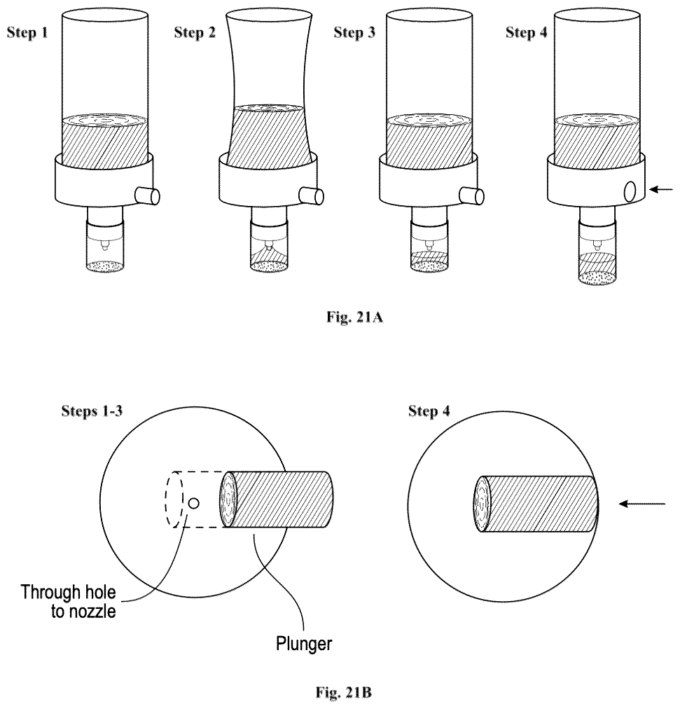

In some embodiments, the measurements for the Reagent cap/internal chamber, the Dropper cap and their relative positioning may be chosen in order to facilitate filling the internal chamber with the intended volume of sample fluid. In some embodiments, the nozzle of the Dropper cap may be designed with a specific geometry and specific dimensions to control the size of a drop that is released from the nozzle. In some embodiments, the inner diameter of the nozzle through-hole, the outer diameter of the nozzle tip, the shape of the tip (e.g., pointed vs blunt, high aspect ratio), and any surface coatings such as hydrophobic or hydrophilic coatings inside or outside of the nozzle may be selected based on the size of the desired droplet to be released. In some embodiments, certain additives such as surfactants may be used in the sample fluid in order to affect the droplet size that is released from the nozzle. In some embodiments, the droplet size may be adjusted so that the user could be instructed to deliver a single droplet or a specified number of droplets into the internal chamber. In some embodiments, the distance between the tip of the nozzle of the Dropper cap and the end of the Reagent cap/internal chamber (labeled as “X” below, see FIG. 20A) may be chosen so that a certain sample volume can be consistently delivered into the internal chamber. In some embodiments, the nozzle may be positioned so that after delivering a drop or drops of sample fluid into the internal chamber (FIG. 20B, C) and upon releasing pressure on the Squeezable collection container, excess volume of sample fluid may be withdrawn from the internal chamber and a specific volume may remain in the internal chamber (FIG. 21A, 20D-E). The Dropper cap may incorporate a side-plunger mechanism to seal the dropper after the desired volume of fluid has been delivered into the internal chamber—see FIG. 21A-B.

In some embodiments, the Dropper cap may incorporate a side-plunger mechanism to seal the dropper after the desired volume of fluid has been delivered into the internal chamber—see FIG. 21A-B. In some embodiments, there may be a hole that extends from the side of the Dropper cap and intersects with the through-hole that connects the Squeezable collection tube inner reservoir to the internal chamber. In some embodiments, this hole may have a plunger inserted part-way into it with the remaining portion of the plunger protruding from the side of the Dropper cap. In some embodiments, the plunger may be composed of rubber, silicone, or some similar material that can form a seal in the hole that is both water-tight and air-tight so that the function of the Dropper cap may not be hindered. In some embodiments, the inner end of the plunger may be wider than the rest of the plunger and there may be a constriction at the mouth of the plunger hole so that the plunger cannot be easily removed. This may prevent sample from leaking through the side hole of the Dropper cap. In some embodiments, other mechanisms may be used to prevent the plunger from being readily removed from the side hole in the Dropper cap. In some embodiments, after transferring the desired volume of sample fluid from the Squeezable collection tube into the internal chamber (Steps 1-3 in FIG. 21B), the plunger may be pressed into the side of the Dropper cap (Step 4 in FIG. 21B). This may seal the through-hole to the nozzle and prevent further transfer of fluid between the Squeezable collection container and the internal chamber in either direction.

### Example Workflow—Dropper-Type CCU

After obtaining a biological specimen such as an anterior nares swab and swirling it in an inactivation solution in the Squeezable collection tube, the user takes an assembled Dropper cap/Reagent cap/internal chamber and screws it onto the collection tube. The user then inverts the tube and gently squeezes the tube to administer one or more drops of sample fluid into the internal chamber as specified. Optionally, the user then presses the side plunger into the side of the Dropper cap to seal it and prevent further sample fluid transfer. The user then agitates the cap by shaking or flicking to elute the lyophilized reagents in the internal chamber into the sample fluid and to ensure that it is well-mixed. The user then places the tube cap-side down into a slot in the heater/reader for incubation of the amplification reaction and measurement of the result.

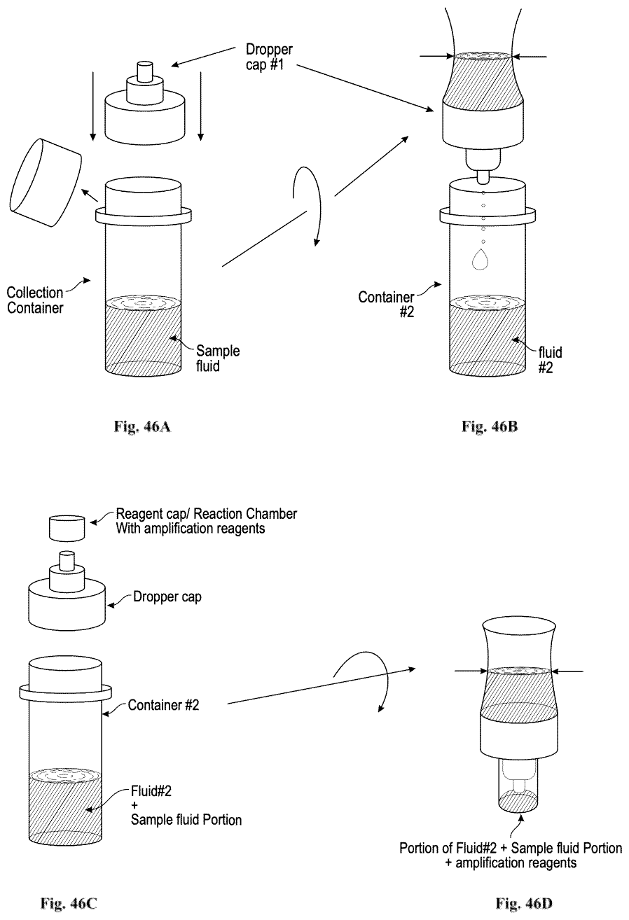

In some embodiments, as shown in FIG. 46A-D, the workflow may consist of first discarding a standard sample container cap and replacing it with a first dropper cap (FIG. 46A), then inverting the collection tube/first dropper cap assembly and administering one or more drops of sample fluid into a second sample container that may be pre-filled with a second fluid (FIG. 46B). There may optionally be a heat inactivation step either prior to step A (FIG. 46A) or after step B (FIG. 46B) during which there may be a standard cap attached to the sample container. Following step B (FIG. 46B) and optionally following a heat inactivation step, a second dropper cap may be attached to the second sample container (FIGS. 46C, D). This second dropper cap may be as described in the “Exemplary dropper reaction cap” section (see FIG. 19A-F), consisting of a dropper cap and a reagent cap/reaction chamber (FIG. 19A). In some embodiments, the reagent cap/reaction chamber may be pre-filled with amplification reagents that are dried, lyophilized, frozen, or stabilized by another process (FIG. 19B). In some embodiments, the reagent cap/reaction chamber may be a separate part that is loaded with amplification reagents by the end user and then attached to the dropper cap before use (FIG. 19C, D). After attaching the second dropper cap to the second sample container, the user may invert and squeeze the tube to transfer one or more drops of the fluid from the second sample container to the reagent cap/reaction chamber (FIG. 19E and FIG. 46D). The user may then shake, flick, or otherwise agitate the reagent cap/reaction chamber in order to mix the added fluid with the amplification reagents in the reagent cap/reaction chamber (FIG. 19F). The user may then place the reaction container onto a heater/reader for incubation of the test and measurement of the test result. In some embodiments, the reaction chamber may be a container that remains separate from the dropper cap throughout the workflow. In such embodiments, the second dropper cap may be used to administer one or more drops of fluid from the second sample container to a separate container that may be mixed and then may be capped, plugged, or otherwise sealed and then may be placed onto a heater/reader for incubation of the test and measurement of the test result.

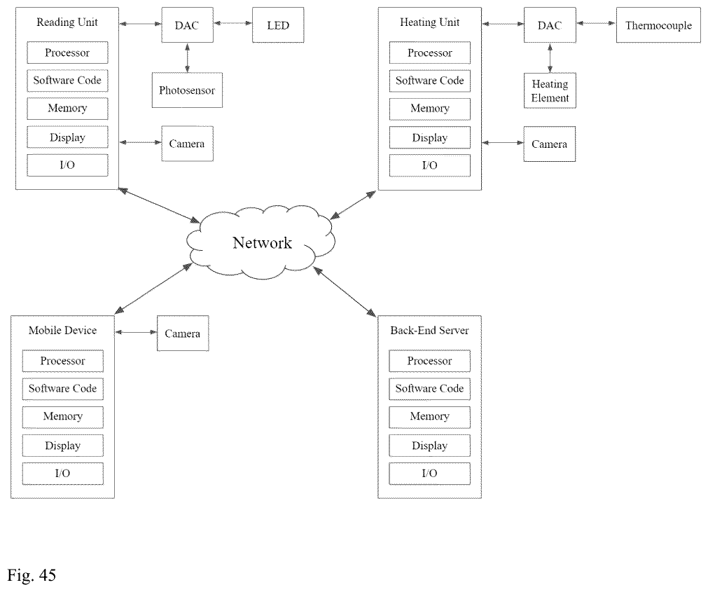

As illustrated in FIG. 45, components of an exemplary system may include one or more of: a reading system, a heating system (may be integrated with a reading system), a mobile device (e.g., associated with a test subject), or a back-end server. Each of these components may comprise at least one processor, software code, at least one memory, optionally a display or indicator (e.g., indicator LEDs), and input/output devices such as a keyboard, keypad, touchscreen, and/or mouse. The reading system may communicate with a light source or a photosensor via a digital-analog converter (DAC). The reading system may communicate with a camera or other scanning device to be able to receive information (e.g., to scan identifying information from a reaction container). The heating system may communicate with a thermocouple or a heating element via a DAC. The heating system may utilize a control algorithm (e.g., a proportional integral derivative (PID) loop) in order to maintain a target temperature for the incubation of an isothermal amplification reaction. The mobile device may contain a camera that may be used to receive information (e.g., to scan identifying information from a reaction container). The mobile device (e.g., app on the mobile device) may be used to register a sample contained in the reaction container with an individual or group of individuals associated with that sample. The mobile device may be used to receive test results when available from the reading system or the back-end server via the network.

The back-end server may be used to relay information between the other devices over a network. The back-end server may track information related to one or more of: individuals providing test samples, individuals performing testing at reader or heater systems, reaction containers, data collected from reaction containers (e.g., data for internal chambers under test in a reader system), test status/progress (e.g., based on information related to individual providing sample for test, reaction container ID, etc. (e.g., test group created, reaction container received); based on information from reader system; based on information from heater system), or test results. The back-end server may provide access to any of the tracked information to: individuals providing test samples, individuals associated with individuals providing test samples (e.g., family members (e.g., parents, guardians), household members, close contacts), individuals managing testing (e.g., operating or processing samples at a reader system or heater system), organizations managing testing of organization members (e.g., including family members or close contacts of an organization member), or local/county/state/federal government entities. In some embodiments, data from one or more devices (e.g., test results) or tracked information (e.g., identification of individual providing sample in identified reaction container) may be logged manually (e.g., on paper) and then transferred to data/information structures stored on one or more devices (e.g., back-end server).

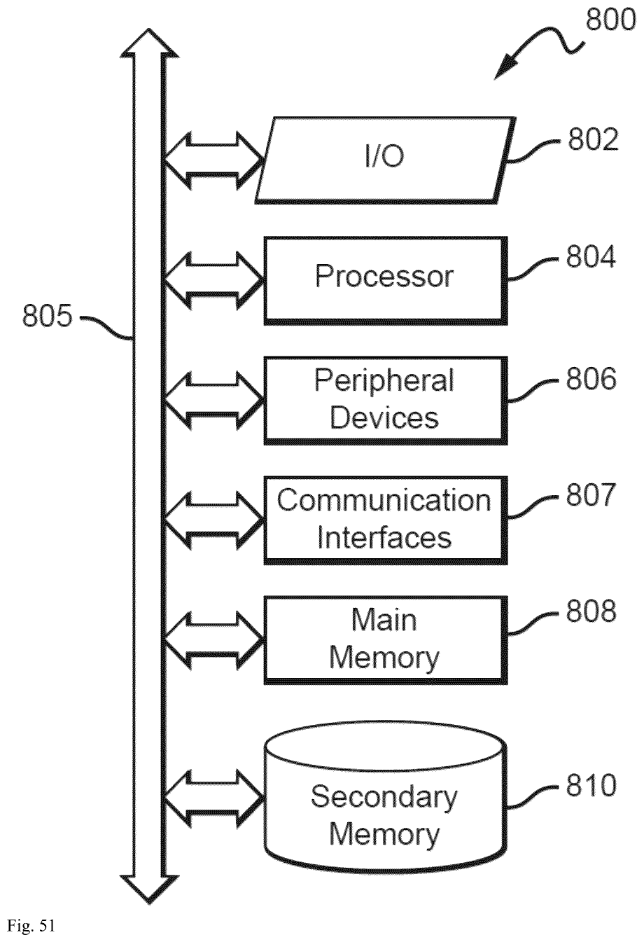

FIG. 51 illustrates an example of a computer system 800 that may be used to execute program code stored in a non-transitory computer readable medium (e.g., memory) in accordance with embodiments of the disclosure. The computer system includes an input/output subsystem 802, which may be used to interface with human users and/or other computer systems depending upon the application. The I/O subsystem 802 may include, e.g., a keyboard, mouse, graphical user interface, touchscreen, or other interfaces for input, and, e.g., an LED or other flat screen display, or other interfaces for output, including application program interfaces (APIs).

Program code may be stored in non-transitory computer-readable media such as persistent storage in secondary memory 810 or main memory 808 or both. Main memory 808 may include volatile memory such as random-access memory (RAM) or non-volatile memory such as read only memory (ROM), as well as different levels of cache memory for faster access to instructions and data. Secondary memory may include persistent storage such as solid-state drives, hard disk drives or optical disks. One or more processors 804 reads program code from one or more non-transitory media and executes the code to enable the computer system to accomplish the methods performed by the embodiments herein. Those skilled in the art will understand that the processor(s) may ingest source code and interpret or compile the source code into machine code that is understandable at the hardware gate level of the processor(s) 804. The processor(s) 804 may include dedicated processors such as microcontrollers running firmware. The processor(s) 804 may include specialized processing units (e.g., GPUs) for handling computationally intensive tasks.

The processor(s) 804 may communicate with external networks via one or more communications interfaces 807, such as a network interface card, WiFi transceiver, etc. A bus 805 communicatively couples the I/O subsystem 802, the processor(s) 804, peripheral devices 806, communications interfaces 807, memory 808, and persistent storage 810. Embodiments of the disclosure are not limited to this representative architecture. Alternative embodiments may employ different arrangements and types of components, e.g., separate buses for input-output components and memory subsystems. Elements of embodiments of the disclosure, such as one or more servers (e.g., in the cloud) communicating with an app, may be implemented with at least some of the components (e.g., processor 804, memory 808, communication interfaces 807) of a computer system like that of computer system 800.

Those skilled in the art will understand that some or all of the elements of embodiments of the disclosure, and their accompanying operations, may be implemented wholly or partially by one or more computer systems including one or more processors and one or more memory systems like those of computer system 800. Some elements and functionality may be implemented locally and others may be implemented in a distributed fashion over a network through different servers, e.g., in client-server fashion, for example.

In some embodiments, an application may be an application executing in a mobile operating system (e.g., iOS from Apple, Android from Google). In some embodiments, an application may be a desktop application designed to run in an operating system such as macOS from Apple, Windows 10 or 11 from Microsoft, ChromeOS from Google, etc. In some embodiments, a browser may be a browser such as Chrome from Google, Edge from Microsoft, Firefox from Mozilla, etc. or a browser extension designed to run on such a browser in an operating system (e.g., macOS, Windows 10 or 11, ChromeOS, etc.). Any of these executables may run on a computer system such as computer system 800. In some embodiments, a system may comprise one or more mobile applications executing on respective mobile devices and one or more server applications executing on one or more servers (e.g., in the cloud—Microsoft Azure, Amazon AWS, Google Cloud Platform, etc.).

Those skilled in the art will recognize that, in some embodiments, some of the operations described herein (e.g., acquiring a specimen from a participant, inserting a reaction container into a slot in a reaction container receiver) that do not involve data processing may be performed by human implementation, or through a combination of automated and manual means.

Although the disclosure may not expressly disclose that some embodiments or features described herein may be combined with other embodiments or features described herein, this disclosure should be read to describe any such combinations that would be practicable by one of ordinary skill in the art. The user of “or” in this disclosure should be understood to mean non-exclusive or, i.e., “and/or,” unless otherwise indicated herein.

In the embodiments or claims below, an embodiment or claim reciting “any one of embodiments/claims X-Y” shall refer to any one of embodiments or claims from embodiment/claim X and ending with embodiment/claim Y (inclusive). For example, “The system of any one of claims 7-11” refers to the system of any one of claims 7, 8, 9, 10, and 11.

Each embodiment below corresponds to one or more embodiments of the disclosure. Unless indicated otherwise, dependencies below refer back to embodiments within the same set (e.g., Embodiment Set A, Embodiment Set B1, Embodiment Set B2, Embodiment Set B3, Embodiment Set C1, Embodiment Set C2, Embodiment Set C3, Embodiment Set D). Comments included in brackets referencing exemplary figures are not to be interpreted as limiting the scope of the respective embodiment.

In embodiments described in combination with one or more parent embodiments, an embodiment element having a name that matches a corresponding, identically-named element in any of the one or more parent embodiments correspond to the same element—for example, in Embodiment Set A, in embodiment 36 based on embodiment 35, the “the FP cross-sectional area” of embodiment 36 corresponds to “an FP cross-sectional area” of embodiment 35 and “an FP cross-sectional area” of embodiment 36.

Embodiments that are incomplete or not practicable as a result of nested use of multiple dependent embodiments may be ignored. For example, in Embodiment Set A, embodiment 34 recites “CI cross-sectional area.” However, the set of embodiments 34 depending on embodiment 31 depending on any one of embodiments 1-27 may be ignored because embodiments 1-27, 31 do not recite “CI cross-sectional area.”

### Embodiment Set A

1. A container coupling unit (CCU) configured to couple to a sample container, the CCU comprising:
one or more internal chambers, wherein at least a first internal chamber of the one or more internal chambers is configured to receive reaction material, and the first internal chamber is separated from a volume outside the CCU via a fluidic pathway (FP); and
a coupling interface (CI), wherein the CCU is configured to couple to the sample container via the CI. [See, e.g., at least FIGS. 1-3]

2. The CCU of embodiment 1, wherein the sample container is a tube having a diameter equal to or less than 40 mm, 20 mm, 15 mm, 10 mm, or 5 mm.

3. The CCU of embodiment 1 or 2, wherein the CI is configured to couple to the sample container using screw threads.

4. The CCU of embodiment 1 or 2, wherein the CI is configured to couple to the sample container via an interference-fit or a snap-fit.

5. The CCU of any one of the preceding embodiments, wherein the CI comprises a gasket-based seal.

6. The CCU of any one of the preceding embodiments, wherein an opening of the sample container, through which fluid in the sample container is accessible with the CCU coupled to the sample container, couples to the CI.

7. The CCU of embodiment 6, wherein the opening is used to introduce sample material into the sample container.

8. The CCU of embodiment 6 or 7, wherein the CI of the CCU is configured to couple to the opening of the sample container with, during coupling, at least a portion of fluid in the sample container positioned below the CCU.

9. The CCU of any one of embodiments 6-8, wherein the opening of the sample container is the only opening permitting access to fluid in the sample container.

10. The CCU of any one of the preceding embodiments, wherein the CCU, once coupled with the sample container, is configured to lock in a coupled state.

11. The CCU of any one of the preceding embodiments, wherein the CCU is a single part. [See, e.g., at least FIGS. 1-3]

12. The CCU of embodiment 11, wherein the single part is formed by injection molding or 3D-printing. [See, e.g., at least FIGS. 1-3]

13. The CCU of any one of the preceding embodiments, wherein the reaction material is provided in the first internal chamber, and the reaction material is provided by dispensing a liquid or adding a pellet.

14. The CCU of embodiment 13, wherein the reaction material is provided by dispensing the liquid, and the reaction material is dried from a liquid form.

15. The CCU of any one of embodiments 1-10, wherein the CCU comprises two or more parts, a first part of the two or more parts is configured to form at least a portion of the first internal chamber, the first part is configured to receive the reaction material in the portion of the first internal chamber, and a second part of the two or more parts is configured to couple with the first part to form at least a portion of the CCU. [See, e.g., at least FIGS. 8, 40]

16. The CCU of embodiment 15, wherein the first part and the second part are coupled together using one or more of: an adhesive, heat, or mechanical coupling.

17. The CCU of embodiment 15 or 16, wherein the reaction material is provided in the portion of the first internal chamber.

18. The CCU of embodiment 17, wherein the reaction material is provided using one or more of: manual liquid dispensing, automated liquid dispensing, or adding a pellet.

19. The CCU of embodiment 17 or 18, wherein the reaction material is dispensed as a liquid, and the reaction material is dried from a liquid form.

20. The CCU of any one of the preceding embodiments, wherein the CCU comprises a movable part configured to move relative to another part of the CCU. [See, e.g., at least FIGS. 6, 22-26, 29-36]

21. The CCU of embodiment 20, wherein, during use, the movable part is configured to result in movement of a volume of fluid to the first internal chamber.

22. The CCU of any one of embodiments 1-19, the CCU further comprising: one or more transfer chambers, wherein, with the CCU in a first configuration, at least a first transfer chamber of the one or more transfer chambers is in fluidic communication with the volume outside the CCU, with the CCU in a second configuration, the first transfer chamber is in fluidic communication with the first internal chamber, and the fluidic pathway comprises the first transfer chamber. [See, e.g., at least FIGS. 4, 10-18]

23. The CCU of embodiment 22, wherein the CCU in the first configuration is changed to the second configuration by rotating or translating a movable part of the CCU relative to another part of the CCU.

24. The CCU of any one of embodiments 1-21, wherein, the first internal chamber comprises a component that is configured to float. [See, e.g., at least FIG. 37-39]

25. The CCU of any one of embodiments 1-21, 24, wherein the fluidic pathway permits fluidic communication between the first internal chamber and the volume outside the CCU with the CCU in a first configuration, and the fluidic pathway restricts fluidic communication between the first internal chamber and the volume outside the CCU with the CCU in a second configuration.

26. The CCU of embodiment 25, wherein the CCU in the first configuration is changed to the second configuration based on a position of a movable part. [See, e.g., at least FIG. 5, 21-26, 29-36,41]

27. The CCU of any one of the preceding embodiments, wherein, during use, the CCU is configured to use pressure in the sample container, with the CCU coupled to the sample container, to transfer fluid from the sample container into the first internal chamber. [See, e.g., at least FIGS. 19-21]

28. The CCU of any one of the preceding embodiments, wherein the CI has a CI cross-sectional area spanning a CI larger dimension and a CI shorter dimension, and the CI larger dimension is between 4 mm and 35 mm, 5 mm and 25 mm, or 6 mm and 20 mm. [See, e.g., at least FIG. 2, element M]

29. The CCU of embodiment 28, wherein, during use, fluid from the sample container contacts an area of the CCU excluding the one or more internal chambers that is more than 50%, 75%, 80%, 90% or 95% of the CI cross-sectional area.

30. The CCU of embodiment 28 or 29, wherein the CI cross-sectional area is a circle, and the CI larger dimension and the CI shorter dimension are the same.

31. The CCU of any one of the preceding embodiments, wherein the CCU has a CCU outer cross-sectional area spanning a CCU larger dimension and a CCU shorter dimension, and the CCU larger dimension is less than 35 mm, 30 mm, 25 mm, 20 mm, 15 mm, or 10 mm. [See, e.g., at least FIG. 2, element N]

32. The CCU of any one of embodiments 28-30, wherein the CCU has a CCU outer cross-sectional area spanning a CCU larger dimension and a CCU shorter dimension, and the CCU larger dimension is less than 2, 1.8, 1.5, 1.4, 1.3, 1.2, or 1.1 times the CI larger dimension. [See, e.g., at least FIG. 2, elements M, N]

33. The CCU of embodiment 31 or 32, wherein the CCU outer cross-sectional area is a circle, and the CCU larger dimension and the CCU shorter dimension are the same.

34. The CCU of any one of embodiments 28-33, wherein the fluidic pathway has a minimum cross-sectional area referenced as an FP cross-sectional area, and the FP cross-sectional area is less than 25%, 20%, 10%, 5%, 2%, or 1% of the CI cross-sectional area. [See, e.g., at least FIG. 2, elements A, M]

35. The CCU of any one of embodiments 31-33, wherein the fluidic pathway has a minimum cross-sectional area referenced as an FP cross-sectional area, and the FP cross-sectional area is less than 25%, 20%, 10%, 5%, 2%, or 1% of the CCU outer cross-sectional area. [See, e.g., at least FIG. 2, elements A, N]

36. The CCU of any one of the preceding embodiments, wherein the fluidic pathway has a minimum cross-sectional area referenced as an FP cross-sectional area, the FP cross-sectional area spans an FP larger dimension and an FP shorter dimension, and the FP larger dimension is less than 5 mm, 4 mm, 3 mm, 2 mm, 1.5 mm, 1.2 mm, 1 mm, 0.8 mm, or 0.5 mm. [See, e.g., at least FIG. 2, element A]

37. The CCU of embodiment 36, wherein the FP shorter dimension is more than 0.25 mm, 0.5 mm, 0.8 mm, 1 mm, 1.2 mm, 1.5 mm, 2 mm, 3 mm, or 4 mm.

38. The CCU of any one of the preceding embodiments, wherein the fluidic pathway has an FP length, and the FP length is less than 6 mm, 5 mm, 4 mm, 3 mm, 2 mm, or 1 mm.

39. The CCU of any one of the preceding embodiments, wherein the CCU comprises a second internal chamber, the second internal chamber is configured to receive a second reaction material, and the second internal chamber is separated from the volume outside the CCU via a second fluidic pathway.

Additional CCU embodiments of Embodiment Set A include, without limitation, the CCU of any one of embodiments 1-39 described above together with any combination of the following variations:
1. First inner chamber volume less than: 1 mL, 500 uL, 200 uL, 100 uL, 50 uL, 20 uL, 10 uL, 5 uL, 2 uL, or 1 uL
2. Reaction material in first internal chamber is:
   a. Frozen, CCU refrigerated during storage/transport; may be thawed before use
   b. Lyophilized
   c. Dried
   d. In liquid state
      i. With removable barrier (peel-off, screw off, etc.) in place unit CCU is ready to be used [See, e.g., at least FIGS. 7E, 7F for description of plug or other piece that may be coupled to the CCU, e.g., for storage, prior to use]
      ii. Dropper embodiment with restriction of dropper opening maintaining reaction material in the first internal chamber
3. First internal chamber geometry/design configured to permit, during use, optical measurement of at least a portion of fluid in first internal chamber
4. CCU configured to mechanically couple (e.g., via threads, via press fit, via snap fit) to top (with fluid in sample container located below CCU; CCU functions like a “cap” for the sample container) or bottom (with fluid in sample container located above CCU) of sample container [See, e.g., at least FIGS. 6, 7, 17, 19, 28, 29, 44]
5. First internal chamber optionally configured with a vent to permit gas in first internal chamber to exit as fluid enters the first internal chamber
   a. Vent in first internal chamber is self-sealing [See, e.g., at least FIGS. 37-39]
   b. Vent and fluidic pathway are separate [See, e.g., at least FIGS. 27, 28, 33, 35]]
6. Optional second internal chamber of the one or more internal chambers provided with reaction material and additionally provided with biological or synthetic material that functions as a basis of control for the reaction being performed in the first internal chamber
   a. For example, optional second internal chamber provided with reaction material and additionally provided with nucleic acid positive control template molecules such that the second internal chamber functions as a positive control for an amplification reaction (e.g., isothermal amplification reaction) being performed in the first internal chamber
7. Optional second internal chamber of the one or more internal chambers provided with a different reaction material (another test, e.g., for flu, with COVID-19 test in first internal chamber) or a different amount of reaction material—e.g., using different test time, temperature, etc. for different tests in different internal chambers
8. CCU usage options:
   a. CCU coupled to the sample container having a fluid, e.g., CCU at top, fluid at bottom of sample container
   b. CCU+sample container assembly flipped to introduce a portion of the fluid into the first internal chamber
   c. Placed on heater unit—CCU side down
      i. Heater unit type:
         1. Hot plate or dry bath/block heater with a heat block [See, e.g., at least FIG. 42]
         2. Heating coil—resistive heating of a CCU+sample container
         3. Chemical reaction produces heat—e.g., 2 components being combined in exothermic reaction
         4. Oven—CCU+sample container heated together
         5. Liquid bath—portion of CCU in bath
         6. Dry bath, e.g., using sand, granular particles—portion of CCU in bath
      ii. Optional:
         1. CCU+sample container assembly pulled into contact with heater
         2. Thermal interface material (e.g., thermal pad, thermal paste) between CCU+sample container assembly and heater—to improve thermal coupling
   d. Placed on reader unit to capture information re portion of fluid in the first internal chamber (e.g., following thermal cycling)
      i. Detecting color of portion of fluid in the first internal chamber
         1. Light source (LED)+photo detector (photodiode, etc.)
         2. Light source+camera
      ii. Detecting the absorption of light of one or more wavelengths
      iii. Detecting fluorescence from portion of fluid in the first internal chamber
         1. Illuminate portion of fluid with photons with a given wavelength; detect reemitted photons (fluorescence signal), e.g., at a different wavelength
      iv. If more than one internal chamber, identify internal chamber for each measured result
      v. Reader unit may be integrated with heater unit
9. Optional fluid properties
   a. Fluid includes material from swab(s)—e.g., swab nasal cavity, throat cavity
   b. Fluid includes material from saliva, urine, blood, etc.
   c. Fluid includes material formed by reacting with material on swab(s), saliva, etc.
   d. Fluid may include material from one or more individuals, “pooled sample” if more than one individual contributes
10. Result tracking options
   a. Optional IDs for use in test tracking:
      i. ID on cap
      ii. ID on sample container
      iii. ID for sample—may include information re individuals contributing samples
      iv. ID for internal chamber in CCU—e.g., 1, 2, 3, . . . ; A, B, C, . . .
   b. Exemplary workflow:
      i. Register CapID or ContainerID with individual(s) under test (e.g., using SampleID)
      ii. Record CapID or ContainerID at heater unit
      iii. Record CapID or ContainerID at sensor unit
      iv. Record result from sensor unit (e.g., CapID or ContainerID+internal chamber ID (if more than one internal chamber))
   c. Exemplary results:

| TestGroupID | ContainerID | CCUID | ChamberID | Result |
|---|---|---|---|---|
| 203132 | 501325 | 834321 | A | Positive |
| 203132 | 501325 | 834321 | B | Negative |
| 203132 | 501325 | 834321 | C | Positive |
| 208149 | | 835116 | A | Negative |
| 208149 | | 835116 | B | Positive |
| 208149 | | 835116 | C | -Error- |
| 210486 | | 837749 | | Negative |
| 213578 | 534768 | | A | Positive |
| 213578 | 534768 | | B | Positive |
| 215912 | | | A | Positive |
| 215912 | | | B | -Error- |
| | 573298 | | A | Negative |
| | | 878328 | A | Positive |

d. Options for how test results (e.g., Positive, Negative, Inconclusive, Error, etc.) may be detected:
   i. Change in color (e.g., initial to final distance in (u,v) space)
   ii. Final color (e.g., point in (u,v) space)
      1. Optional: separate tracking relative to initial color
   iii. Peak wavelength in transmitted light spectrum (through portion of test sample fluid in internal chamber; detecting change in absorption of test sample fluid)
   iv. Intensity of transmitted light (e.g., from light source) at a given wavelength—e.g., at end of test, compare intensity from beginning of test to intensity at end of test
   v. Integrated intensity of transmitted light (e.g., from light source) over one or more wavelengths—e.g., at end of test, compare intensity from beginning of test to intensity at end of test
   vi. Detecting change in absorbance of test sample fluid (e.g., in internal chamber)
11. Exemplary workflow: One or more individuals create a test group (e.g., using an app on a mobile device) identifying individual(s) who are contributing to a sample or a pooled sample
   a. For each member of the test group, test group information includes one or more of:
      i. Member name
      ii. Member email address
      iii. Member phone number
      iv. Member date of birth
      v. Member address
   b. Test group may be identified by a TestGroupID
12. Exemplary workflow: TestGroupID is associated with a reaction container, reaction container may be identified by a ContainerID or CCUID; reaction container contains samples from test group members that have contributed to the sample fluid to be tested—may be done before or after test sample is tested
   a. An individual associates the reaction container with the test group (e.g., scanning QR code on reaction container (ContainerID or CCUID) (e.g., using an app) and associating it with TestGroupID, recording correspondence on a paper log)
      i. Individual may be one of the individuals in the test group
13. Exemplary workflow: CCU (e.g., with CCUID) is associated with the reaction container (e.g., reaction container having ContainerID) or test group (e.g., test group having TestGroupID)—may be done before or after test sample is tested
   a. CCUID identifies one or more internal chambers associated with the CCU, may include test process for each of the one or more internal chambers, e.g., process parameters (heating temperature and duration) for each internal chamber
   b. An individual associates the CCU with the reaction container (e.g., scanning QR code on CCU (CCUID) using app and associating it with ContainerID) or test group (e.g., scanning QR code on CCU (CCUID) using app and associating it with TestGroupID)
      i. Individual may be one of the individuals in the test group
14. Individual brings reaction container (CCU+container) with sample fluid to testing station (reader unit, heater unit)
   a. Individual registers reaction container with the testing station, e.g., using one or more of: TestGroupID, ContainerID, or CCUID
   b. Testing station tests one or more internal chambers (e.g., using the respective process parameters associated with each internal chamber)
   c. Testing system (e.g., including app, testing station, backend) relates the results from each of the tested internal chambers to one or more of the associated TestGroupID, ContainerID, or CCUID
15. Testing system provides one or more test results to the members of the test group (e.g., using one or more of TestGroupID, ContainerID, or CCUID)
   a. For example:
      i. Members John and Sara of test group with TestGroupID 213578 may receive test results in the associated app, by email, or by phone
      ii. Results for container with ContainerID 573298 or for CCU with CCUID 878328 may be provided to an individual that has associated the respective ContainerID or CCUID with their account in the Testing System
      iii. Testing station may display the results of the test (e.g., for container with ContainerID 573298, for CCU with CCUID 878328) locally (e.g., on a display, using indicator LEDs) to an individual who may not have registered as a user of the Testing System

### Embodiment Set B1

1. A system for measuring data related to a test performed on a portion of sample fluid in a reaction container, the system comprising:
a reaction container receiver having one or more slots, wherein the reaction container receiver is configured to receive reaction containers in each slot of the one or more slots, and the one or more slots include a first slot;
one or more memories storing instructions;
one or more sensors including a first sensor; one or more processors, operably coupled to the one or more memories and operably coupled to the one or more sensors, for executing the instructions to cause:
receiving, from the first sensor, first information associated with the portion of sample fluid in the reaction container, wherein at least a portion of the reaction container is in the first slot, the test starts at a test start time, the first information is received after a test time period has elapsed since the test start time, a target test time is based at least in part upon the test performed on the portion of sample fluid in the reaction chamber, and the test time period is within less than 5 minutes, 2 minutes, 1 minute, 30 seconds, 10 seconds, or 5 seconds of the target test time.

2. The system of embodiment 1, wherein the start of the test is associated with insertion of the reaction container in the first slot.

3. The system of embodiment 1 or 2, wherein the instructions, when executed, cause: receiving, from the first sensor, second information associated with the portion of the sample fluid in the reaction container, wherein the second information is received within less than 5 minutes, 2 minutes, 1 minute, 30 seconds, 10 seconds, or 5 seconds of the test start time.

4. The system of any one of the preceding embodiments, wherein the instructions, when executed, cause: receiving, from the first sensor, additional information associated with the portion of the sample fluid in the reaction container, wherein the additional information is received less than every 5 minutes, 2 minutes, 1 minute, 30 seconds, 10 seconds, or 5 seconds, and the additional information is received one or more times before the first information is received.

5. The system of any one of the preceding embodiments, wherein a second test is performed on a second portion of a second sample fluid in a second reaction container, at least a portion of the second reaction container is in a second slot of the one or more slots, and the instructions, when executed, cause:
receiving, from a second sensor of the one or more sensors, third information associated with the second portion of second sample fluid in the second reaction container in the second slot, wherein the second test starts at a second test start time, the third information is received after a second test time period has elapsed since the second test start time, a second target test time is based at least in part upon the second test performed on the second portion of second sample fluid in the second reaction container, the second test time period is within less than 5 minutes, 2 minutes, 1 minute, 30 seconds, 10 seconds, or 5 seconds of the second target test time, and the test start time and the second test start time are different.

6. The system of any one of the preceding embodiments, wherein the test is based at least in part upon an amplification reaction performed on the portion of sample fluid in the reaction container.

7. The system of any one of the preceding embodiments, wherein the first information is based on an optical measurement performed on the portion of sample fluid in the reaction container.

8. The system of any one of the preceding embodiments, wherein the reaction container receiver has more than 1, 3, 11, 23, 47, or 95 slots.

9. The system of any one of the preceding embodiments, wherein the first information is received after the portion of the sample fluid in the reaction container is heated for at least the test time period.

10. The system of embodiment 9, wherein the portion of the sample fluid in the reaction container receiver is heated using an externally controlled heater.

11. The system of embodiment 9, the system further comprising: a heating unit, operably coupled to the one or more processors, wherein the instructions, when executed, cause:
providing fourth information to cause the heating unit to provide heat to the portion of the sample fluid in the reaction container.

12. The system of any one of the preceding embodiments, wherein the instructions, when executed, cause:
providing fifth information to cause an indication to be displayed, wherein the indication is displayed after the test is started.

13. The system of any one of the preceding embodiments, wherein the instructions, when executed, cause:
providing sixth information to cause a second indication to be displayed, wherein the second indication is displayed after the first information is received.

14. The system of any one of the preceding embodiments, wherein the instructions, when executed, cause:
providing seventh information to cause a third indication to be displayed, wherein the third indication is displayed if the reaction container is not inserted in the first slot properly.

15. The system of any one of the preceding embodiments, wherein the instructions, when executed, cause:
receiving eighth information associated with the reaction container, wherein the eighth information is associated with information identifying a component of the reaction container or information identifying a source of the sample fluid.

16. The system of any one of the preceding embodiments, the system further comprising: one or more light sources, each operably coupled to the one or more processors, including a first light source, wherein the instructions, when executed, cause:
provide ninth information to cause the first light source to illuminate, wherein the first sensor is a photo sensor, light from the illuminated first light source is transmitted through the portion of sample fluid in the reaction container, the transmitted light impinges on the photo sensor, and the first information is based at least in part on a signal generated by the photo sensor in response to the impinging transmitted light.

17. The system of any one of the preceding embodiments, wherein the reaction container receiver comprises a part fabricated from Aluminum.

18. The system of any one of the preceding embodiments, wherein at least the first sensor is mounted on a metal core PCB.

19. The system of any one of the preceding embodiments, wherein the instructions, when executed, cause:
determining a test result based at least in part upon the first information; and providing tenth information to cause a fourth indication to be displayed, wherein the fourth indication is associated with the test result.

20. The system of any one of the preceding embodiments, wherein the reaction container is removed from the first slot after the first information is received, and a third reaction container is placed in the first slot, after the reaction container is removed, for a third test to be performed on a portion of third sample fluid in the third reaction container.

21. The system of any one of the preceding embodiments, wherein at least one of the first information, the second information, the third information, fourth information, fifth information, sixth information, seventh information, eighth information, ninth information, tenth information, additional information, or test result is transmitted to another computing device via a network.

22. The system of any one of the preceding embodiments, wherein the reaction container comprises:
a sample container having the sample fluid; and
a CCU described in any one of the embodiments of Embodiment Set A, wherein the CCU is coupled to the sample container having the sample fluid, the CCU comprises one or more internal chambers, and the portion of the sample fluid in the reaction container is in a first internal chamber of the one or more internal chambers.

23. The system of embodiment 22, wherein the reaction container receiver is configured to orient the one or more internal chambers of the CCU to permit identification of each of the respective internal chambers.

24. The system of embodiment 22 or 23, wherein the portion of the sample fluid in the first internal chamber remains in the first internal chamber during the test.

25. The system of any one of embodiments 1-21, wherein the reaction container comprises:
a plug; and
a CCU described in any one of the embodiments of Embodiment Set A, wherein the CCU is coupled to the plug, the CCU comprises one or more internal chambers, and the portion of the sample fluid is in a first internal chamber of the one or more internal chambers. [See, e.g., at least FIGS. 7E, 7F]

26. The system of any one of embodiments 1-21, wherein the reaction container comprises: one or more internal chambers, wherein the portion of the sample fluid is in a first internal chamber of the one or more internal chambers, the first internal chamber is configured to receive reaction material, the reaction container comprises a first volume, a second portion of the sample fluid is in the first volume, and a ratio of the portion of the sample fluid in the first internal chamber to the second portion of the sample fluid is less than 1:2, 1:5, 1:10, 1:20, 1:50, 1:100, 1:200, 1:500, 1:1000, 1:2000, 1:5000, 1:10000, 1:20000, or 1:50000.

27. The system of embodiment 26, wherein the reaction container comprises two or more parts, wherein a first part of the two or more parts comprises the first volume, a second part of the two or more parts comprises at least a portion of the first internal chamber, and the first part and the second part are coupled together to form at least a portion of the reaction container.

28. The system of embodiment 26 or 27, wherein the first internal chamber is as described in any one of the embodiments in Embodiment Set A without incorporating the coupling limitation of the CI.

29. The system of any one of embodiments 26-28, wherein the reaction container comprises components or features, used to transfer sample fluid from the first volume to the first internal chamber, described in any one of the embodiments in Embodiment Set A.

30. The system of any one of embodiments 26-29, wherein the components or features comprise the first transfer chamber from embodiment 22 or 23 of Embodiment Set A, and the container is configurable in the first configuration and the second configuration.

31. The system of any one of embodiments 26-29, wherein the container is configurable in the first configuration and the second configuration described in embodiment 25 or 26 of Embodiment Set A.

### Embodiment Set B2

1. A method for measuring data related to a test performed on a portion of sample fluid in a reaction container, the method comprising:
receiving, at a processor, first information associated with the portion of sample fluid in the reaction container, wherein at least a portion of the reaction container is in a first slot of one or more slots of a reaction container receiver, the test starts at a test start time, the first information is received after a test time period has elapsed since the test start time, a target test time is based at least in part upon the test performed on the portion of sample fluid in the reaction chamber, and the test time period is within less than 5 minutes, 2 minutes, 1 minute, 30 seconds, 10 seconds, or 5 seconds of the target test time.

Note: Additional method embodiments include, at least and without limitation, the method described above in Embodiment Set B2 together with any combination of the system embodiments 2-31 from Embodiment Set B1 converted to a corresponding method form.

### Embodiment Set B3

1. One or more non-transitory computer-readable media (CRM) storing instructions for measuring data related to a test performed on a portion of sample fluid in a reaction container, wherein the instructions, when executed by one or more computing devices, cause: receiving, at a processor, first information associated with the portion of sample fluid in the reaction container, wherein at least a portion of the reaction container is in a first slot of one or more slots of a reaction container receiver, the test starts at a test start time, the first information is received after a test time period has elapsed since the test start time, a target test time is based at least in part upon the test performed on the portion of sample fluid in the reaction chamber, and the test time period is within less than 5 minutes, 2 minutes, 1 minute, 30 seconds, 10 seconds, or 5 seconds of the target test time.

Note: Additional CRM embodiments include, at least and without limitation, the CRM described above in Embodiment Set B3 together with any combination of the system embodiments 2-31 from Embodiment Set B1 converted to a corresponding CRM form.

### Embodiment Set C1

1. A method for performing one or more tests on a sample fluid, the method comprising: coupling a CCU with a sample container, wherein the sample container includes the sample fluid, the CCU comprises one or more internal chambers including a first internal chamber, and the CCU coupled with the sample container is referred to as a reaction container; placing at least a portion of the CCU of the reaction container into a first slot of a reaction container receiver;
receiving, from a first sensor coupled to a processor, first information associated with the first internal chamber, wherein the first information relates to a measurement made on at least a portion of a volume of sample fluid in the first internal chamber; and
determining, using a processor, a first test result associated with the first internal chamber based at least in part upon the first information.

2. The method of embodiment 1, wherein the first internal chamber includes the volume of sample fluid prior to insertion of the portion of the CCU into the first slot.

3. The method of embodiment 1 or 2, wherein, during coupling of the CCU with the sample container, at least a portion of the sample fluid in the sample container is positioned below the CCU, the method further comprising:
inverting the reaction container, to orient the CCU so that at least the portion of the CCU is below the portion of the sample fluid, prior to placing the portion of the CCU into the first slot.

4. A method for performing one or more tests on a sample fluid, the method comprising: coupling a CCU with a sample container, wherein the sample container includes the sample fluid, and the CCU comprises one or more internal chambers including a first internal chamber;
after a volume of sample fluid is included in the first internal chamber, uncoupling the CCU from the sample container;
placing at least a portion of the CCU into a first slot of a reaction container receiver, wherein the first internal chamber includes at least a portion of the volume of sample fluid when the CCU is inserted into the first slot;
receiving, from a first sensor coupled to a processor, first information associated with the first internal chamber, wherein the first information relates to a measurement made on the portion of the volume of sample fluid in the first internal chamber; and
determining, using a processor, a first test result associated with the first internal chamber based at least in part upon the first information.

5. The method of embodiment 4, further comprising: coupling the CCU with a plug prior to placing the portion of the CCU into the first slot, and the CCU coupled with the plug is referred to as a reaction container. [See, e.g., at least FIGS. 7E, 7F]

6. The method of any one of the preceding embodiments, wherein the first information is based at least in part upon an optical measurement made on the portion of the volume of sample fluid in the first internal chamber.

7. The method of any one of the preceding embodiments, further comprising: heating the portion of the CCU for a target test time period prior to receiving the first information.

8. The method of embodiment 7, wherein the target test time period starts within 5 minutes, 2 minutes, 1 minute, 30 seconds, 10 seconds, or 5 seconds of placing the portion of the CCU into the first slot.

9. The method of embodiment 7 or 8, further comprising:
receiving, from the first sensor, second information associated with the first internal chamber within less than 5 minutes, 2 minutes, 1 minute, 30 seconds, 10 seconds, or 5 seconds after placing the portion of the CCU into the first slot, wherein the second information relates to a measurement made on the portion of the volume of sample fluid in the first internal chamber, and the first test result is based at least in part upon the second information.

10. The method of embodiment 9, wherein the first test result is based at least in part upon a change in an optical measurement made on the portion of the volume of sample fluid in the first internal chamber, and the change is associated with a difference between the first information and the second information.

11. The method of any one of the preceding embodiments, wherein the CCU comprises a second internal chamber including a second volume of the sample fluid, the method further comprising: receiving, from a second sensor coupled to a processor, third information associated with the second internal chamber, wherein the third information relates to a measurement made on at least a portion of the second volume of sample fluid in the second internal chamber; and determining, using a processor, a second test result associated with the second internal chamber based at least in part upon the third information.

12. The method of any one of the preceding embodiments, further comprising: removing the CCU from the first slot after receiving the first information.

13. The method of embodiment 12, further comprising: placing at least a portion of another CCU into the first slot to perform another test using a different sample fluid.

14. The method of embodiment 4, further comprising:
after uncoupling the CCU from the sample container, coupling another CCU with the sample container, wherein the sample container includes at least a portion of the sample fluid, and the other CCU comprises one or more internal chambers including a second internal chamber; placing at least a portion of the other CCU into a second slot of the reaction container receiver, wherein the second internal chamber includes a second volume of the portion of the sample fluid;
receiving, from a second sensor coupled to a processor, second information associated with the second internal chamber, wherein the second information relates to a measurement made on at least a portion of the second volume of sample fluid in the second internal chamber; and determining, using a processor, a second test result associated with the second internal chamber based at least in part upon the second information.

15. The method of embodiment 14, wherein the first slot and the second slot are the same, the first sensor and the second sensor are the same, and the portion of the other CCU is placed into the first slot after the CCU is removed from the first slot.

16. The method of any one of the preceding embodiments, wherein the test result is based at least part upon a change in optical absorbance of the portion of the volume of sample fluid in the first internal chamber.

17. The method of any one of the preceding embodiments, wherein the test result is based at least part upon a change in visual color of the portion of the volume of sample fluid in the first internal chamber.

18. The method of any one of the preceding embodiments, wherein the test result is based at least part upon a change in turbidity of the portion of the volume of sample fluid in the first internal chamber.

19. The method of any one of the preceding embodiments, wherein the CCU or the other CCU is described by any one of the embodiments of Embodiment Set A.

20. A method for performing one or more tests on a sample, the method comprising: adding a sample to a reaction container, wherein the reaction container comprises one or more internal chambers including a first internal chamber;
placing at least a portion of the reaction container into a first slot of a reaction container receiver; receiving, from a first sensor coupled to a processor, first information associated with the first internal chamber, wherein the first information relates to a measurement made on at least a portion of a volume of a fluid in the first internal chamber, wherein the fluid comprises material from the sample; and
determining, using a processor, a first test result associated with the first internal chamber based at least in part upon the first information.

### Embodiment Set C2

1. A method for performing one or more tests on a sample fluid, the method comprising: coupling a CCU with a sample container, wherein the sample container includes the sample fluid, the CCU comprises one or more internal chambers including a first internal chamber, and the CCU coupled with the sample container is referred to as a reaction container;
receiving, from a first sensor coupled to a processor, first information associated with the first internal chamber, wherein the first information relates to a measurement made on at least a portion of a volume of sample fluid in the first internal chamber; and
determining, using a processor, a first test result associated with the first internal chamber based at least in part upon the first information.

2. The method of embodiment 1, wherein the first information is based at least in part upon an optical measurement made on the portion of the volume of sample fluid in the first internal chamber.

3. The method of embodiment 1 or 2, further comprising:
heating at least a portion of the CCU for a target test time period prior to receiving the first information.

4. The method of any one of the preceding embodiments, further comprising:
receiving, from a second sensor coupled to a processor, second information associated with the first internal chamber prior to heating the portion of the CCU, wherein the second information relates to a measurement made on at least the portion of the volume of sample fluid in the first internal chamber, and the first test result is based at least in part upon the second information.

5. The method of embodiment 4, wherein the first test result is based at least in part upon a change in an optical measurement made on the portion of the volume of sample fluid in the first internal chamber, and the change is associated with a difference between the first information and the second information.

6. The method of embodiment 4 or 5, wherein the first sensor and the second sensor are the same.

7. The method of any one of the preceding embodiments, wherein the test result is based at least part upon a change in optical absorbance of the portion of the volume of sample fluid in the first internal chamber.

8. The method of any one of the preceding embodiments, wherein the test result is based at least part upon a change in visual color of the portion of the volume of sample fluid in the first internal chamber.

9. The method of any one of the preceding embodiments, wherein the test result is based at least part upon a change in turbidity of the portion of the volume of sample fluid in the first internal chamber.

10. The method of any one of the preceding embodiments, wherein the CCU is described by any one of the embodiments of Embodiment Set A.

### Embodiment Set C3

1. A method for performing one or more tests on a sample fluid, the method comprising: coupling a CCU with a sample container, wherein the sample container includes the sample fluid, the CCU comprises one or more internal chambers including a first internal chamber, and the CCU coupled with the sample container is referred to as a reaction container; and
visually inspecting, by an individual, the first internal chamber to infer a test result associated with the test performed on at least a portion of a volume of sample fluid in the first internal chamber.

2. A method for performing one or more tests on a sample fluid, the method comprising: coupling a CCU with a sample container, wherein the sample container includes the sample fluid, the CCU comprises one or more internal chambers including a first internal chamber, and the CCU coupled with the sample container is referred to as a reaction container; and
capturing, using a sensor operably coupled to a processor, an image of the first internal chamber, wherein the first internal chamber includes at least a portion of a volume of sample fluid.

3. The method of embodiment 2, further comprising:
analyzing, using a processor, the image to infer a test result associated with the test performed in the first internal chamber.

4. The method of embodiment 2, wherein the image is visually inspected by an individual to infer a test result associated with the test performed in the first internal chamber.

5. The method of any one of the preceding embodiments, wherein the test result is based at least part upon a change in optical absorbance of the portion of the volume of sample fluid in the first internal chamber.

6. The method of any one of the preceding embodiments, wherein the test result is based at least part upon a change in visual color of the portion of the volume of sample fluid in the first internal chamber.

7. The method of any one of the preceding embodiments, wherein the test result is based at least part upon a change in turbidity of the portion of the volume of sample fluid in the first internal chamber.

8. The method of any one of the preceding embodiments, wherein the CCU is described by any one of the embodiments of Embodiment Set A.

### Embodiment Set D

1. A container configured to perform a biochemical test, the container comprising: a first volume, wherein the first volume is configured to receive a sample fluid;
one or more internal chambers, wherein at least a first internal chamber of the one or more internal chambers is configured to receive reaction material, and the first internal chamber is separated from the first volume via a fluidic pathway (FP); and
an opening, wherein the container is configured to receive a sample introduced via the opening. [See, e.g., at least FIG. 50]

2. The container of embodiment 1, wherein the sample is introduced into the sample fluid, and the biochemical test is performed on a portion of the sample fluid after the sample is introduced into the sample fluid.

3. The container of embodiment 1 or 2, wherein a ratio of a volume of the first internal chamber to the first volume is less than 1:2, 1:5, 1:10, 1:20, 1:50, 1:100, 1:200, 1:500, 1:1000, 1:2000, 1:5000, 1:10000, 1:20000, or 1:50000

4. The container of any one of embodiments 1-3, wherein the first internal chamber is as described in any one of the embodiments in Embodiment Set A without incorporating the coupling limitation of the CI.

5. The container of any one of embodiments 1-4, wherein the container comprises components or features, used to transfer sample fluid from the first volume to the first internal chamber, described in any one of the embodiments in Embodiment Set A.

6. The container of embodiment 5, wherein the components or features comprise the first transfer chamber from embodiment 22 or 23 of Embodiment Set A, and the container is configurable in the first configuration and the second configuration.

7. The container of embodiment 5, wherein the container is configurable in the first configuration and the second configuration described in embodiment 25 or 26 of Embodiment Set A.

1. A system for measuring data related to a test performed on a portion of sample fluid in a reaction container, the system comprising:
a reaction container receiver having one or more slots, wherein the reaction container receiver is configured to receive reaction containers in each slot of the one or more slots, and the one or more slots include a first slot;
one or more memories storing instructions;
one or more sensors including a first sensor;
one or more processors, operably coupled to the one or more memories and operably coupled to the one or more sensors, for executing the instructions to cause:
receiving, from the first sensor, first information associated with the portion of sample fluid in the reaction container, wherein at least a portion of the reaction container is in the first slot, the test starts at a test start time, the start of the test is associated with insertion of the reaction container in the first slot, the first information is received after a test time period has elapsed since the test start time, a target test time is based at least in part upon the test performed on the portion of sample fluid in the reaction chamber, and the test time period is within less than 5 minutes, 2 minutes, 1 minute, 30 seconds, 10 seconds, or 5 seconds of the target test time.

2. The system of claim 1, wherein no component of the system is configured to have fluid communication with the sample fluid in the reaction container.

3. The system of claim 1, wherein no component of the system is operable to electrically couple with the reaction container.

4. The system of claim 1, wherein the system is configured to maintain the reaction container receiver at substantially a first temperature from the test start time until the test time period has elapsed, wherein the reaction container receiver is maintained at the first temperature within +/−10, 5, 3, 2, or 1 degree C.

5. The system of claim 1, wherein the test is based at least in part upon an isothermal amplification reaction performed on the portion of sample fluid in the reaction container.

6. The system of claim 1, wherein the reaction container receiver has more than 1, 3, 11, 23, 47, or 95 slots.

7. The system of claim 1, wherein the system is configured to perform a second test on a second portion of a second sample fluid in a second reaction container with at least a portion of the second reaction container in a second slot of the one or more slots, and the instructions, when executed, cause:
receiving, from a second sensor of the one or more sensors, second information associated with the second portion of second sample fluid in the second reaction container in the second slot, wherein the second test starts at a second test start time, the start of the second test is associated with insertion of the second reaction container in the second slot, the second information is received after a second test time period has elapsed since the second test start time, a second target test time is based at least in part upon the second test performed on the second portion of second sample fluid in the second reaction container, the second test time period is within less than 5 minutes, 2 minutes, 1 minute, 30 seconds, 10 seconds, or 5 seconds of the second target test time, and the test start time and the second test start time are different.

8. The system of claim 1, wherein the reaction container receiver comprises a part with the one or more slots formed in a metal piece.

9. The system of claim 1, wherein at least the first sensor is mounted on a PCB.

10. The system of claim 1, wherein an externally controlled heater is configured to heat the portion of the sample fluid in the reaction container receiver.

11. The system of claim 1, the system further comprising:
a heating unit, operably coupled to the one or more processors, wherein the instructions, when executed, cause:
providing second information to cause the heating unit to provide heat, wherein the portion of the sample fluid in the reaction container is heated by the heat provided by the heating unit.

12. The system of claim 1, wherein the reaction container comprises one or more internal chambers, wherein the portion of the sample fluid is in a first internal chamber of the one or more internal chambers during the test, the first internal chamber is configured to receive reaction material, the reaction container comprises a first volume, a second portion of the sample fluid is in the first volume during the test, and a ratio of the portion of the sample fluid in the first internal chamber to the second portion of the sample fluid is less than 1:2, 1:5, 1:10, 1:20, 1:50, 1:100, 1:200, 1:500, 1:1000, 1:2000, 1:5000, 1:10000, 1:20000, or 1:50000.

13. The system of claim 12, wherein the reaction container comprises two or more parts, wherein a first part of the two or more parts comprises the first volume, a second part of the two or more parts comprises at least a portion of the first internal chamber, and the first part and the second part are coupled together to form at least a portion of the reaction container.

14. The system of claim 1, wherein the reaction container comprises:
a sample container having the sample fluid; and
a container coupling unit (CCU), wherein the CCU is configured to couple to the sample container having the sample fluid, the CCU comprises one or more internal chambers, the portion of the sample fluid in the reaction container is in a first internal chamber of the one or more internal chambers during the test, and the portion of the sample fluid in the first internal chamber remains in the first internal chamber during the test.

15. The system of claim 1, wherein the instructions, when executed, cause:
receiving, from the first sensor, second information associated with the portion of the sample fluid in the reaction container, wherein the second information is received within less than 5 minutes, 2 minutes, 1 minute, 30 seconds, 10 seconds, or 5 seconds of the test start time.

16. The system of claim 1, wherein the instructions, when executed, cause:
determining a test result based at least in part upon the first information; and
transmitting the test result to another computing device via a network.

17. The system of claim 1, wherein the instructions, when executed, cause:
receiving second information associated with the reaction container, wherein the second information is associated with information identifying a component of the reaction container or information identifying a source associated with the sample fluid.

18. The system of claim 1, wherein the first information is based on an optical measurement performed on the portion of sample fluid in the reaction container.

19. The system of claim 1, the system further comprising:
one or more light sources, each operably coupled to the one or more processors, including a first light source, wherein the instructions, when executed, cause:
provide second information to cause the first light source to illuminate, wherein the first sensor is a photo sensor, light from the illuminated first light source is transmitted through the portion of sample fluid in the reaction container, the transmitted light impinges on the photo sensor, and the first information is based at least in part on a signal generated by the photo sensor in response to the impinging transmitted light.

20. The system of claim 1, wherein the instructions, when executed, cause:
providing second information to cause an indication to be displayed, wherein the indication is displayed after the reaction container is inserted into the first slot.

21. A method for measuring data related to a test performed on a portion of sample fluid in a reaction container, the method comprising:
receiving, at a processor, first information associated with the portion of sample fluid in the reaction container, wherein at least a portion of the reaction container is in a first slot of one or more slots of a reaction container receiver, the test starts at a test start time, the start of the test is associated with insertion of the reaction container in the first slot, the first information is received after a test time period has elapsed since the test start time, a target test time is based at least in part upon the test performed on the portion of sample fluid in the reaction chamber, and the test time period is within less than 5 minutes, 2 minutes, 1 minute, 30 seconds, 10 seconds, or 5 seconds of the target test time.

22. One or more non-transitory computer-readable media (CRM) storing instructions for measuring data related to a test performed on a portion of sample fluid in a reaction container, wherein the instructions, when executed by one or more computing devices, cause:
receiving, at a processor, first information associated with the portion of sample fluid in the reaction container, wherein at least a portion of the reaction container is in a first slot of one or more slots of a reaction container receiver, the test starts at a test start time, the start of the test is associated with insertion of the reaction container in the first slot, the first information is received after a test time period has elapsed since the test start time, a target test time is based at least in part upon the test performed on the portion of sample fluid in the reaction chamber, and the test time period is within less than 5 minutes, 2 minutes, 1 minute, 30 seconds, 10 seconds, or 5 seconds of the target test time.
